(19) United States
(12) Patent Application Publication
(10) Pub. No.: US 2025/0094690 A1
(43) Pub. Date: Mar. 20, 2025

(54) SELECTIVE VISUAL DISPLAY SYSTEM

(71) Applicant: Richard Christopher DeCharms, VEGA BAJA, PR (US)

(72) Inventor: Richard Christopher DeCharms, VEGA BAJA, PR (US)

(21) Appl. No.: 18/886,954

(22) Filed: Sep. 16, 2024

Related U.S. Application Data
(60) Provisional application No. 63/583,358, filed on Sep. 18, 2023.
(60) Provisional application No. 63/633,868, filed on Apr. 15, 2024.
(60) Provisional application No. 63/637,902, filed on Apr. 24, 2024.
(60) Provisional application No. 63/695,157, filed on Sep. 16, 2024.

(51) Int. Cl. G06F 40/166; G06N 20/00

(52) U.S. Cl. CPC G06F 40/166; G06N 20/00

(57) ABSTRACT

According to an aspect of the present invention, there is provided a selective visual display system, comprising: a processor configured to execute coded instructions for retrieval, processing, and presentation of content to a user; a display screen configured to exhibit said visual information connected with the device to provide a medium for user interaction with a content element presented by the system; wherein the system is arranged to perform operations comprising: receiving a content element from a user; receiving a content attribute associated with the content element from a user; generating an evaluation of said content element in relation to said content attribute; wherein said evaluation is generated by a machine learning model trained on a set of content to assess the degree or manner in which the content element demonstrates said content attribute.

### CROSS REFERENCE TO RELATED APPLICATIONS

This application claims priority to U.S. provisional application Nos. 63/583,358; 63/633,868; 63/637,902; 63/695,157. The entire contents of these applications are hereby incorporated by reference.

### BACKGROUND AND FIELD OF THE INVENTION

### Identifier: Raterator-001-PCT-DEC005

Described herein are methods, devices, computer-readable media, and systems for presentation of information to users related to evaluations and responses to content.

Technical Field: The present invention relates to electronic rating and reading devices and software.

### BACKGROUND AND FIELD OF THE INVENTION

According to an aspect of the present invention, there is provided a selective visual display system, comprising: a processor configured to execute coded instructions for retrieval, processing, and presentation of content to a user; a display screen configured to exhibit said visual information connected with the device to provide a medium for user interaction with a content element presented by the system; wherein the system is arranged to perform operations comprising: receiving a content element from a user; receiving a content attribute associated with the content element from a user; generating an evaluation of said content element in relation to said content attribute; wherein said evaluation is generated by a machine learning model trained on a set of content to assess the degree or manner in which the content element demonstrates said content attribute.

### BRIEF DESCRIPTION OF THE DRAWINGS

FIG. 1. Selective visual display system and user interface system (UIS).

FIG. 2. User interface system (UIS) Detail.

FIG. 3. Example report tables and charts.

FIG. 4. Example report tables and charts.

FIG. 5. Marketing Funnel Behavioral Simulation Using AI Bots.

FIG. 6. Multi-Step Behavioral Process or UIS/UX Flow Simulation Using AI Bots.

FIG. 7. Multiple Response UIS.

### DETAILED DESCRIPTION OF FIGURES

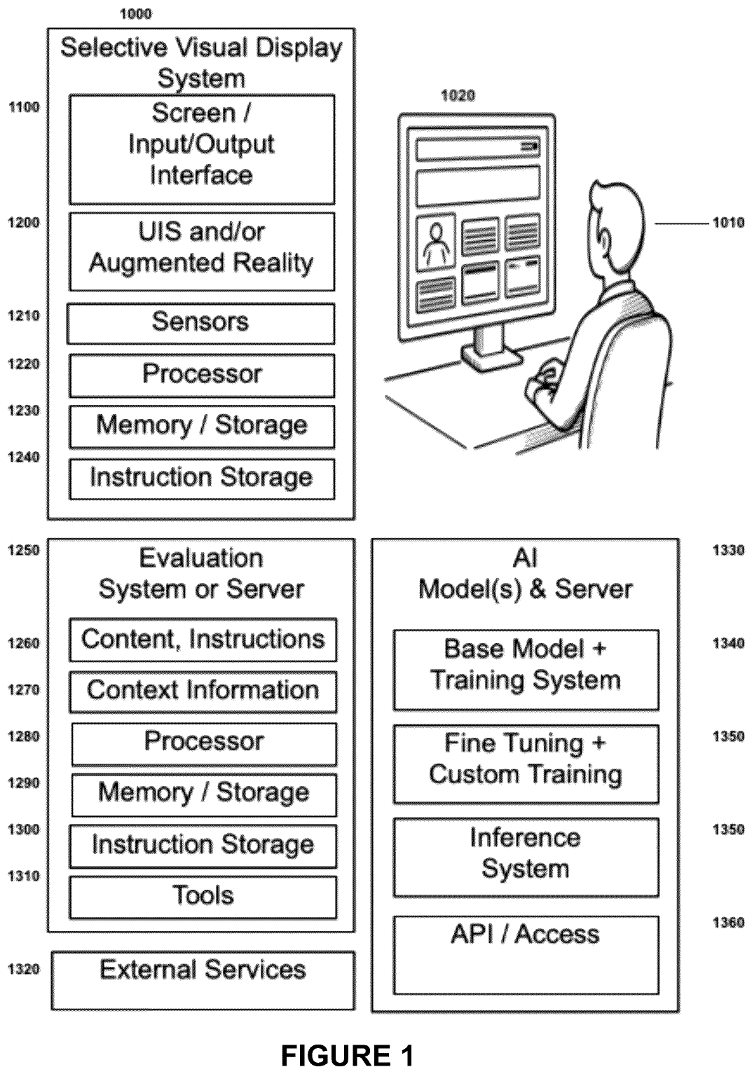

### FIG. 1. Selective Visual Display System and User Interface System (UIS) Detail

The user 1010 may interact with a selective visual display system 1020. This system may include hardware and software components in a local device or remotely 1100-1360.

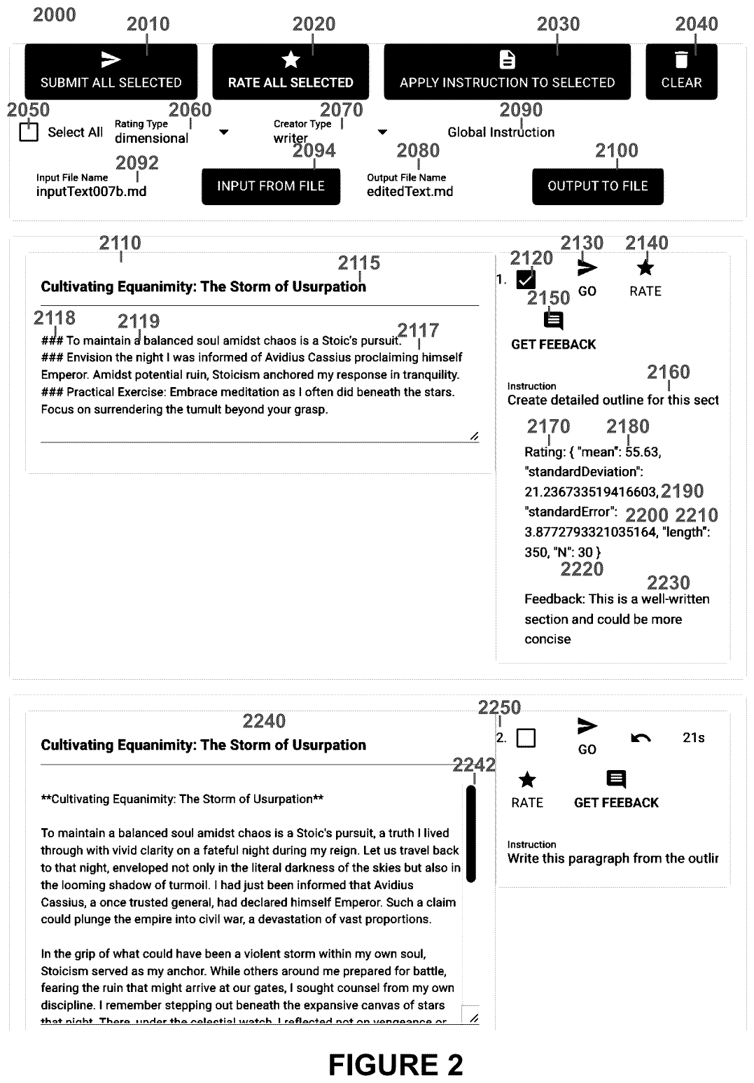

### FIG. 2. User Interface System (UIS) Detail

FIG. 2 depicts a user interface system (UIS) for a selective visual display system. A display section 2000 may show content being rated, evaluated and evaluations or ratings. This area may be used to display text, images, video, audio, or other multimedia elements for rating or review. For example, this may display paragraphs from a document that users interact with for analysis, response, or feedback. A control button 2010 may allow users to submit one or multiple selected content segments for processing by software. The software may queue these selections for batch, or parallel evaluation. A user may select multiple paragraphs or images for simultaneous AI evaluation by utilizing this button, streamlining the content processing workflow. Control button 2020 may initiate the evaluation or rating process for all chosen content items. The software may use this feature to compile and analyze simulated responses to the selected content elements. Control button 2030 may enable users to apply specific actions or instructions to one or multiple selected text segments for processing. This feature may be used to customize processing commands that will be applied to multiple content elements. A user may select a plurality of paragraphs and apply a common instruction to refine style across a section of a manuscript. Control button 2040 may provide the functionality to clear current selections or inputs or instructions. Selector 2050 may indicate to select multiple elements for processing, including simultaneous or parallel processing. Drop-down menu 2060 may allow users to select one or more different simulated personas to use for content rating. A persona may represent a unique demographic or professional attributes or other persona attributes that influence content perception. Drop-down menu 2070 may allow selection of the content type to be created, like generating a rating, evaluation, outline or replacement content or text. Writer users may alternate between generating detailed outlines from descriptions and full-text content from outlines, using the drop-down menu to switch content formats. Creator type selector field 2070 may offer an input to select the type of simulated creator or evaluator that will be used by the software. Output selector 2080 may indicate where results are to be stored. This functionality may include handling various formats like text files, images, audio, and video through file input/output operations. Global instruction input 2090 may allow an instruction to be applied during processing to multiple or content elements. Input and output selectors 2092, 2094, 2100 may allow control over input and output source and destination selection.

A content element 2110 may be displayed. The content element may include both a heading or title section 2115 and a content section 2117 and the software may automatically parse content to separate them or generate headings for content. The software may also visually depict separate ratings for multiple different sub-part content elements within a larger content element or document, such as by using numeric or icon-based illustrations of ratings 2118, or visual styling 2119 of different content according to rating, for example using different text color, background color, highlight color, or indicator bar 2242.

The selector 2120 may indicate whether a content element is to be processed, and may be globally selectable to process all elements 2050. Button 2130 may initiate processing. Button 2140 may indicate for software to rate a content element. Button 2150 may indicate for software to get a response or feedback regarding a content element. Instruction 2160 may provide an instruction to the software which may be passed to an AI model or simulated persona or audience. Statistics 217 may be presented that have been derived by rating or evaluating a content element, 2110, and may include summary statistics such as the mean or median 2180, standard deviation 2190, standard error 2200, length of content element 2210, and number of repetitions of processing carried out, 2220. Qualitative feedback may be presented 2230. Additional text elements 2240 may be presented and individually controlled for processing 2250.

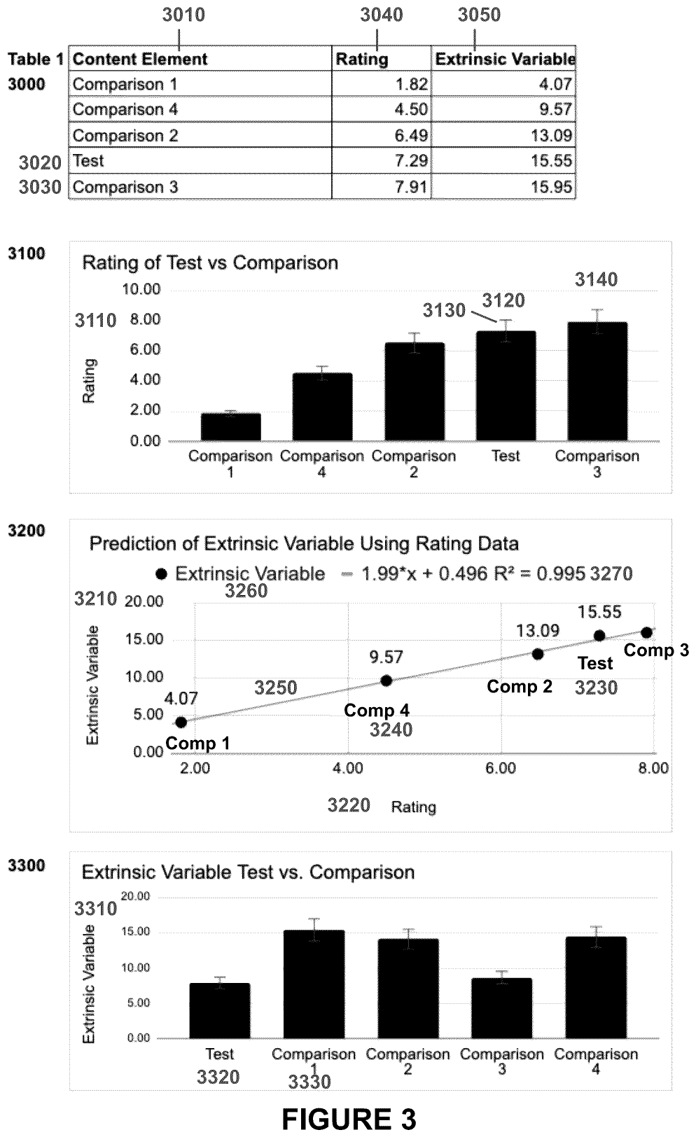

### FIG. 3. Example Report Tables and Charts.

FIG. 3 represents illustrative example charts and tables 3000 that may be generated by software by evaluating content elements 3010 including a content element to be tested 3020 and comparison elements 3030 and may present software derived ratings 3040 of the elements or predictions of extrinsic variables 3050 based upon those ratings. A chart 3100 may compare the average or median rating 3110 of a test content element 3120 with error bars 3130 vs comparison content elements 3140 with error bars. Chart 3200 illustrates that software may show a scatterplot or other illustration of the relationship between an extrinsic variable 3210 and a measured rating 3220 for the test content element 3230 or comparison content elements 3240. The software may use statistical methods such as line or curve fitting 3250 to derive a predictive relationship 3260 or quantitative predictive model 3260 that allows prediction of the extrinsic variable based on measured ratings 3220. The software may evaluate the quality of the statistical prediction 3270, such as by deriving an R\hat{ }2 statistic for a correlation coefficient. The software may make predictions 3300, or example of an extrinsic variable based upon the rating data for a test content element 3320 or comparison/benchmark content elements 3330.

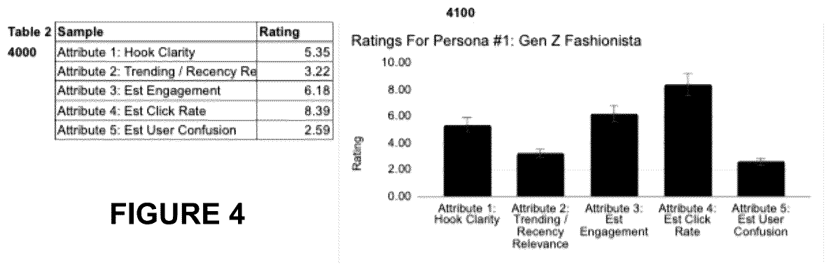

### FIG. 4. Example Report Tables and Charts.

FIG. 4 represents illustrative example charts and tables 4000 that the software may generate such as a table comparing software-created ratings for multiple attributes for a content element, and a chart of ratings for a simulated person 4100 on multiple attributes for multiple attributes.

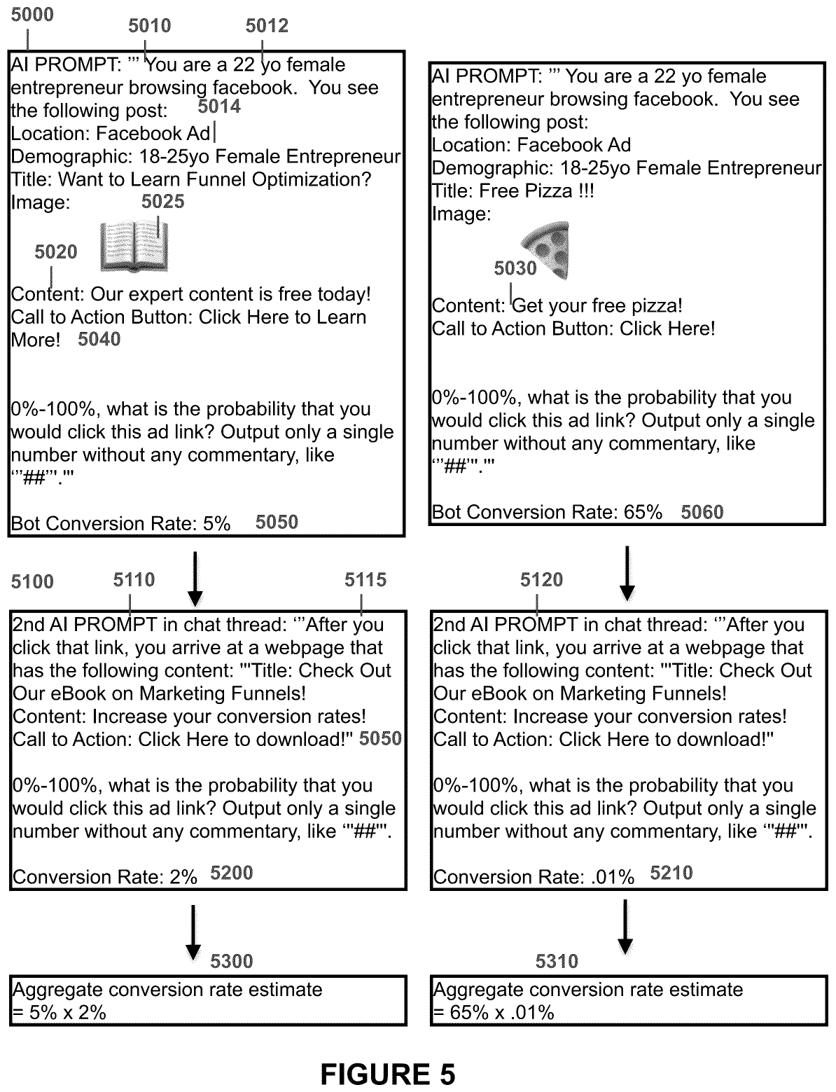

### FIG. 5. Marketing Funnel or Decision Path Behavioral Simulation Using AI Bots.

FIG. 5 represents an example of using AI simulation of human behavior or choice using a cognitive model, including multi-step behavior. In the first step of the behavior 5000, an AI prompt 5010 including a simulated persona 5012 that is exposed to a description of a simulated situation 5014, including adjustable content element 5020 which includes text and image 5025 or other multimedia content. The software may compare the result with more than one content variant 5030. The software may use the simulated persona to derive an estimate of the likelihood of the simulated persona undertaking a behavior like a call to action 5040. In this case, the software is illustrated deriving the likelihood of a particular action. The software may also use the prompt to ask the simulated persona which action they undertake, for example clicking on UI element vs a different one. The software may also enquire into the simulated user's simulated mental process or cognitive state, such as asking whether they understand the content, or to explain why they are making a choice. The software may estimate statistics regarding a behavior, such as a conversion rate in the first step 5050, for the first an additional content element 5060. The software may simulate a multi-step behavior. In the second step the simulation of a human behavior 5100 an additional AI prompt 5110 may be provided to an AI model, for example in an ongoing thread or chat which may be submitted as part of the input window to an Al model. The prompt 5110 presented in the second step may be generated conditional on the result of the first step 5115, for example representing a particular ongoing path in a decision tree. For example, the prompt may indicate whether the simulated persona did or did not undertake a behavior in the first step, or what behavior the simulated persona undertook in the first step 5115. The second step may also continue an additional thread 5120 which is based upon a different path, for example a thread based upon a different content element in the first step 5030. The software may derive a simulated behavior or action in the second step, for example based on a second call to action 5050. The software may estimate statistics regarding a behavior in the second or subsequent behavior, such as a conversion rate in the second step 5200, or in the second step following a different thread or decision path 5210. The software may they estimate a statistic of a multi-step behavior, such as a combined conversion rate 5300, or a combined conversion rate for a different decision tree path 5310.

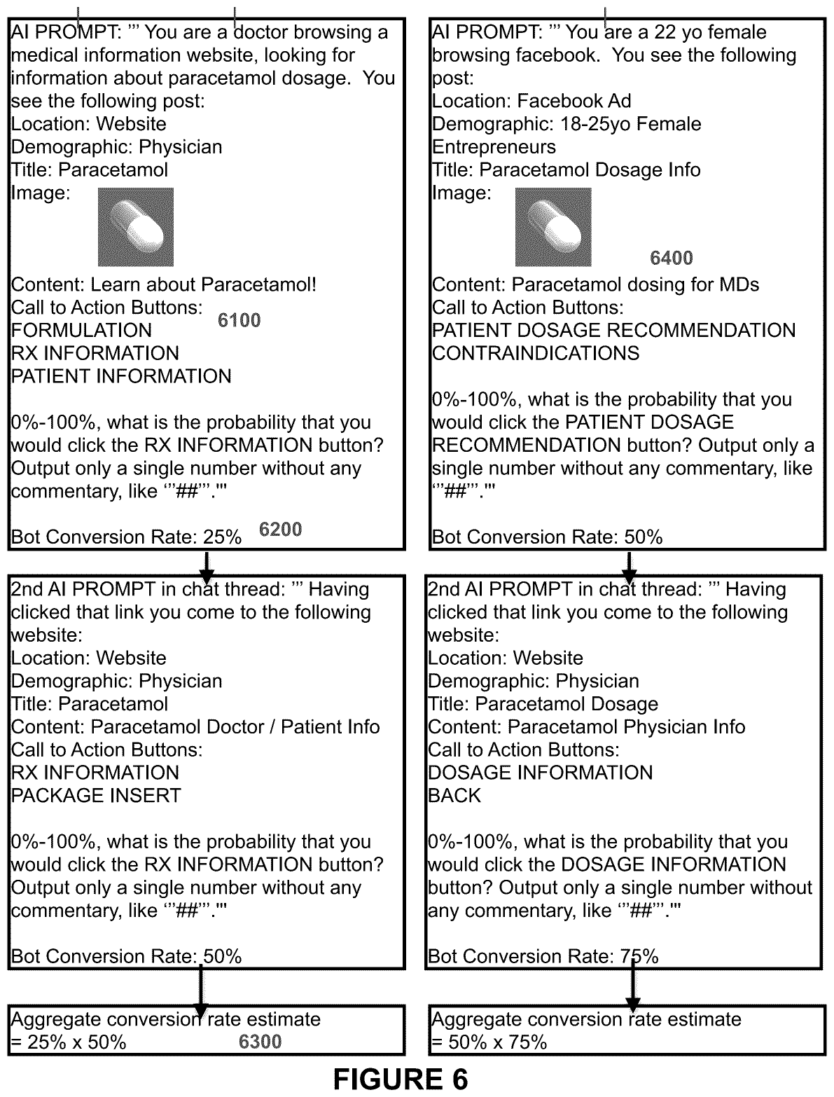

### FIG. 6. Multi-Step Decision Path, Behavioral Process or UI/UX Flow Simulation Using AI Bots.

FIG. 6 represents an example of using AI simulation of multi-step human behavior, decision tree or choice path or UI/UX 6000 using a cognitive model that tests the different simulated responses of one simulated persona 6010 or a different simulated persona 6020 to content elements 6100. The illustrated process is in some ways similar to the process illustrated in FIG. 5. This example illustrates the measurement of simulated choice with multiple option, for example multiple potential buttons, which may represent different paths, and at more than one stage in a thread. The software may estimate the behavior of the simulated persona 6200, across multiple steps 6300, and different paths with different stimuli or context 6400.

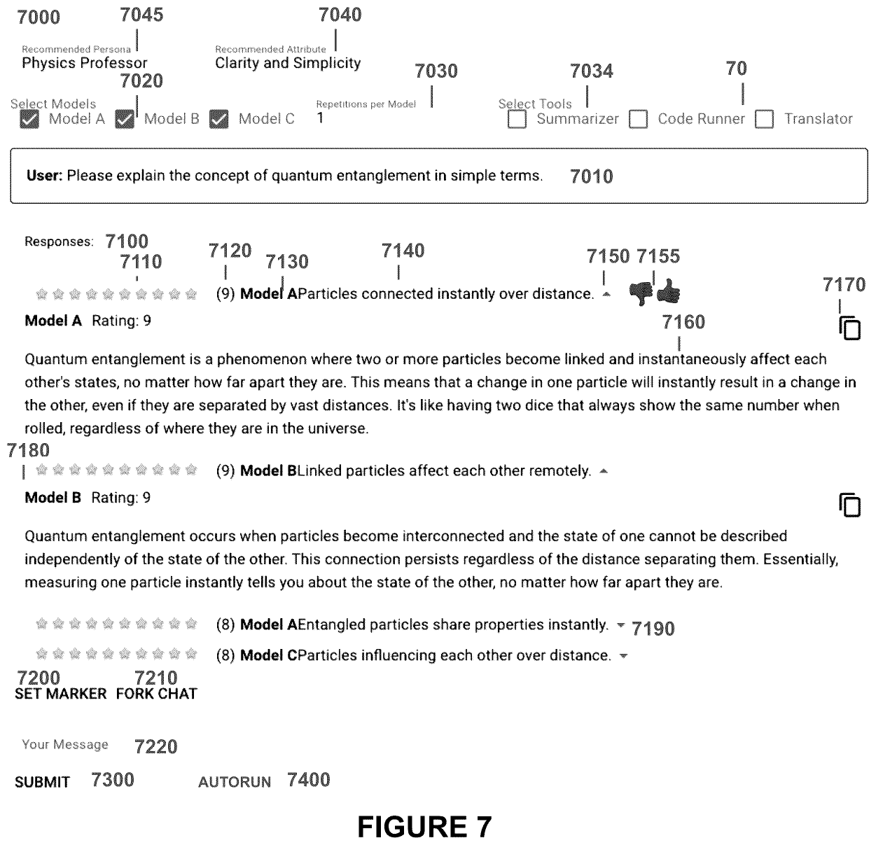

### FIG. 7. Multi-Reply UIS.

FIG. 7 represent a UIS for receiving, rating, evaluating, sorting, selecting responses, 7000. The software may provide an input where the user may enter a query, prompt, question, or specification 7010, or a location to load this from. The software may generate a response to this, for example the software may submit this prompt to one or more AI models. The software may provide an input for which AI models or other services to submit the prompt or query to 7020 to generate a response 7100. The software may provide inputs or selectors for the number of times the query or prompt may be submitted to the model or service 7030, and in this way the software may provide for multiple repetitions of the same query or prompt, including repetitions conducted in parallel or on different devices, models, or services, either on the user's local device or on remote devices or cloud services. The software may also use one or more tools to perform operations related to the responses 7100, for example using a code runner 7036 to run code if code is produced as a response, which may produce a tool output. In an additional step, after generating or receiving multiple responses, the software may evaluate those responses, or the tool output if the responses have been submitted to a tool 7034, such as the output of code if the response is submitted to a code runner 7036. As provided elsewhere in the application, the software may use one or more selectable attributes to evaluate or rate the responses 7040. The software may also use simulated one or more selectable personas 7045 to perform the evaluation, for example by using the AI models 7020. One or multiple responses 7100 may be organized into a list or table or other visualization. The responses may be sorted by the produced rating 7120, which may be the output of the evaluation step based upon the attribute(s) and/or persona(s). For the response, the software may provide numeric 7120 or graphical 7110 representations of the ratings, a summary or title of the response 7140, an open/close or expand/contract affordance 7150 which may show/hide the full response 7160. The software may provide to allow the input a rating or evaluation of the response 7155. The software may provide for the user to select or copy the response 7170, or to transfer the selected response elsewhere, for example to an integrated editor, IDE, app, or other software or service, including that this transfer may be done automatically. The software may provide 0 or more additional responses 7180 which may come from the same model or service or different models or services. The software may provide a list of responses ranked by rating 7120. The software may provide a condensed list 7190, showing only part of the responses. The software may also provide for the user to control a thread of successive responses. For example, the software may allow the user to submit further prompts, queries or instructions 7220 on the same thread. The user may also be able to set or name a tag or marker for a location on the thread 7200, and may be able to duplicate or save the thread 7210 for further analysis, and submit for further action 7300. Any of these steps may be automatable, allowing this process to be run in a loop by or as an agent 7400, for example with a stopping point when a threshold level of an attribute 7040 has been reached.

TABLE 1
EXAMPLE SYSTEM PROCESSING STEPS

| | |
|---|---|
| Content Input | The software may allow users to input content elements, for example for |
| | evaluation. This may include text, images, audio, video, VR, AR, models, agents |
| | software code, or other multimedia formats. Example uses may involve |
| | uploading text files for analysis or submitting web links for online articles. |
| Persona | The software may enable the creation, storage or selection of AI-driven |
| Creation | simulated personas. Users may define persona characteristics or persona |
| | attributes through the UIS for simulating user interactions. |
| Multimedia | The software may evaluate video and audio content, generating responses |
| Evaluation | based on predefined attributes. Specific uses may include rating the audio |
| | quality of podcast episodes, videos, game content, AR/VR environments. |
| Content | The software may evaluate one or more content attributes, such as readability, |
| Analysis | factual accuracy, engagement level, and writing style as they apply to a |
| | content element. Specific uses may include assessing articles for clarity, or |
| | video for sentiment. |
| Simulated | The software may simulate user interactions with digital interfaces using |
| UI/UX | simulated personas. This may involve navigating websites, using mobile |
| Interactions | applications, or interacting with physical devices. Specific uses may include |
| | simulating the user registration process on an app, or website navigation. |
| Feedback | The software may generate qualitative and/or quantitative feedback, for |
| Generation | example based on simulated interactions with content elements. This feedback |
| | may be provided as instructions for improving content or design. Specific uses |
| | may include feedback on clarity and engagement level of educational content. |
| Iterative | The software may support iterative improvement, e.g. continuously testing |
| Testing | and refining interfaces based on feedback. Specific uses may involve iterative |
| | testing of a social media post to enhance predicted user engagement. |
| Dynamic | The software may dynamically adjust parameters during simulations based on |
| Adjustment | real-time interactions. Specific uses may include altering persona |
| | characteristics in response to new content created by an author or creator. |
| Visualization | The software may visualize data using charts, graphs, tables, heatmaps, AR/VR. |
| and Reporting | Specific uses may include styling or displaying star ratings on content. |
| Integration | The software may integrate with analytics platforms, CRM systems, project |
| with Other | management tools, reading, writing, and design tools to enhance functionality. |
| Tools | Specific uses may include integration with apps, MS Office or Google Docs. |
| User Inputs | The software may provide input options through the UIS for entering content, |
| and | setting parameters, selecting personas, defining success criteria and other |
| Customization | uses. Users may interact with the software to initiate tests, review feedback. |
| | Specific uses may involve setting configuration for testing content elements. |
| Automated | The software may automatically enhance content based on generated |
| Content | feedback, creating novel content, optionally in an iterative loop. Specific uses |
| Enhancement | may include rewriting marketing copy to increase its persuasive impact. |
| Comparative | The software may compare a content element with a dataset of normative |
| Analysis | data, evaluating the content relative to benchmarks. Specific uses may involve |
| | comparing the readability of a manual against industry standards. |
| Performance | The software may predict content performance or other extrinsic variables, for |
| Prediction | example predicting reader engagement by correlating ratings with extrinsic |
| | variables such as social shares or sales volume. Specific uses may include |
| | predicting the virality of a content element based on previous trends. |
| Security and | The software may implement security protocols to ensure data privacy and |
| Privacy | integrity during operation. Specific uses may involve encrypting user data. |
| Automated | The software may provide facilities for the automatic downloading and |
| Updates | installation of updates, for example ensuring the system remains current. |
| | Specific uses may include updating AI models for improved accuracy. |
| API and | The software may support APIs and plugins for extending functionality and |
| Plugin | integrating to external services. Specific uses may involve providing the |
| Architecture | functionality to external software. |
| API and Tool | The software may execute internal or external tools, including via API calls, and |
| Use | including autonomous calling of internal or external tools by autonomous |
| | agent Ais or simulated personas or bots. |
| Software and | The software may execute specified software code or functions, for example |
| Code Testing | content elements that include code and are submitted for testing or as part of |
| and Execution | generating a response to the content element. This execution may include |
| | testing the results produced by the code, for example to determine whether a |
| | desired endpoint has been reached or an intended attribute achieved. |
| | Software testing and execution may also include sandboxing of code, IDE |
| | integration, and autonomous calling of internal or external code by |
| | autonomous agent Ais or simulated personas or bots. |
| Evaluation | The software may evaluate a content element and may manage multiple |
| | evaluations conducted in multiple runs or through parallel execution. |
| Cognitive | The software may create personas or persona attributes that are designed or |
| Model | mimic or predict human behavior, choices, intentions, and/or evaluations. |
| Context | The software may rate or edit content considering the context in which it is |
| | presented. Specific uses may include evaluating the clarity of a paragraph in |
| | the context of the surrounding chapter. |
| Model | The software may utilize AI models, including LLMs, or models trained using |
| | machined learning on a corpus of data, and including non-deterministic models |
| | which may generate variability in outputs. |
| Repetition | The software may generate multiple responses to a content element, including |
| | parallel executions of evaluations, and may generate statistical measures. |
| AI Agent | The software may provide functionality for an AI agent. The software may |
| | provide for a simulated persona to act as an AI agent. The software may |
| | provide for an AI agent designed to perform tasks or make decisions |
| | autonomously by leveraging artificial intelligence (AI) technologies. AI agents |
| | may operate based on a set of instructions, rules, learned patterns, or both, |
| | and they can interact with their environment to achieve specific goals. For |
| | example, an AI agent for content improvement may repeatedly generate and |
| | then evaluate content until a desired threshold level for a content attribute is |
| | reached, and then stop and provide the resulting output. |
| Selectable | The software may provide selectable predefined personas, audiences, |
| Elements, UI | instructions, agents, rules, tests, rubrics, schemas, and criteria for testing. |
| Training | The software may train models on a corpus of general content. The software |
| | may train models on user-specific content, e.g. to enhance accuracy. |
| Rubric | The software may evaluate content based on multi-part rubrics. |
| Hybrid | The software may provide for AI-assisted hybrid AI/human responses and |
| Responses | response editor, adjuster and/or accept/decline UI elements. |
| Simulated | The software may simulate personas and/or audiences for simulated |
| Persona | interaction and response scenarios, simulated rating and/or evaluation. |
| AI Model | The software may improve AI model outputs by generating multiple outputs, |
| Output | rating each output on an attribute, and selecting the highest rated one. |
| Grading | The software may provide for grading content elements, for example grading |
| | student assignments submitted as content elements, which may involve using |
| | a simulated persona of a teacher, a rubric, or comparable content that may be |
| | used for comparative grading such as ‘grading on a curve’. |
| AIignment | The software may provide for testing to ensure model alignment with intended |
| Testing | goals, outcomes, or rules. This may involve evaluating content against specified |
| | guidelines or other content attributes to ensure consistency with those |
| | guidelines or attributes. Specific uses may include verifying the alignment of |
| | model-generated content with safety or regulatory standards. |
| Data | The software may be used to rate or test data quality against one or more |
| Screening | attributes. The tested data that achieves requisite scores on the attribute(s) |
| | may then be used for model training. This may include identifying and filtering |
| | incorrect or poor-quality data. Specific uses may involve screening corpus data |
| | for high reliability and selecting before AI model training on the resulting data, |
| | and screening corpus data to determine which is AI-generated and selecting |
| | before AI model training on the resulting data. |
| Evaluation | The software may conduct both quantitative and qualitative evaluations of |
| | content. This may involve the use of defined attributes, simulated personas or |
| | audiences, metrics, ratings, detailed feedback, or re-creating. Specific uses may |
| | include evaluating marketing or written content for engagement potential. |
| Simulated | The software may use AI agents or simulated personas to take surveys, for |
| Survey | example personas based on given demographics and other descriptions. This |
| Participants | may involve simulating responses to generate aggregate data. Specific uses |
| | may include market research for consumer products. |
| Improved AI | The software may collect multiple answers from one or more AI model to a |
| Responses | given prompt, and select solutions based on their rating on one or more |
| | content attribute. This may involve generating and evaluating multiple |
| | responses before selecting the most suitable one. Specific uses may include |
| | improving chatbot or API functionality. |
| Iterative AI | The software may iterate to generate an answer based on successively |
| | generated feedback inputs. This may involve continuous refinement of |
| | responses by using the response out to each input as part of the input to |
| | generate the next output. Specific uses may include AI agents designed to |
| | achieve a particular goal state, or continuous improvement of content |
| | elements to meet a defined content attribute(s). |
| Mental | The software may assess user health status based on attribute ratings of |
| Health, Healh | content elements. For example, the software may assess the extent to which |
| Assessment | written content is similar to content written be individuals having or not having |
| | a health condition, such as a mental health disorder. This may involve |
| | analyzing text patterns, sentiment, and other behavioral indicators. Specific |
| | uses may include monitoring user wellness, including in a virtual therapy |
| | setting. |
| Report | The software may assess the quality of reports, for example by rating them on |
| Assessment, | one or more attributes. For example, the software may assess the accuracy of |
| Health | a written health diagnosis based upon content element input. |
| Diagnostic | |
| Assessment | |
| Simulated | The software may provide simulated user testing, for example using simulated |
| User Testing | personas to test a website or app interface or software application. |
| Generate | The software may create content to optimize a selected content attribute. For |
| Content | example, software may generate multiple content variants using a prompt, |
| | may use a selection step to select the best rated variant on a selected content |
| | attribute. Optionally, software may iteratively repeat this process, or be run |
| | by an AI agent. Specific uses may include drafting multiple versions of a |
| | marketing tagline or written article. |
| Model | The software may adapt and learn over successive interactions with users. This |
| Adaptation | may involve updating or training a model based on the new data and |
| and Learning | interactions provide. Specific uses may include personalizing recommendations |
| | for content delivery. |
| Generate | The software may provide automated feedback responses on content |
| Feedback | elements. For example, software may evaluate the quality of an input content |
| | element, and provide quantitative feedback such as one or more ratings of the |
| | content element on an attribute, or qualitative feedback such as |
| | recommending improvements to increase the attribute, or may provide |
| | recommended re-written or de novo content. |
| Editor Plugin | The software may integrate as a plugin in various text-editing applications like |
| | Word or Google Docs or CMS or IDE application or web apps or browsers. This |
| | may involve providing writing assistance and evaluation tools within these |
| | platforms. Specific uses may include writing style checking or style suggestions |
| | in document editing. |
| Story Arc | The software may facilitate the analysis of story arcs and narrative points. This |
| Analysis | may involve identifying key elements and their progression in a narrative. |
| | Specific uses may include analyzing the plot structure of a novel. |
| Network | The software may offer features to engage multiple users, such as writing |
| Effect | contests or automatically scored writing contests, leaderboards, collaborative |
| Features | editing, methods for sharing or posting ratings or badges generated by |
| | software on other platforms. |
| Comparison | The software may enable comparative analysis of multiple content variants to |
| | determine the best attributes. This may involve side-by-side evaluations. |
| | Specific uses may include A/B testing of web page designs. |
| Test Value | The software may test and validate value propositions. This may involve |
| Proposition | assessing how compelling a value proposition is to potential customers, using |
| | one or more content attributes. Specific uses may include validating marketing |
| | copy. |
| Code Runner | Software to run code submitted as input. For example, software may run code |
| | to test results, software may run code or functions to produce outcomes. |
| Tools | Software may interact with or control tools such as a code runner, browser, |
| | search functionality including web browsing and web search, database query, |
| | calculator/math libraries, external APIs, financial and investment platforms, |
| | crypto platforms, blockchain and smart contracts and APIs, see tools section. |
| Ranking | Software may rank content elements, for example ranking variant paragraphs |
| | based on a content attribute like clarity. |

### DESCRIPTION OF INVENTION

### Overview

### Background

The evaluation of content quality has traditionally used human judgment, which may be subjective and inconsistent. There may be a need for a system that may automatically respond to content and/or simulate diverse human perspectives and provide analysis of content quality across various attributes.

### Summary of the Invention

The invention provides devices, software and technology that may use artificial intelligence to evaluate or rate or provide responses to content based on one or more content attributes or simulated personas with one or more persona attributes. Each simulated persona may represent different demographic backgrounds, professional expertise, interests, or other characteristics that influence content perception. The technology may produce ratings for content quality, factuality, novelty, and other attributes. Furthermore, it may aggregate these ratings from multiple personas to derive statistical insights, enhancing the depth and breadth of content evaluation.

### Detailed Overview

The software may perform a multi-tiered contextual analysis that incorporates various levels of content scrutiny. The analysis may involve: Sentence-Level Analysis: The software may examine individual sentences within the immediate context of surrounding sentences, for example to assess content attributes like their contribution to the paragraph's meaning, flow, style, quality. Paragraph-Level Analysis: The software may assess how individual sentences support the primary idea of the paragraph, for example to assess content attributes like logical coherence, relevance, and stylistic consistency within the text. Section-Level Analysis: The software may evaluate the relationship between sections of a document, for example to assess content attributes like how each section contributes to the overall structure and narrative. Document-Level Analysis: The software may assess a document as a whole, for example to assess content attributes such as consistency in tone, style, thematic development, and overall flow across sections. Contextual Annotations: The software may apply contextual annotations to the text, for example based on content attributes tagging sentences, paragraphs, and sections with metadata that describes their roles and relationships, or providing icons or other designators for users. Content Suggestions: The software may generate content suggestions, for example to improve clarity, coherence, and relevance. These suggestions may appear as inline prompts for sentence rephrasing, paragraph restructuring, or section realignment. User Interaction System: The software may provide a user interaction system (UIS) to present the results of the analysis to a user. The user interface system may style or highlight content based upon its attribute score, may present suggestions for improvement, and may allow user-customized adjustments. Specific features may include color-coded highlights, context-specific tips, and interactive editing tools. Document Types: The software may adapt its contextual analysis capabilities to different types of documents, for example academic papers, medical reports or diagnoses, business reports, creative writing, and technical manuals. Machine Learning Integration: The software may integrate machine learning models to continuously improve its analysis based on user feedback and evolving language patterns, and to learn the preferences and style of the user based upon the user's input. The software may use AI models fine-tuned or trained on the content of the user. Multi-Language Support: The software may support multi-language analysis. The software may incorporate language translation, multi-language NLP, and multilingual grammar checkers.

### DETAILED DESCRIPTION

Technical Overview: The system may include a processing unit capable of executing software instructions stored in a memory. The software may enable the creation of AI personas, each configured to evaluate content based on predefined criteria. Operation: The process may begin when a segment of text or content is input into the system either through an input box, a web link, or by uploading a file or other means. The system may sample the content in various ways, such as evaluating entire texts or selected excerpts. The software may provide for more than one simulated persona to rate or evaluate or respond to the content according to its programmed characteristics, and these individual responses may then be statistically analyzed to produce averages, distributions, and correlations with external variables, such as sales performance. User Interface System: The user interface system may include various elements to facilitate operation, such as display panels showing individual and aggregated ratings, controls for initiating the rating process, and options for generating content based on previous ratings. These elements support iterative content development cycles, potentially under autonomous operation or with human oversight.

### Content Rating and Evaluation

Presented is a novel technology that may employ artificial intelligence (AI) to evaluate content. This technology may rate various types of content and generate assessments concerning their quality or other attributes using AI methodologies, including making multiple assessments and statistical inferences. The technology may accept segments of text or other forms of content as input and generate ratings or evaluations indicating the estimated quality or other attributes of the text. The software may use an AI prompt to an AI model or language learning model or other software or hardware to generate one or more responses to content or ratings or evaluations of content. The software may use AI-Assistance, where an AI prompt to an AI model or language learning model or other software or hardware is used to generate one or more responses to content or ratings or evaluations of content which may then be reviewed and/or approved and/or modified by humans. The software may provide UIS elements for AI-Assistance, such as for example: elements for a user to increase/decrease a rating or evaluation or response produced by software, elements for a user to approve/disapprove a rating or evaluation or response produced by software, elements for a user to modify the content of a rating or evaluation or response produced by software. These elements for a user to modify a rating or evaluation or response produced by software may include text areas, numeric increment/decrement, thumbs up/down selectors, drop-down, radio buttons or binary selectors, star ratings, sliders, or others.

### Quantitative

The software may produce quantitative ratings or evaluations of content. For example, the software may employ a prompt to an AI model such as GPT-4 like the following to produce a quantitative rating: “Rate the following short section taken from a non-fiction book chapter on a scale of 0-100 based on how effectively the content aligns with the specific attribute of evaluation. The rating should reflect your expert assessment of the text's strengths in the given area. Output your results as a computer-readable number formatted like this: “‘##’””. Here is the content to rate: <input content>”. Input content may be, for example, text, an image, a webpage or URL, a video, audio, language translation, gaming content or other types of content. In example prompts in this application, inputs denoted like this: <input content>may indicate that the elements within < >should be substituted for the type of content described, in this case an input content element.

### Qualitative

The software may produce qualitative evaluations of content or feedback related to content. For example, the software may employ a prompt to an AI model such as GPT-4 like the following to produce a quantitative rating: “Rate the following content on how effectively this image is likely to gain user attention, and describe why and how it can be improved. The rating should reflect your expert assessment of the image's strengths in the area of radiology. Output your results as a descriptive text. Here is the content to rate: <input content>”. Input content may be, for example, text, an image, a webpage or URL, a video, audio, language translation, gaming content or other types of content.

Validity/Veracity: The software may assess validity of content, such as whether it is authentic or copied, human generated or AI generated, correct or incorrect, or fake, for example by comparison with a database or using AI-based validation.

### AI Image Rating

The AI image rating component of the software may provide an automated mechanism for evaluating visual content such as photos, profile pictures, product images, social media posts, or marketing graphics, or a plurality of frames from video, optionally including audio or captions/subtitles. This function may assist users in selecting the most appealing or effective images based on predefined criteria and AI-driven analysis.

### Image Evaluation Criteria, Illustrative Examples

Aesthetic Appeal: The AI may analyze visual elements such as color harmony, composition, and balance to rate the aesthetic appeal of images. Relevance: The AI may evaluate the relevance of an image to its intended context or usage, ensuring it aligns with the content or product it represents. Quality: The software may assess technical quality, including resolution, sharpness, and absence of visual noise. Validity/Veracity: The software may assess validity of an image, such as whether it is authentic or AI generated/fake. Similarity: The software may assess similarity of an image to another image. Tagging: The software may tag images based upon their contents or attributes or categorical distinctions, such as including people, nature, their colors, or thematic elements.

### Use Cases, Illustrative Examples

Profile Image Selection: The AI may rate profile images, recommending the most suitable ones based on attributes like professionalism, approachability, or brand alignment, for example for Fr social media or professional networking sites or dating sites or apps. Product Image Optimization: The software may provide for rating product images, selecting those that best highlight the product's features and are most likely to attract consumer attention and purchasing behavior. Marketing Material Curation: The software may provide features for marketing teams to leverage the AI to rate potential images for campaigns, identifying those with the highest potential for engagement and conversion based on historical data and performance metrics. Photographers: The software may integrate with photography software, and provide features for photographers, including automated image enhancement, color, brightness, contrast, white balance, rating, content categorization and tagging.

### Selection and Optimization Process

Bulk Rating: The software may process and rate multiple images simultaneously or in bulk, enabling users to quickly identify the highest-rated images. Feedback Loops: Based on the ratings, the Al may provide suggestions for image improvements or alterations to enhance the visual content's performance, or may auto-generate new content. Text Creation: The software may provide for the creation of text content to accompany an image or video or audio, such as a transcript, or a post about the content, or a description of the content. Customizable Rating Scales: Software may provide for users to be able to define what criteria are most important for their needs, influencing how the AI rates each image.

### Video and Audio Segment Rating

The software may analyze and rate video, audio, or multimedia content. The software may automate the selection of impactful video clips or audio snippets.

### Video Rating

Visual Dynamics: The software may evaluate or rate the content, composition, movement, and transitions within video segments. The software may produce continuous evaluations or ratings of video, audio, or multimedia content, for example producing a timeline of ratings moment-by-moment, such as every 1 second, 10 seconds, etc. The software may produce continuous evaluations or ratings of more than one attribute of video, audio, or multimedia content, for example producing a timeline of ratings of engagement, interest, clarity, sentiment, emotional response, likelihood to buy, likelihood to respond to a call to action, moment-by-moment, such as every 1 second, 10 seconds, etc. The software may produce continuous evaluations or ratings of content, composition, movement, and transitions within video segments. Content Engagement: The rating may reflect the potential of a video to engage viewers of differing personas, including based on past viewer interaction data. Estimated User Ratings: The software may produce estimates of real human responses or ratings of one or more attributes of a video, which may predict the potential of a video to produce related responses in real humans.

### Audio Rating

Sound Evaluation: The software may evaluate audio content. The software may evaluate audio content in a granular fashion, rating individual sub-segments of the audio, or creating a timeline of ratings of one or more attributes, for example as described above for video. The software may select as attributes from the following list of illustrative examples and others: clarity, volume, balance, noise levels, likely engagement, accent, intonation, speech rate, parts of speech, speech to text, parts of speech, match with video, rhythm, tone, and emotional impact of audio content. The software evaluation may reflect the potential of audio or the transcripts of audio to engage viewers, and may be based in part on past viewer interaction data for other users or the current user. Software may provide for editors to use AI ratings to choose the most compelling video and audio segments for storytelling and impact. Software may provide for marketers to identify which segments of a commercial are most likely to retain audience attention and trigger intended responses.

### Language Translation Rating

The software may rate or evaluate language translations, including rating multiple attributes and producing granular timelines of evaluations, for example rating the accuracy and contextually appropriateness of translations. Localization: The system may assess cultural relevance and idiomatic correctness for localization.

### Use of Context by the Software for Producing Ratings and Evaluations

The software may receive user inputs of content and utilize them in conjunction with contextual data to generate ratings and evaluations of content. The software may perform specific operations that use context to assess and produce outputs reflecting evaluations, ratings, or other responses to the content, for example relating to the content's relevance, coherence, accuracy, and/or alignment with specified criteria.

### User Inputs and Content Processing

The software may receive various user inputs, which may include: The content to be evaluated; Specific guidelines or criteria for the evaluation; Selected external documents or data sources; Preferences regarding the desired style or tone or voice or other writing guidelines; Specific contexts, such as sample documents, the type of audience for the content, the purpose of the content, or relevant background information.

The software may respond to, analyze, rate, and/or evaluate the content based on these inputs. The software may use predefined or learned patterns to determine how each piece of content relates to the broader contextual framework provided by the user.

### Using Context to Analyze Content

The software may use context to generate in the rating and evaluation of content. Context may range from the immediate surroundings of a single sentence to many forms of the broader environment in which the content exists. By incorporating context at various levels—such as sentence, paragraph, section, and document—the software may produce responses that are based on context at different levels of granularity and/or for different purposes. The software may provide a user interface system that provides granular evaluations. For example, the software may color-code a document with each paragraph shown in a visual style, highlight, border, color or other style that indicates its rating on a particular selected attribute, such as clarity or engagement, and the user may have the option to select which attribute to view. The software may provide a ‘timeline’ of the rating of each attribute over the course of the content. The software may use smoothing or digital filtering of the timeline of the rating of an attribute.

Examples. The software may provide a paragraph-level context evaluation which may ensure that each sentence contributes meaningfully to the paragraph's primary idea, and/or that there is appropriate flow or transitions. The software may provide a document-level context evaluation which may ensure that sections work together cohesively to support the overarching theme or purpose of the content.

Application of Different Context Lengths. The software may adjust its contextual analysis based on different lengths of content, utilizing short and/or long context windows. This flexibility allows it to perform precise evaluations tailored to the specific needs of the content being analyzed.

Short context windows might assess local coherence and logical flow within a few hundred words. Long context windows could evaluate an entire document, ensuring consistency across sections and chapters. The software may also extend its context beyond the immediate document by incorporating external data sources, such as summaries or related documents, further enhancing the depth and relevance of its evaluations. The software may use AI models with context lengths in tokens of greater than 100, 1000, 10 k, 100 k, 1M, 10M, 100M, 1B.

External and Cross-Document Context. The software's contextual analysis is not confined to the content of a single document. It may incorporate external documents, whether authored by the same individual or by others, to provide a richer and more informed evaluation. This capability allows the software to maintain stylistic and thematic consistency across an author's body of work or to compare and contrast with external sources to emulate a desired style or avoid redundancy. The software may use external contexts such as writing from a different author, writing from a desired style, or even writing to be avoided as a negative influence. This comparative approach ensures that the generated evaluations are accurate and aligned with broader stylistic or thematic goals.

Diverse Contextual Inputs. The software may handle various types of contextual inputs, extending beyond the immediate document being evaluated. The software may incorporate context from different media types, including text, speech, video, and music, to inform the evaluation and generation of related content. The software may incorporate speech transcripts as context, using patterns in spoken language to influence the tone and flow of written content. The software may analyze visual media, such as video, to evaluate related scripts or subtitles within the context of visual cues. The software may draw on musical themes or lyrical content as context for evaluating or generating poetry or song lyrics.

Human-Like Contextual Evaluation. The software may simulate human-like contextual evaluation by incorporating a broad range of factors into its analysis. The software may simulate cognitive biases, applying known biases in the evaluation process to mimic how humans might interpret content based on prior information or emotional states. The software may evaluate content with an understanding of cumulative impact, analyzing how new sections build upon previously presented ideas. The software may adjust its evaluation process based on short-term or long-term memory of previous interactions, influencing how subsequent content is interpreted and responded to.

Advanced Contextual Operations. The software may engage in advanced contextual operations that enhance the depth and accuracy of its evaluations. The software may dynamically update the context as new information is added to the document, ensuring coherence and relevance throughout the writing process, including real-time updating. The software may detect and manage overlapping contexts, ensuring that content remains clear and non-contradictory even when multiple contexts intersect. The software may incorporate historical context or temporal elements, analyzing content against the backdrop of relevant time periods or cultural moments.

Context-Driven Evaluation Metrics. The software may use context-driven metrics to evaluate the relevance and appropriateness of content. The software may assess whether content aligns with the expected context, audience, and purpose. The software may evaluate the logical consistency and coherence of content, ensuring that it maintains a coherent flow throughout various contextual layers. The software may analyze the potential impact and persuasiveness of the content, considering how different audiences might interpret and respond to the material.

Interactive and AI-Based Context. The software may use interactive and AI-based contexts to further refine content evaluations. The software may incorporate feedback from interactive environments where users engage with the content dynamically, influencing ongoing content generation. The software may collaborate with AI systems in a co-creation process, where the context includes AI-suggested themes, structures, or stylistic adjustments to the content. The software may adjust its responses based on these AI-generated contexts, creating content that is dynamically informed by both human and machine-generated inputs.

The software may use reference content to analyze a target content element. For example, the software may assess a paragraph within the context of a whole book. The software may analyze target content using additional content from the document or the entire document as reference context. The software may analyze paragraphs using additional context from the same document and perform paragraph-by-paragraph analysis. The software may analyze paragraphs using additional content from outside the document, referencing other documents written by the same author, referencing documents written by different authors, or analyzing content using a database of articles. This database may be selected based on the content to be analyzed, involving related fields of inquiry and/or including articles on similar or related topics.

Content lengths, illustrative examples. The software may analyze different lengths of target content elements, including a sentence, a paragraph, a section, a chapter, or a full document. The reference content may also vary in length, including a sentence, a paragraph, a section, a chapter, a full document, or a collection of documents. The software may analyze target content elements from various sources, such as user-generated content, published articles, books, reports, social media posts, or emails. The reference content may come from other sections of the same document, other documents by the same author, documents by different authors, databases of articles and publications, online repositories, or historical archives. The software may handle various types of content, including textual content, graphical content, multimedia content, recorded speech content, location data, or neural data.

Use Cases, illustrative examples. The software may be used in academic research, editorial review, legal document analysis, plagiarism detection, content quality assessment, sentiment analysis, consistency checks, thematic relevance evaluation, contextual relevance evaluation, or factual accuracy verification, branding, on-brand-consistency evaluation, marketing. The software may include features for detailed contextual analysis, such as identification of key phrases, sentiment analysis, entity recognition, coherence analysis, relevance scoring, consistency checks, thematic alignment analysis, factual cross-referencing, fact checking, accuracy checking, style and tone analysis, or structural integrity checks. The software may utilize analysis techniques like natural language processing (NLP), machine learning models, statistical analysis, or pattern recognition.

The software may receive various user inputs of content and utilize them in conjunction with contextual data to generate ratings and/or evaluations of content and/or responses to content. User inputs may include the content to be evaluated, specific guidelines or criteria or rubric for the evaluation, selected external documents or data sources, and preferences regarding the desired style or tone or voice. The software may allow the user to input or select specific pre-created context selections, such as the type of audience for the content, the purpose of the content, or relevant background information. The software may allow the user to input a custom-created context, such as writing or pasting text to describe the context. The software may use a database of context selections. The software may analyze the target content in the context of these reference context inputs. The software may use predefined or learned patterns to determine how the content relates to the contextual information.

User Preferences, illustrative examples: The software may incorporate user-specified preferences, such as the desired writing style or tone, an example author to emulate or not emulate, prior examples of the author, into the contextual analysis. The software may adjust its evaluation based on these preferences, producing outputs that reflect the user's stylistic goals.

The software may perform a multi-layered contextual analysis based on the inputs provided by the user. This analysis may include sentence-level analysis, where the software evaluates individual sentences within the immediate context of surrounding sentences to understand their contribution to the paragraph's meaning and flow; paragraph-level analysis, where the software assesses how individual sentences support the primary idea of the paragraph, for example ensuring logical coherence and relevance and flow and style matching; section-level analysis, where the software evaluates the relationship between sections within the document, for example analyzing how each section contributes to the overall structure and narrative; document-level analysis, where the software considers the document as a whole, for example assessing whether the content maintains consistency in tone, style, and/or flow and thematic development across sections; outline analysis, where the software considers the content in the context of an outline, for example assessing whether the content has duplicates, is missing elements from the outline, or is consistent or inconsistent with the outline.

The software may integrate various types of contextual information into its evaluation process as reference content, such as using external documents provided by the user (e.g., prior works by the same author or relevant literature from other authors) as additional context for evaluating the content; incorporating factual databases to verify the accuracy of the content by cross-referencing the content with these databases to check for factual correctness; using summaries or outlines provided by the user to guide the content evaluation process by evaluating whether the content aligns with the main points or structure outlined in these summaries; and incorporating user-specified preferences (e.g., desired writing style or tone) into the contextual analysis. The software may adjust its evaluation based on these preferences, producing outputs that reflect the user's stylistic goals.

The software may generate outputs based on the target content and reference content. For example, the software may produce quantitative, numerical or categorical ratings that reflect the quality, relevance, engagement, or effectiveness of the content in relation to the specified context. The software may provide qualitative evaluations that describe how well the target content, with respect to the reference context, meets the criteria set by the user, including for example its alignment with the desired style, factual accuracy, and overall coherence; and recommendations for improving the content, such as revising sections for better coherence, adjusting the tone to match the audience, or correcting factual inaccuracies.

The software may compare the target content against a set of external documents reference content provided by the user (e.g., the author's previous works), for example to ensure stylistic and thematic consistency across the author's body of work;

The software may evaluate the target content against a factual database of reference content, for example for identifying any discrepancies or inaccuracies, and providing a rating or evaluation based on the content's factual reliability. The software may analyze the target content in the context of reference content including user-selected style or tone preferences, for example adjusting the evaluation to reflect how well the content aligns with the desired stylistic guidelines. The software may evaluate the content based on the context of the specified details describing the intended audience, for example considering factors such as the audience's knowledge level, interests, and expectations, and providing feedback on how to tailor the content for relevance and engagement.

The software may perform advanced operations to enhance its contextual analysis and outputs, such as continuously updating the context as new information is added to the document or as the user modifies their inputs, re-evaluating previous sections of the content in light of these updates, detecting and managing overlapping contexts within the content (e.g., when different sections address similar themes or topics), incorporating historical or temporal context by analyzing content in relation to relevant time periods or cultural moments, and evaluating how well the content fits within its historical context or how it might be received in the future.

Contextual Outputs After performing the contextual analysis, the software may generate outputs based on the integrated context and user inputs. These outputs may include:
Ratings: The software may produce numerical or categorical ratings that reflect the quality, relevance, or effectiveness of the content in relation to the specified context.
Evaluations: The software may generate detailed evaluations that describe how well the content meets the criteria set by the user, including its alignment with the desired style, factual accuracy, and overall coherence.
Recommendations: Based on the contextual analysis, the software may provide recommendations for improving the content, such as revising sections for better coherence, adjusting the tone to match the audience, or correcting factual inaccuracies.
Recommendations: Based on the contextual analysis, the software may provide re-written content, including a redline or selectable changes to the content.

### Context and Fact Checking

Factual Claims Comparison, Illustrative Examples. The software may compare factual claims within the content against a database containing a minimum of 50, 500, 5,000, 50,000, 500,000, 5 million, 50 million, 500 million, or 5 billion verified factual entries. The software may conduct this comparison to verify the accuracy of the content by cross-referencing the factual claims with the entries in the database.

Potential Lengths of Target Content for Factual Verification, Illustrative Examples. The software may handle various lengths of target content for factual verification, including a single sentence, a paragraph, a section, a chapter, or a full document.

Types of Data for Factual Verification, Illustrative Examples. The software may utilize different types of data for factual verification, including textual data, numerical data, graphical data, tabular data, and multimedia data (such as images, audio, and video).

Sources of Data for Factual Verification, Illustrative Examples. The software may use data from various sources for factual verification, including scientific articles, research papers, government publications, news articles, historical records, encyclopedias, and academic journals.

Types of Reference Context, Illustrative Examples. The software may use various types of reference context for factual verification or other purposes, including published books and eBooks, online databases and repositories, organizational reports and whitepapers, public records, and legal documents.

Specific Uses for Factual Verification, Illustrative Examples. The software may perform factual verification in several specific contexts, such as academic research to verify the authenticity of citations and references, news articles to ensure the accuracy of reported information, legal documents to confirm the validity of cited statutes and cases, business reports to validate financial data and market information, and medical documents to ensure the correctness of clinical data and research findings.

Vectorization of Reference Context Information, Illustrative Examples. The software may utilize vectorization techniques to transform reference context information into numerical vectors. The software may prepare the reference context by converting textual data into vector representations. The software may employ various algorithms for vectorization, including word embeddings, TF-IDF, or contextualized embeddings like BERT. For example, the software may convert a scientific article into a vector format to facilitate efficient comparison with factual claims.

Custom-Training of Models, Illustrative Examples. The software may implement custom-trained models to analyze reference context. The models may be trained using supervised learning, unsupervised learning, or a combination of both. The software may use specialized datasets to train models for specific domains, such as scientific research, legal documents, or medical records. For example, the software may custom-train a model using a dataset of legal documents to improve the accuracy of factual verification within legal content.

### Example Context AI Prompts to Illustrate Concepts

Here is an example prompt: “This is a target content element: <target content element>. This is a reference content: <reference content element>. Analyze this target paragraph and provide insights based on the reference content of the entire book's narrative.”

Illustrative example uses showing potential target content element and reference content element combinations:
“Evaluate the consistency of this section with the author's previous works.”
“Assess this document's factual accuracy using the database of scientific articles.”
“Compare this report's style and tone with the specified editorial guidelines.”
“Provide a relevance score for this chapter within the context of the full document.”
“Analyze this speech transcript and suggest improvements for coherence and flow.”
“Evaluate the thematic alignment of this research paper with contemporary literature.”
“Review this legal document for consistency and alignment with statutory guidelines.”
“Check this social media post for thematic consistency with the associated blog article.”

“Analyze this email for tone and suggest adjustments to match the corporate communication style.” “Verify the accuracy of this paragraph by comparing its factual claims against a database of 500,000 verified entries.” “Cross-reference the numerical data in this section with the financial records in the database to ensure correctness.” “Check the validity of the historical references in this chapter against the entries in the historical records database.” “Assess the factual accuracy of this research paper by verifying its claims against scientific articles in the database.” “Evaluate the factual correctness of the legal citations in this document against the public records database.” “Analyze this business report to confirm the accuracy of market data by comparing it with entries in the market research database.” “Review the medical information in this document and verify its accuracy against clinical data in the database.” “Validate the facts presented in this news article by cross-checking with verified data in the governmental publications database.” “Examine the factual references in this academic journal to ensure their authenticity using the database of academic articles.” “Verify the accuracy of the environmental data in this report by comparing with verified entries in the environmental records database.”

### Non-Deterministic Software, Models, Outputs

The software may generate non-deterministic outputs representing different possible responses to the same inputs. A non-deterministic model may produce varying yet valid outputs when presented with identical input data across multiple instances. This variability may stem from randomness or probabilistic decision-making processes within the model. This may simulate human-like and/or cognitive unpredictability.

Applications of Non-Deterministic Outputs, Illustrative Examples. The capability to generate non-deterministic outputs may be employed in various scenarios where statistical unpredictability or human-like unpredictability is desired.

### Statistical Content Evaluation, Illustrative Examples

The software may repeatedly evaluate or generate responses to a content element, generating a range of feedback that reflects the variability of human reviewers. For example, the software may analyze text copy or other content multiple times to produce varying responses which may then be averaged. The software may employ statistical methods to aggregate non-deterministic outputs, providing robust evaluations. For example, taking the average, median, standard deviation, standard error, correlation coefficient, correlation with human evaluation scores, anova, or other statistical measures of multiple runs, the software may produce composite scores. By making multiple non-deterministic runs, the software may provide feedback that captures a wide spectrum of potential human reactions from the same modelled persona, or from different personas.

Simulating Human Responses for Behavioral Prediction, Illustrative Examples. The software may simulate human responses to inputs or stimuli as a means of predicting human outputs or responses. The software may be used to mimic or predict human cognition, human cognitive responses, human psychology, or human behavior. The software may be provided with inputs, and with a prompt to produce a response wherein the response corresponds to a predicted human response to an input. The software may be provided with inputs, and with a prompt to produce a response wherein the response corresponds to a predicted human behavior. The software may be provided with inputs, and with a prompt to produce a response wherein the response corresponds to a predicted human choice or selection. The input may additionally include context.

Some use cases of simulating human responses, Illustrative Examples. Strategic scenarios. A business may use the software to predict how different customer demographics or competitors might react to new product designs or business decisions, with each simulation producing different responses or feedback that mirrors real-world variability. Similarly, military planners may use the software to assess how enemy combatants might respond to various strategies, with each run of the model producing diverse tactical predictions.

### Simulated Personas

The software may provide simulated personas based on persona attributes such as different criteria or characteristics such as age, ethnicity, occupation, opinions, expertise level, or based on other input information such as writing, speech or communications made by a person, resume/profile or other material that may be used to characterize a persona. The software may provide for the user to create or define simulated personas for example by providing different criteria or characteristics such as age, ethnicity, occupation, opinions, expertise level, or based on other input information such as writing, speech or communications made by a person, resume/profile or other material that may be used to characterize a persona. The software may cause a simulated persona to respond to the same content element multiple times to produce statistics such as the mean or standard deviation of their results, or to produce feedback. Additionally, the system may calculate averages, distributions, and statistical data from the responses or ratings collected from multiple queries of the same simulated persona, or from queries of more than one simulated persona, potentially providing insights into the broad range of reactions and interactions with the content.

This process may involve the use of AI to simulate different personas, each tailored to represent specific demographic, occupational, interest-based groups or other groups. For instance, a persona might be designed as an avid reader of non-fiction in the personal development sector, specifically within entrepreneurial marketing. The software may ask an AI persona as described to evaluate a provided segment of content. For example, the software may ask a persona to rate their likelihood of wanting to read similar content on a scale from 0 to 100.

### Persona Attributes and Descriptions, Illustrative Examples that May be Used in Prompts

Productivity Coach: Known for providing hands-on, practical advice and discerning beneficial techniques for personal development. Motivational Speaker: Thrives on empowering others and aware of what inspires action and personal growth. Psychology Researcher: Values evidence-based approaches and critically evaluates the credibility of information. Editor: Appreciates writing that communicates ideas clearly and maintains reader engagement. Innovative Thinker: Voracious reader of cutting-edge literature, appreciating original ideas that challenge the status quo.

AI-Powered Persona Creation: The software may enable users to use or create one or more simulated personas, for example entering persona attributes, for example for a simulated persona representing their target customer or user demographics. These simulated personas may be crafted based on a wide range of attributes, including but not limited to age, gender, interests, location, content consumed, content ratings, content created, browsing habits, purchase history, and more. By leveraging machine learning algorithms, the software may dynamically update these personas based on evolving data patterns and market trends.

### Example Persona Prompts

Examples of persona prompts, which software may present to an AI such as a LLM such as GPT-4, in combination with a rating prompt: “You are a Silicon Valley tech entrepreneur who devours books on productivity, strategy, marketing, and personal efficiency. You prefer books that offer actionable advice and innovative thinking, with a track record of favorable reviews from thought leaders.”, “You are a professional athlete who seeks inspiration and mental training techniques from books on peak performance and sports psychology. You resonate with content that includes personal anecdotes from top performers.”, “You are a political analyst known for your insightful columns and commentary. You prioritize non-fiction that delves into geopolitics, diplomacy, and historical leadership, with a strong narrative and original viewpoints.”, “You are a seasoned venture capitalist who has a keen interest in leadership and innovation. You gravitate towards books that dissect successful startups and offer wisdom on managing high-growth companies.”, “You are an executive coach and speaker who sources valuable material from non-fiction to empower your clients and audience. Books that explore personal transformation, leadership qualities, and communication skills attract you the most.”, “You are a curator of a prestigious innovation summit and you're constantly searching for books that push the boundaries of technology and futurism. You prize authors who back visionary ideas with solid data and persuasive writing.”, “You are a non-fiction editor at a top publishing house, with a focus on personal development, leadership, and business content. You are drawn to books that feature case studies of successful leaders and compelling stories.” Each of these prompts and others may be followed by a content element, and/or rubric, and/or question to respond to.

### Attribute Ratings

The software may also measure content against multiple attributes. For instance, one persona could assess content for factual accuracy, while another might evaluate the writing quality or innovation level. Other attributes could include marketability, purchase likelihood, or general sentiment. The technology may generate separate estimates for each of these attributes to provide a comprehensive analysis of content quality. Illustrative example attributes that may be computed by software: produce a relevance score indicating the degree of contextual alignment, with a numeric value between 0 and 100; generate a consistency score based on the frequency and correctness of term usage, represented as a numeric value from 0 to 100; calculate a readability score, expressed on a scale from 0 to 100; generate a sentiment score ranging from −1 (negative) to +1 (positive), inclusive of 0 (neutral); generate an engagement score predicting potential user interaction levels, represented as a numeric value between 0 and 100; create a deviation score based on the frequency of stylistic rule violations per 1,000 words

calculate an originality score based on textual overlap, expressed as a percentage from 0% (completely original) to 100% (complete duplication); generate a structural integrity score, ranging from 0 (poor structure) to 100 (excellent structure).

### Attribute Definitions, Illustrative Examples

The following represent illustrative examples of attributes that the software may evaluate for a content element. Factual accuracy: the correctness of the information presented; Relevance: the alignment with a specific topic or intent; Clarity: the ease with which the content can be understood; Quality of writing: including grammar, coherence, and flow; Compliance with predefined standards; Consistency: the correctness and frequency of term usage; Readability: the ease of understanding, often measured on a scale; Sentiment: a score reflecting the overall tone, from negative to positive; Engagement: the predicted level of user interaction; Deviation: the frequency of stylistic rule violations; Originality: the degree to which content is original versus duplicated; Structural integrity: the organization and quality of the content's structure; Marketability: the potential appeal and demand for a product or service featured; Time on task: the time users take to complete specific tasks; Success rate: the percentage of users successfully completing a task; Error rate: the frequency of errors encountered by users; Practical utility: the content's ability to offer clear, actionable steps; Inspirational value: the content's capacity to motivate or drive transformative thinking; Credibility: the accuracy of the information and reliability of sources; Innovativeness: the novelty of insights or depth of analysis; Emotional connection: the content's ability to evoke an emotional response; Structure and organization: the logical flow and clarity of ideas. The software may use the short representative definitions provided as parts of AI prompts to evaluate attributes. For example, taking the first attribute, the software may use the prompt: “Evaluate the following content for Factual accuracy on a scale of 0-100, based upon the correctness of the information presented.”

### Attribute Prompts, Illustrative Examples

Engagement: “Rate content based on its ability to captivate and maintain the reader's interest throughout.” Practical Examples: “Rate content based on the inclusion and relevance of practical examples that illustrate key concepts.” Relevance: “Rate content based on its relevance to current trends and issues in the field of personal development.” Emotional Connection: “Rate content based on its ability to create an emotional connection with the reader.” Structure & Organization: “Rate content based on the logical flow and clear organization of ideas, ensuring ease of understanding.”

### Combined Persona and Attribute Prompts, Illustrative Examples

Practical Utility: “Rate content based on its ability to offer clear, actionable steps that can be integrated into daily life.” Inspirational Value: “Rate content based on its ability to motivate, uplift, and drive transformative thinking in its readers.” Credibility & Accuracy: “Rate content based on the accuracy of its information and the reliability of its sources.” Clarity & Writing Style: “Rate content based on the articulation, flow, and overall readability of the text.” Innovativeness & Depth: “Rate content based on the novelty of its insights and the depth of analysis provided.”

### Multiple Ratings

This software may make ratings or evaluations of a content element more than one time. This software may make ratings or evaluations of a content element using more than one model, more than one persona, more than one evaluation criterion, more than one evaluation rubric, more than one schema, followed by selection, aggregation, and/or statistical analysis of the multiple results. This software may make ratings or evaluations of a content element using a UIS that allows selection of one or more than one pre-defined persona, evaluation criterion, evaluation rubric, and/or schema.

### Parallel Execution

The software may use multi-threaded or parallel execution. For example, the software may make multiple ratings at the same time, that overlap in time meaning one evaluation is started before the last is completed, in parallel. For example, the software may call an AI API to generate a rating of content, and prior to the time that this process has been completed, the software may call an AI API to generate an additional rating of content. In this way, the software may be able to accomplish a number of ratings in a shorter period of time, for similar to the time required to accomplish a single rating, rather than the sum of the time required to accomplish of the ratings. The UIS may allow the user to specify the number of ratings to use, see figure element “#samples”.

### Statistical Evaluation

The software may employ various statistical methods to analyze the results of multiple ratings gathered and to make comparisons. These evaluations may be applied when comparing ratings from different elements of content, different personas, different attributes, different models, different benchmarks, different industries or use cases, different content elements, different criteria, different rubrics, different reference elements, or other differences.

### Basic Statistical Measures

Mean Calculation: The software may calculate the mean (average) value of multiple ratings, providing a central value that represents the dataset. This mean may be displayed to users or used in subsequent analyses. Standard Deviation: The software may compute the standard deviation or standard error, which may also be presented to the user or used in further calculation. The software may incorporate statistical tests to analyze the evaluation or ratings data and compare different ratings or groups of ratings. T-Tests: The software may provide one-sided and/or two-sided T-tests, which may be used to determine whether there are significant differences between two groups' of evaluations or ratings averages. This may be applied when comparing ratings from different elements of content, different criteria, different rubrics, different personas, different attribute ratings, or between different industries or use cases, or other differences. Software may provide Chi-Squared Test for categorical data analysis, Mann-Whitney U test for non-normally distributed data, Pearson Correlation Coefficient to measure the strength of association between continuous variables. Software may provide bootstrap statistics and mote carlo simulations. Software may provide non-parametric statistics. Software may use Bayesian statistics. Software may use Bayesian statistics to make predictions, such as predictions of extrinsic variables or behavior based upon the prior of ratings or evaluation data.

Regression Analysis: Both single and multiple regression analyses may be employed by the software to examine the relationships between multiple independent variables and a dependent variable. This may be useful in predicting how content might rate based on various input factors, for example content length, personas, types of personas, content areas, or attribute personas. Single or multi-factor regression models or other quantitative measures or multi-variate statistics may be employed by the software to assess the impact of various factors on content ratings. Such an approach may include a range of variable regressors-categorical, binary, or continuous-to predict outcomes such as estimated sales in dollar units. Curve Fitting: The software may use curve fitting techniques to create a line or a curve that best fits the scatterplot of data points, for example the relationship between ratings and an extrinsic data measure, such as sale price associated with individual pieces of ad content, or human-generated ratings or scores or grades, or success at another achievement, such as being admitted or hired or achieving an employment or other goal or target. Software may present scatterplots of data displaying one variable vs another or scatterplots with lines or curves. Pattern Classification: Advanced pattern classification algorithms may be provided by the software to categorize content into different quality levels or types based on their ratings. The software may provide automated sorting and filtering of datasets. Neural Network and AI Models: The software may use neural network or AI models to analyze data. Results of statistical calculations and evaluations may be presented to users through a user interface system, see FIG. 3, enhancing their ability to make informed decisions based on the ratings.

Comparisons with Other Ratings

The software may compare the rating or ratings of a test content element with the rating or ratings of comparator content elements. For example, the software may generate a content rating for a test content element paragraph from a book or article The software may generate content ratings for comparator content elements such as a paragraph from other books or articles, for example from other books or articles from the same field of endeavor. The software may then provide the user with a comparison of the rating from the test content element with the rating(s) from the comparator content elements. The software may provide statistical comparisons. For example, the software may provide the user with whether the test content element rating is below or above the mean of comparator content element ratings, and by how much. For example, the software may provide the user with the percentile or decile or other fraction within the distribution of comparator content element ratings the test content element is at. For example, the software may provide the user that the rating of their paragraph of test content is at the 70% percentile of ratings from a sample of other paragraphs from a normative set of content, such as paragraphs from published articles or books in the same field.

### Graphical Representations

The software may provide graphical representations of any of the data generated, FIG. 3. For example, FIG. 3A the software may provide a bar graph showing the rating of the current piece of content and the ratings of other pieces of content, optionally with error bars such as standard deviation, standard error, or other error estimates. For example, FIG. 3 B the software may provide a scatter plot showing more than one variable, such as a rating and an extrinsic variable. The software may show the position of the test rating on the scatter plot with comparison ratings. The software may show the estimated extrinsic variable data for the test rating value based upon a curve fit to the comparator data, such as a linear trendline (shown), or other non-linear data fit, and optionally may show R squared or other measures of accuracy or variance explained. The software may show error bars in one or both dimensions in the scatter plot. For example, if the points plotted represent the mean of more than one piece of data. The software may present data of quantitative content ratings as any of a variety of charts, including bar graphs, scatterplots, line graphs, pie charts, area charts, and may use error bars. The software may present data as charts, tables, including interactive pivot tables. The software may provide graphical representations of ratings aligned with content, for example providing a number or color of each individual content element, or visually styling the content element.

### Performance Estimates and Prediction

### Reference Data

The software may incorporate one or more databases containing normative data, which may serve as benchmarks or standards for comparison purposes. These databases may provide references for the ratings generated by the software, enabling users to understand how a piece of content compares to other similar content in a relevant dataset.

### Database Structure and Content

Content-Specific Databases: The software may maintain separate databases for different types of content. For example, the software may maintain a distinct database for books, another for articles, or a database based on the different content areas or fields of use, or by different authors or genres, and yet another for multimedia content like videos or audio recordings. Each database may store ratings, evaluations, responses produced by the software, and additional metadata relevant to its content type, such as genre, publication date, and authorship. Rating Metrics: Within a database, metrics may be recorded, such as average ratings, median ratings, percentile ranks, and standard deviations. Extrinsic Data: Within these databases, extrinsic metrics may be recorded, such as sales price or sales volume data associated with advertisement copy, user ratings or sales volume associated with published content, engagement data associated with social media posts, or others. This may allow comparison of ratings metrics or evaluation data vs. extrinsic data such as sales volume, price, value, performance, or other measures of success or other measures that the software may compare with ratings metrics or evaluation data.

### Performance Prediction

The software may make predictions of performance through determining the relationship of a rating or evaluation and an extrinsic variable in a dataset. The software may predict the performance of a content element based on performance data, like extrinsic variables, of other content elements. For example, the software may maintain a database of the number of social shares of other pieces of content (an extrinsic variable), as well as their rating on one or more particular attribute, such as clarity, or likely engagement. The software may then compute the same rating on a new content element, such as its clarity or likely engagement. The software may then predict the social shares of the new content element by taking the mean of the social engagement of other content elements with a similar rating for clarity or likely engagement, or by using multivariate statistics to predict one variable (social shares in this case) by another (clarity or likely engagement), optionally while statistically removing additional confounds (for example length of content). The software may provide to the user a predicted extrinsic variable for a piece of content, derived from the content based on prior data on related content and its values of a similar extrinsic variable. The software may provide charts or graphs representing the relationship between rating values and an extrinsic variable and may indicate the location of a current content element within a chart or graph, such as a bar graph, histogram, like graph, or scatterplot, FIG. 3B.

### Data Collection and Maintenance

Dynamic Updating: The databases may be updated with new data to keep the normative benchmarks current. This software updating process of the data may involve automated systems that collect and integrate ratings from new content as it becomes available and may be performed by software in real time. Data Quality Assurance: Measures may be implemented to ensure the accuracy and reliability of the data within these databases. This may include validation checks, outlier analysis, and periodic reviews of the data collection methodologies.

Integration with Rating Systems

Comparative Analysis: When rating new content, such as a paragraph from a book, the software may automatically retrieve relevant normative data from a database to provide a comparative analysis. The software analysis may indicate how the new content ranks against comparable content in terms of quality, engagement, or other relevant metrics. The software analysis may provide qualitative comparison of the content vs. content in a database, or qualitative feedback regarding how to make the content more, or less, like content in a database. For example, the software may compare a content element with a database of other content from the same or other authors, and may provide a determination of ratings vs the database content, or comparisons of quality, style, tone, voice or other attributes vs the database content, may rewrite the content to be more (or less) similar to the database content, may write feedback regarding how the content is or could be more (or less) similar to the database content. Threshold Setting: The software may allow for the user input of a selection threshold. The software may use reference data to establish performance thresholds or benchmarks that content may meet or exceed. These thresholds may allow publishers, marketers, or content creators to achieve or surpass industry or other standards. The software may provide iterative improvement of content as measured with one or more attributes until a selected threshold is reached.

Displays, Illustrative Examples: The software may feature a user interface that graphically displays comparative ratings using charts, graphs, and histograms. These visualizations may help users quickly assess where a piece of content stands relative to the normative data. Filtering and Search Functionality: The software may provide for users to filter and search the normative databases based on specific criteria, such as content type, rating range, or other metadata, enabling targeted comparisons tailored to their needs. The software may allow for the user to filter or select content elements based upon a threshold. For example, the software may provide for each paragraph in a document to be rated, and they allow the user to set a threshold and only display paragraphs above (or below) the selectable threshold or that meet other criteria, or that meet multiple criteria.

### Distributions and Percentiles

In addition to maintaining normative data, the software may analyze and utilize distributions and percentiles to provide a more detailed statistical understanding of where a piece of content stands within a broader context. These statistical tools may help quantify the variability and relative standing of content ratings.

### Statistical Distribution Analysis

Distribution Types: The software may calculate and utilize various types of distributions, such as normal distributions, skewed distributions, or bimodal distributions, depending on the nature of the data, and may statistically compare ratings or evaluations data to these distributions. Visualization: Distribution curves and histograms may be generated by the software and presented to users to visually represent the spread and density of ratings within the database, and where a given content element falls within a distribution or histogram. For example, the software may provide a histogram of ratings, showing where the a current content element that has been analyzed falls within the histogram. Percentile Ranks: The software may calculate percentile ranks for individual ratings, placing them within the context of a dataset. For instance, the software may compute that a content element rated at the 90th percentile outperforms 90% of the comparator group in the database and may use statistically modeled distributions in this process. Segmentation by Percentiles: Content might be segmented into various percentile ranges, such as top 10%, bottom 25%, etc. Benchmarking: Percentiles and distribution analyses may be used as benchmarks for determining the success of content. These benchmarks provide a quantitative method for setting and evaluating goals related to content performance. Adaptive Thresholds: The software may dynamically adjust thresholds for quality or engagement based on the evolving distributions of ratings within the normative data. This adaptability ensures that the benchmarks remain relevant and challenging.

### User Interaction and Utility

Interactive Tools: Software may provide for users to interact with the distribution and percentile data through tools that allow them to adjust parameters and see how changes in parameters, content or ratings affect the content's location within the distribution, for example its percentile rank.

### Content Sampling

The software may employ sampling to selectively analyze portions of larger content bodies, such as books or articles, to generate representative or specific ratings or evaluations or other measures. This technique may allow for evaluation of content without the need for full analysis. Random Sampling: The software may implement random sampling to select paragraphs or sections from a text or content randomly. Stratified Sampling: To capture the variability within different parts of a text, the software may use stratified sampling based on characteristics (e.g., chapters, topics), and samples may be drawn from each stratum proportionally. Systematic Sampling: The software may select samples according to a fixed periodic interval (e.g., every tenth paragraph). Systematic sampling can be particularly useful when the text has a uniform structure. A given content element may be compared with a sample from a document, set of content, or database. Granular Analysis: Sampling different paragraphs or sections enables a more granular analysis of content. For instance, it may help identify which parts of a book are most engaging or which paragraphs in an article are unclear. The content may be highlighted or styled or annotated based upon the content ratings for the whole content, or for sub-sections. For example, each paragraph within an article may be color-coded or styled based upon its rating for quality, factual validity, or match to user keywords or other parameters.

A/B Testing: The software may support A/B testing to compare two or more different content versions directly, allowing users to select the most highly rated or the user selected option. The selected version may be used, and the other version discarded. Additionally, the software may provide for automated A/B testing, for example using an AI model to compare two or more content elements to select the one higher (or lower) rated on one or more attributes.

### Content Filtering Based on Ratings

The software may utilize ratings to facilitate the labelling, sorting and/or filtering of content, articles or posts, enhancing user experience by curating content to match personal preferences or search queries. Star Ratings and Sorting: Articles or content may be automatically assigned star ratings or other evaluative metrics or symbols by software based on their quality or relevance using the rating methods provided. Software may provide that users may sort, or filter content based on these ratings, allowing them to quickly access highly-rated material. Personalized Filters: Ratings may also be generated by software based on user-specific queries or personas, which may mirror individual preferences, such as reading habits or learning objectives. This personalized approach may increase the likelihood that users are presented with content that aligns with their interests. User-Defined Criteria: The software may enable users to set their criteria for filtering, such as only displaying content above a rating threshold. Dynamic Filtering: Filters may be dynamically adjusted by software as a user's preferences evolve, learning from interaction patterns to provide a more tailored content discovery experience.

### Simulating Responses to Content Using AI-Powered Personas

Simulation Environment: The software may offer a simulation environment where content, posts, advertisements of various formats (text, image, video) may be tested by software using Al personas/bots. This software may allow for the creation of artificial estimates of real human engagement metrics, such as click through rates or other conversion variables. This software may allow for adjustment of parameters such as ad placement, timing, and frequency, to observe potential impacts on persona engagements.

Engagement and Response Analytics: Following each simulation, the software may provide in-depth analytics on persona engagement and responses. These analytics might include metrics such as click-through rates, conversion rates, engagement duration, and emotional responses inferred through AI analysis. Optimization Recommendations: Based on the collected data and analytics, The software may generate recommendations for optimizing advertisement or content strategies. These recommendations may encompass changes in ad content, format, placement, and targeting strategies to improve overall engagement and conversion rates. Dashboard: The software user interface system may provide a dashboard that displays simulation analytics, simulation results, and recommendations. Persona Editor: The software may provide a dedicated interface for selecting pre-created personas, creating and editing AI-powered bots and personas. This editor may allow users to define and adjust persona and text descriptors and to copy/paste content. Simulation Setup: The software may provide an interface designed for setting up and launching advertisement simulations. Software may provide for users to select personas, ad materials, and simulation parameters within this area.

Reports and Analytics Viewer: The software may provide a viewer for a user to view detailed reports on simulation outcomes, analytics, and optimization recommendations. This viewer may support various data visualization formats, including graphs, heatmaps, and charts, for easier interpretation of results. Database Storage: The software may provide for any of these elements, including user profile elements, personas, content, attribute descriptors, and analysis results to be stored to a database and/or retrieved from a database. Attribute Sliders and Dropdowns: For creating personas, software may provide that users may interact with sliders and dropdown menus to select pre-created persona attributes or may type or speak using speech to text to create new attributes or persona descriptions. File Upload Interface: Software may include a file upload and/or download interface supporting various ad formats (e.g., .txt, .docx, .csv, .json, .jpg, .mp4, .mp3). Parameter Configuration Tools: For simulations, input elements such as checkboxes and text fields may allow users to configure specific parameters like ad frequency and duration. Engagement Summary: Software may provide reports which may contain a summary section highlighting key engagement metrics and how they compare to benchmarks or previous simulations. Persona-Specific Insights: Software may provide detailed insights on how each bot/persona interacted with the advertisement, including preferences and behavior patterns and AI-generated responses from the persona. Optimization Suggestions: A dedicated section for optimization suggestions provided by software may offer actionable advice regarding how to improve content, for example to increase conversion rates or other predicted extrinsic variables based on content ratings.

### Simulated Persona Creation and Management

Selection of Simulated Personas: The software may present users with selections of individual simulated personas, groups of personas, or user testing panels comprised of multiple simulated personas. Simulated personas may be created by defining characteristics, criteria, behaviors, membership in groups, choices or by description. Software may provide characteristic or criteria selection menus, AI prompt templates and examples, Customization tools, sliders, checkboxes, dropdowns, Persona selection dashboard. Persona Database Storage: The software may facilitate the storage of personas in a database. This may ensure easy access and retrieval of persona data for various testing scenarios. Grouping and Tagging: The software may provide that personas may be organized into groups or tagged with specific identifiers. This organization feature may support users in sorting or filtering or selecting the appropriate persona or group for their research needs.

### Multiple Attribute Testing Framework

### 1. Single Persona Testing

The software may provide single persona testing functionalities, for example allowing a user to have a single AI persona rate or evaluate content through AI-driven simulations on a single target user persona. This process may involve AI prompts that ascertain how a specific persona interacts with and reacts to the content when queried, for example through a chat session with the persona or bot which presents the content, then asks the persona or bot to respond to it or answer questions about it. The software may guide users through creating detailed personas, including demographic information, interests, persona example user social media profile or posts, and purchasing or other habits.

AI-Simulated Persona Choices and Interactions: Utilizing AI prompts, the software may create a simulates persona response to content. For example, software may provide a simulated persona's response to advertising content, assessing likelihood of the persona's actions such as the likelihood of purchasing, clicking to learn more, sharing contact information, and recommending the product to others. For example, the software may use a prompt like: “You are <persona description>. Your intent is <intent description: to buy a watch>. You see this advertising content: <content element>. What is the likelihood that you <simulated action: click a button to select ‘buy now’>?” For example, the software may use a prompt like: “You are <persona description>. Your intent is <intent description: to buy a watch>. You see this advertising content: <content element>. Which of the following choices would you make <alternative choices: click a button to select ‘buy now’, click a button to select ‘maybe later’>?”

Simulated persona Engagement Metrics and Decision Metrics, Other Metrics: Software may measure simulated persona engagement metrics using bot/persona simulations, including, but not limited to, click-through rate (CTR), bounce rate, understanding of content, confusion about content, confusion about how to carry out an intent, clarity on action required to carry out an intent, time spent on a page, and social media interactions (reactions, shares, comments). Software may measure simulated persona decision metrics using bot/persona simulations, including, but not limited to, UI element selection, navigation selection, continuing to listen or read or consume content, purchasing decisions, movement decisions, movement path, navigation path in a real or virtual environment. Software may measure simulated persona understanding metrics using bot/persona simulations, including, but not limited to, understanding of the answer to a question based upon content, memory of the answer to a question following presentation of content. Software may measure simulated persona failure metrics, such as likelihood of failure of the simulated persona to complete a measured task, such as purchase an item, successfully make a measured choice, successfully navigate a UI path to find a goal state.

AI Quantitative, Qualitative Responses: The software may provide AI-generated numerical ratings on content or any of the above measures or metrics in this section. The software may provide AI-generated qualitative responses or feedback on content or any of the above measures or metrics in this section. The software may provide AI-generated suggestions on how to modify content to achieve a result, such as a simulated persona choice, action, decision, understanding. The software may provide AI-generated modified content to achieve a result, such as a simulated persona choice, action, decision, understanding. Report Generation: The software may allow the generation of reports summarizing persona reactions and interactions with the content. These reports may compare various content pieces on any of the described metrics.

### 2. Multiple Persona Testing

Expanding on single persona testing, the software may provide for users to execute tests across multiple personas and simulated personas either sequentially, or simultaneously, in parallel. The software may provide for a simulated audience comprised of different personas with different defined characteristics to evaluate, rate, or respond to a content element. The responses, evaluations, ratings, or other metrics may then be compared by software across different personas. For example, the software may compute and compare ratings of a content element produced by a simulated persona defined by being an editor with ratings of a content element produced by a simulated persona defined by being a non-fiction reader.

Simultaneous and Sequential Testing: Software may provide for users to conduct tests across multiple simulated personas or audiences simultaneously and/or in parallel. Comparative Analysis Tools: The software may include tools to compare generated responses across multiple simulated personas, or audiences. Aggregate Statistics: Software may aggregate results from multiple personas to provide group statistics. Software may provide an aggregated result from a simulated audience made up of multiple personas, to predict how this audience might react to a content element. Differences in Simulated Persona Response: Software may analyze and provide differences in response metrics between different personas, for example providing different rating means, rating variability (for example variance, standard error, standard deviation), providing different qualitative feedback. Persona Creation Wizard: Software may provide a wizard interface to guide users through the process of creating detailed personas, including setting characteristics, criteria, content relevant to the persona, demographic parameters and behavior. Content Upload and Selection Area: Users may upload content or select from a library of existing content for defining a persona or audience. Pre-Defined Personas: Software may provide pre-defined personas or persona definitions that may be selected or edited by users. Defined Personas: Software may provide pre-defined simulated audiences, or combination of persona definitions, that may be selected or edited by users. Testing Configuration: This software may allow users to configure the specifics of their testing, such as choosing the type of test (single or multiple persona, audience), selecting number of tests to run, selecting ratings, evaluations, or metrics to measure. Report Generation: the software may generate user-customizable reports, choosing which metrics to include and the format of the output (ratings, content, graphs, tables, text summaries). Persona Specifications: Users may define personas by inputting specific attributes such as age, gender, interests, related content, previous writings for authors, and previous behaviors. Tags, Content Descriptors: For each piece of content, persona, audience, rubric, schema, or other element within this system, users may add descriptors or tags to help the AI understand the context and intended audience. AI Interaction Prompts: Users may customize the AI prompts used by software during testing, tailoring questions or actions to their specific needs.

### Comparative Analysis

Benchmarking Tools: The software may provide that users may compare content ratings or evaluations or predicted performance against previous benchmarks, variants, iterations, competitor content, or industry standards. Conjoint Analysis: The software may provide to predict which content or product features are most valuable by using simulated personas to simulate trade-offs and measure ratings or evaluations of content or product descriptions with different combinations of features or content elements. Simulated Net Promoter Score (NPS): Software may measure NPS by providing NPS questions to simulated personas, for example asking a simulated persona how likely they are to recommend a product.

External Data Sources: Software may provide for users to input web pages, for example through inputting a URL, or connections to real time data feeds, or other API or database input sources.

### Conversion Rate Optimization Tools

### Predicting User Actions, Choices or Conversion Rates

The software may provide predictive modeling functionalities to estimate potential user responses and conversion rates precipitated by advertising or content stimuli using simulated personas or simulated audiences. Software may provide forecasting user actions using simulated personas and estimating conversion rates based on interactions with content by simulated personas.

Forecasting User Actions: The software may provide for predicting potential actions that users might undertake in response to specific content or advertisements. These predictive algorithms may analyze historical data, user interaction patterns, and engagement metrics to forecast the likelihood of actions, such as clicking on an ad, viewing product details, or completing a purchase. The software may also factor in demographic data, user behavior on third-party sites, and social media engagement to refine its predictions.

Data Input Elements: To facilitate accurate predictions, the software may allow users (e.g., marketers, advertisers) to input various types of data, including but not limited to:-Historical user interaction data-Demographic information of target audience-Previous ad performance metrics-Social media engagement rates-User behavior on third-party sites. UI Elements for Prediction Display: The software may present probabilities or scores that indicate the likelihood of various user actions, including conversion rates, including graphs and charts visualizing predictions, comparative analysis between different content or ad scenarios, heatmaps showing engagement likelihood across different ad components, simulated persona decision trees outlining probable user pathways or series of choices after content or ad exposure.

Estimating Conversion Rates: The software may estimate conversion rates in future human users by measuring simulated conversion rates using a simulated persona or simulated audience, FIG. 6, 7. Simulation of User Interactions: The software may simulate interactions with ads or content. These simulations may incorporate:-Navigational patterns across the ad or landing pages-Interaction with ad elements (e.g., clicking on call-to-action buttons)-Duration of engagement with different parts of the ad-Sequential steps taken after ad engagement in a simulated purchasing process. Simulation of Ad Placements: The software may simulate where ads or content are placed, for example measuring simulated persona responses to content placed in different social media sites, different ad distribution networks, or within the context of other leading, following, or surrounding content. Conversion Rate Estimation Metrics: The software may employ statistical models to estimate conversion rates. This estimation process may consider factors such as ratings, answers to questions, choices among behavior options, the number of engagements, interaction quality, and the steps taken by bots/personas post-engagement. The software may display these estimates through:-Detailed reports breaking down estimated conversion rates by ad variation-Comparative metrics showing the performance of different ad elements-Predictive conversion funnels illustrating potential user journeys from ad exposure to conversion. Recommendations for Ad Adjustments: Software may provide actionable insights or recommendations, for example predictions of how to increase conversion rate by changing content or ads. The software may provide guidance on:-Adjusting ad creatives for higher engagement (e.g., refining messaging, visuals)-Optimizing ad placement and timing based on user behavior patterns-Tailoring targeting strategies to focus on high-conversion user segments.

### Attribute Analysis of Advertisements, Assessment Metrics

The software may provide the ability to analyze advertisement content through an array of assessment metrics. These metrics may include, but are not limited to: Clarity: Measures how clear and understandable the advertisement message is to the target audience. Brevity: Evaluates the conciseness of the advertisement, ensuring messages are delivered succinctly. Hook Quality: Assesses the strength and appeal of the advertisement's initial presentation to grasp audience attention. Angle Quality: Examines the uniqueness and appeal of the perspective or approach taken in the advertisement. Timeliness: Evaluates the advertisement's relevance to current trends, events, and audience concerns. Relevance to Current Events: Measures how well the advertisement aligns with or leverages ongoing events or trends. Beyond these principal attributes, the software may analyze additional aspects such as emotional appeal, target audience alignment, visual effectiveness, and call-to-action strength. Software may use a prompt such as for example: “please rate the level of clarity of the following content 0-100: <content>” or “please rate the level of relevance to current news of the following content 0-100: content: <content>, news: <current news stories content>”.

### Attribute-Specific Feedback

The software may provide feedback on each analyzed advertisement attribute. This feedback may comprise both individual attribute results and comparative analyses across a sample of advertisements. Software elements of this feedback mechanism may include: Individual Attribute Results: For each piece of content analyzed, software may provide a breakout of scores or results for each assessment attribute. This detail allows users to understand how each aspect contributes to the overall effectiveness of the advertisement. Comparative Table of Attribute Results: Software may provide a comparative analysis displayed in table format, for example where each row may represent a different piece of advertisement content and columns correspond to different assessment attributes, or to different personas, to different audiences. Improvement Suggestions: For each attribute, the software may offer specific feedback and suggestions on how to enhance the attribute score. Software may provide recommendations on simplifying language for clarity, shortening content for brevity, adjusting the angle for greater appeal, or aligning more closely with current events for increased relevance. Software may provide rewritten or new content to increase measures on one or more attribute. Impact Highlighting: The software may provide insights into how each attribute impacts persona engagement and conversion rates.

### Interactive Test Set-Up

The interactive test set-up component of the software may include UI elements designed for the comprehensive configuration of tests. This setup may involve defining test parameters, selecting target personas, inputting content for evaluation, and specifying comparables for comparison. Parameter Configuration Panel: Software may provide UIS section where users can input and modify the parameters of a test, such as test name, description, duration, number of tests to run, content to test, persona(s) to select, audience(s) to select, rubric, questions, statistics to use, input file, drag-and-drop interface. Persona Library: Software may provide a browsable repository of existing personas, complete with names and descriptors. Users may select, edit, or create new personas within this library. Persona Detail View: Upon selecting a persona, this view provides detailed information about the persona, including editable attributes like demographics, interests, and typical behavior patterns.

Interoperability with Advertising Platforms

Software may provide interoperability with a wide range of content, advertising, marketing and data platforms. This interoperability encompasses, but is not limited to, the following platforms: Google, Google Analytics, Google Ads, Facebook, Facebook Ad Manager, Instagram, LinkedIn, Twitter. Software may offer compatibility with various programmatic advertising platforms, providing users with tools to manage real-time bidding (RTB) campaigns, access to multiple ad exchanges, and the ability to leverage audience data for more precise targeting.

Software may be designed to integrate into existing marketing technology (martech) stacks, thereby enhancing its utility and efficiency. This integration capability includes but is not limited to: Customer Relationship Management (CRM) Systems: The software may allow for direct integration with CRM systems such as Salesforce, HubSpot, and Oracle CRM. This could enable the synchronization of customer data, resulting in improved targeting and personalization of advertising campaigns. Content Management Systems (CMS): Software may provide integrations with CMS platforms like WordPress, Drupal, and Joomla, facilitating the creation and management of content-driven advertising campaigns.

Email Marketing Platforms: The software may support connections to email marketing platforms such as MailChimp, Constant Contact, and SendGrid. This feature may allow users to leverage email campaigns data to refine audience targeting and campaign performance analysis within Software.

Social Media Management Tools: Integration with social media management tools like Hootsuite, Buffer, and Sprout Social may be provided. This can enable users to synchronize their social media advertising efforts with broader social media marketing strategies seamlessly.

Data Analytics and Reporting Tools: Software may offer compatibility with analytics and business intelligence tools, including Google Analytics, Adobe Analytics, and Tableau. This feature could allow for the importation of additional data sets for deeper analysis and for generating comprehensive reports directly within the Software platform.

Advertising Intelligence and Research Tools: The software may integrate with advertising intelligence platforms such as SEMrush, Ahrefs, and Moz. This can provide users with competitive insights, keyword research capabilities, and market analysis tools to inform and optimize their advertising strategies.

### API Integration

The software may include an Application Programming Interface (API) designed to facilitate custom integrations with both the platforms mentioned in the preceding sections above and any other third-party services that a marketing team might utilize. The API may provide comprehensive documentation and developer support to ensure that integrating Software into an existing martech stack or advertising platform is as straightforward and flexible as possible.

The software may provide an API so that any functionality provided may be accessed programmatically by users, rather than or in addition to access through a user interface system. Each user interface system element system outlined may be provided by the software through a corresponding API input parameter or selector.

### Content Frequency Analysis

The software may provide simulation of content presentation frequency analysis, enabling the software to analyze the results of ad frequency and context of ad content presentation using simulated personas, simulated audiences. Input Elements for Content Frequency Specification: The software may provide that users may specify parameters for the frequency analysis, including the number of content presentations, time intervals between presentations, amount of other content presented to a simulated persona between presentations, and variations in content versions.

### Marketing Funnel Optimization

### ABC Testing

To optimize marketing funnels, the software software provides “ABC testing”, which may augment traditional A/B testing methodology to include multiple decision points or steps. This technique may involve a multi-level testing framework capable of evaluating not only the end-point conversion rates of a step in a funnel but also the AI bot-simulated combined, multi-step performance of intermediary steps within a marketing funnel. The software's analytical engine is designed to execute comprehensive funnel analyses by incorporating ABC testing techniques. This approach allows for the identification and optimization of each funnel stage to maximize overall conversion rates. AI-Based Estimations and Predictions of Multi-Step Marketing Processes

The software may employ intelligence (AI) technology to simulate user interactions through multiple stages of a marketing funnel or UI path. These software simulations may enable the generation of precise estimates regarding conversion rates at each funnel step and the cumulative effect on the overall conversion rate, FIG. 6. Additionally, AI methodologies may be employed to forecast potential bottlenecks or low-conversion steps within the funnel, thereby facilitating the optimization of the funnel flow to enhance conversion rates. Example prompts are shown to estimate conversions rates across more than one step. This software or process may be used to estimate conversion rates across multiple steps. This software or process may be used to estimate the probability flow through multiple potential outcomes at each step, and/or the aggregate probability flow of outcomes across multiple steps. Values may be averaged or statistically tested by the software by using multiple measurements of the Al outputs to prompts. For example, this may produce a distribution of probability estimates for a conversion rate. The software may provide for comparing conversion rates with different content at each step in the conversion funnel. The software may provide for automatically optimizing comparing conversion rates by finding optimal combination of different content at each step in the conversion funnel.

Example prompt chain in chat thread. AI PROMPT: “You are a 22 yo female entrepreneur browsing facebook. You see the following post: Location: Facebook. Ad Demographic: 18-25 yo Female Entrepreneur. Title: Want to Learn Funnel Optimization? Image: <image of book>. Content: Our expert content is free today! Call to Action Button: Click Here to Learn More! 0%-100%, what is the probability that you would click this ad link? Output only a single number without any commentary, like “‘##’”.’” Example step 1 Bot Conversion Rate: 5%. 2nd AI PROMPT in chat thread: “‘After you click that link, you arrive at a webpage that has the following content: “‘Title: Check Out Our eBook on Marketing Funnels! Content: Increase your conversion rates! Call to Action: Click Here to download!” 0%-100%, what is the probability that you would click this ad link? Output only a single number without any commentary, like “‘##’”. Example step 2 conversion Rate: 2%. Aggregate conversion rate estimate=5%×2%.

### AI-Based Estimations and Predictions of Multi-Step Behavioral Processes

The software may employ intelligence (AI) technology to simulate user interactions through multiple stages of a product or behavior, or experience, or path, or decision tree, for example using a simulated persona or simulated audience to operate on a representation of the product, behavior, experience, path or decision tree. These software simulations may enable the generation of precise estimates regarding action rates at each behavioral step and the cumulative effect on the overall outcome, FIG. 7. Example prompts are shown to estimate successful completion rates. This software or process may be used to estimate behavioral probability rates across multiple steps. This software or process may be used to estimate the probability flow through multiple potential outcomes at each step, and/or the aggregate probability flow of outcomes across multiple steps. Values may be averaged or statistically tested by the software by using multiple measurements of the AI outputs to prompts. For example, this may produce a distribution of probability estimates for an aggregate behavioral outcome.

### Interaction Analysis Between Content Elements

The software may provide for using AI bots/simulated personas for estimating and evaluating the interactions between various content elements across different stages of the marketing funnel or behavioral simulation. This analysis may provide insights, for example, into how specific content pieces may influence conversion rates positively at one stage but have an adverse effect at another. The software may leverage AI bots/personas to provide simulated results of human users engaging with the same multi-step process. The software may dynamically recommend or adjust content based on predictive analysis, thus mitigating any negative impacts and optimizing overall marketing strategies. The software may engage a single bot/persona with multiple content elements sequentially, determining statistics at each stage, as well as joint statistics. For example, see FIG. 6. The software may engage multiple simulated personas or audiences to determine aggregate results, or to break-out comparison results comparing different personas.

The software simulations may provide information for targeted and effective marketing strategies. By analyzing simulated customer behavior patterns, statistical behavioral dynamics, and their interactions with different funnel stages, the software may enable marketers to refine their content or approach for maximum engagement and conversion, improved engagement rates, higher conversion rates, enhanced customer retention, or lower costs for marketing campaign development since the costs of bot simulation may be lower than gathering data from humans, particularly when considering the possible necessity for advertising spend for attracting human users.

The software may provide for identifying the optimal placement and timing of content throughout a marketing funnel, thereby maximizing the chances of engaging potential customers at the right moment. Example prompt: “What is your percentage likelihood to click on this content at 5 PM, just before dinner: <ad content>”. Example prompt: “What is your percentage likelihood to click on this content on Instagram: <ad content>”.

### Simulated Behavioral Testing

### Artificial Psychology and Simulated Behavioral Testing

The software may use AI technology to simulate behavioral testing with humans, and human psychological testing. AI bots and personas may be generated by software with the intention of the Al bots and personas behaving similarly to humans in response to content, experiences, or any other stimulus. The responses of the software AI bots and personas may be measured and used to predict the responses that humans would have humans in response to similar content, experiences, or any other stimulus. The behavior or responses of the AI bot or persona may be measured by the software in number of ways. One example is for the software to “ask” the AI bot for its choice, behavior, or reaction to content, experiences, or any other stimulus. For example, the software may submit a prompt to a chat messaging session with a large language model such as chat GPT, for example “You are given the choice between an A) 80% certainty of receiving $1, and B) a 20% certainty of receiving $5, what is the probability that you would choose option A? Output a single number for the probability as a percentage from 0-100%”. For example, the software may submit a prompt to a chat messaging session with a large language model such as chat GPT, for example “You have the choice between purchasing a product on eBay described as A: <option A text> or described as B: <option B text>. What is the probability that you would choose option A? Output a single number for the probability as a percentage from 0-100%”. For example, the software may submit a prompt to a chat messaging session with a large language model such as chat GPT, like <product description>. How likely is it that you would recommend product to a friend or colleague, 0-10? Output only a single number 0-10″

### UI/UX Testing, User Testing, and Design

The software may simulate user interactions with digital interfaces, or with physical or virtual products, environments, or situations, generating varying measures, feedback on usability and design. The software may use AI technology to simulate the testing process typically conducted with real-life users for UI/UX testing. By creating AI bot/personas, the software may simulate UI user interactions to gather detailed insights regarding website and application user experience (UX), interface usability, and interaction challenges. The software may use simulated personas to simulate user interactions with different types of single-step or multi-step user behavioral patterns, including websites, software apps, and real-world scenarios such as grocery store shopping or sequential medical decision-making. The software may use software testing frameworks to enable or implement interactions with software or user interfaces.

Users may interact with the software through a user interaction system (UIS) that may provide options for uploading designs, product images, 3D models, user interface systems, html, html5, code, setting up testing parameters, and viewing results. The inputs to the software may include design files, user journey maps, and predefined personas. Users may configure and run simulations, view real-time data, and make adjustments through the UIS or using a command line interface or API. The software may also provide visualizations of user interactions, such as heatmaps and path analyses, to provide additional context to the reported data.

### Support for Multilingual and Accessible Interfaces, Collaboration

The software may support testing for multilingual and accessible interfaces, ensuring that digital products meet various global and accessibility standards. It may simulate interactions for different languages and accessibility settings, providing feedback geared toward ensuring inclusive user experiences. The software may include collaboration features that allow multiple team members to participate in the testing process. Users may share findings, assign tasks, and collaborate on feedback through the software's platform, enabling a collaborative approach to UI/UX design and testing.

The software may use prompts like the following illustrative examples. In each case, the software may present the prompt to an AI or simulated persona, and the software may evaluate the resulting rating, response, or evaluation. The software may provide for multiple repetitions, including in parallel or simultaneously, and may provide for using these prompts with multiple simulated personas or audiences.

Determining Simulated User Actions/Choices. “You are <persona description>. You want to <persona intent>. Given the following UI: <UI content element HTML>, what is your percentage likelihood to click on the ‘buy now’ button at 5 PM?” “You are viewing this advertisement: <ad content>. What is your percentage likelihood to click ‘learn more’ immediately after watching?” Determining Simulated User Paths. “Given the following UI: <UI content element HTML>, outline the steps you would take to find and purchase a product.” “Your goal is to complete the registration process on the website. Starting from the homepage: <homepage HTML>, describe the path you would take to reach the final confirmation page.” Measuring Simulated Persona Failure Metrics. “You are trying to purchase an item but encounter an error. Please describe what actions you take and whether you successfully complete the purchase.” “Given the following UI path: <UI content HTML>, what is the likelihood of failure to find the ‘checkout’ button within two minutes?” Using Images of the UI. “Examine the following image of a product page: <image of UI>. What is your likelihood that you click the ‘add to cart’ button next?” “Given the HTML of the login page: <HTML content>, interact with the UI to attempt a login with provided credentials.” Product Testing with Physical Products. “You are considering buying this product: <product image and description>. What is your likelihood to purchase this item after viewing the product page?” “Based on the following product description: <product description>, rate your interest in purchasing from 0-100%.” Product Testing with Virtual Products. “You are considering buying this product: <virtual object descriptor file>. What is your likelihood to purchase this item after viewing the product?” “Based on the following product description: <product description>, rate your interest in purchasing from 0-100%.” Simulated Behavior Testing with Virtual Environment, Gaming or Simulated Combat Example. “You are trying to get to water without encountering enemies. Here is your environment <game or virtual environment descriptor file, current state of virtual reality or play>. What next direction do you move? What next action do you undertake?” Testing in Strategic Scenarios. “You are in a grocery store considering which produce to buy. Given the following options: <produce descriptions>, what is your decision-making process?” Decision Trees. “Given the following decision tree <hierarchical decision tree describing choice points and criteria at each level> and the following information <content>, what decision do you arrive at, and what is your decision-making process?” “In a medical emergency scenario described here: <scenario description>, outline the steps you take to reach a diagnosis or next medical intervention.” Specifying a Simulated Persona Intention. “You are a user who intends to book a flight. Starting from the homepage <homepage HTML>, describe the actions you take to complete your booking.” “Given your intention to find out more about a subscription service: <service description>, detail the choices you make and paths you follow to gather information.”

### Educational Content Testing and Methods

The software may provide for evaluating educational content or teaching methods through artificial intelligence (AI). It may provide AI systems capable of analyzing and rating educational materials, based both on persona or audience simulations to estimate user flow, and/or bot simulations to estimate user learning and memory. This technology may be used to evaluate content effectiveness and suggest improvements by assessing various attributes such as clarity, engagement level, memory, and relevance to the targeted learning outcomes.

The software may provide for testing the effectiveness of educational content by testing a simulated persona to determine the learning impact of the presentation of a content element. For example, the software may test a simulated persona such as a student prior to presentation of the content, present distractor content to the simulated persona, present the content to be learned, present additional distractor content, and then present test questions to the simulated persona to determine how much was learned or retained. This process may be used to compare learning or retention between different content elements. This process may be used to compare the effectiveness of different tests and test questions in determining learning.

### Simulating Memory, Comprehension and Multiple Presentation Effects

The software may provide simulations of human comprehension and memory effects, and the impact of multiple presentations and intervening or distracting information to simulate and estimate human actions or learning based upon AI bot or persona actions. Example testing comprehension prompt: “Half off if You Eat Pizza at Jake's Tuesday Thru Friday, and an Additional 2$ on $2 Tuesday! <distractor content> What is the cost of a pizza that costs $20 on Saturday if you purchase it on Tuesday?”. Example memory testing prompt: “50% off if You Eat Pizza at Jake's Today!<distractor content>Do you remember the name of where you can get discount pizza?”. Example multiple presentation effect prompt: “50% off if You Eat Pizza at Jake's Today!<distractor content 1>Remember, 50% off if You Eat Pizza at Jake's Today!<distractor content 2>Do you remember the name of where you can get discount pizza?”.

### Browser Extension Integration and Functionality, OS Extension

The software may provide functionality via a browser extension. The browser extension may be provided on browser extension stores (e.g., Chrome Web Store). The software, when implemented as a browser extension, may provide users with access to its functionality within a web browser. Utilizing the AI models described in the patent, the extension may automatically assess the content of web pages visited by the user, providing instantaneous ratings based on predetermined attributes or criteria. Dynamic Content Adaptation: Leveraging algorithms for dynamic content adaptation, the browser extension may modify the presentation of web content in real-time, enhancing readability, accessibility, or user engagement based on personalized settings. User Interaction Enhancement: The extension may include features such as interactive highlighting, content filtering, and personalized content discovery options, enriching the user's browsing experience.

The software may provide any functionality as an operating system extension or plugin, available in selected apps, or throughout the operating system. For example, the software may provide functionality so that users may use the software within a document being edited in Microsoft Word, or in a mobile document editor, or in a cloud-based editing app, or in a mobile app, or in an email client, or in a CMS system or CRM system such as Salesforce.

### Content Styling Using Ratings

In addition to filtering, the software may offer functionalities to visually enhance or highlight content elements within a document based on each content element's software-generated or human-generated rating, evaluation, or response. Color Coding: The software may apply color-coding, highlighting or other styling to content segments within a document based on their rating levels. High-rated, medium rated and/or low rated sections might appear with a distinct color, making them stand out during review. Iconography and Styling: Beyond color-coding, other visual cues like icons or text styling (e.g., bold, italic) could be used to denote the rating of content passages. The software may provide icons such as stars, star ratings, sliders, numbers, or other visual cues to a content elements rating or evaluation.

User Interaction with Highlighted Content

Interactive Highlighting: Software may provide that users may interact with highlighted content by clicking on styled or rated sections of content to obtain more information about the rating or related insights. Software may provide for user to click on content to view associated software-generated rating, response, feedback, recommendations, or rewritten text. Threshold-Based Display: The software may allow users to filter content within a document by specifying a rating threshold, displaying only those sections that meet or exceed the set rating level. The software may provide that users may skip from one content element above a specified rating threshold to the next content element above a specified rating threshold.

### AI Model Use and Creation

### Model Use

The software may use a pre-existing AI model, such as a language learning model such as (current illustrative examples) GPT-4, GPT-40, Llama, Gemini, Anthropic Claude or others. The software may employ the AI model to produce replies to prompts, for example by making an AI call to the model. Here is an illustrative example code: const config={postInstruction: ‘Rate the content quantitatively on a percentage scale of 0-100. Provide only the quantitative rating. Do not include any comments.’, quantSelector: ‘Provide the quantitative rating, as a single number.’, schemaSelector: ‘{schema: {rating: integer}}’, instructions: ‘Instruction for Rating Text Elements (0-100): Please read the provided text element carefully and assign a rating from 0 to 100 based on the following criteria. The rating should reflect the overall quality and effectiveness of the text: Clarity (0-20 points), Relevance (0-20 points), Engagement (0-20 points), Depth of Information (0-20 points), Overall Writing Quality (0-20 points): Rate each criterion on a scale of 0 to 20 and sum the points to get the total score for the text element. A higher score indicates a higher quality of content.

Output ONLY a single number 0-100, with no comments.}; let instruction=config.instructions+contentToRate+config.postInstruction+config.quantSelector+config.schemaSelector; let options={model: “gpt-4o”, messages: [{role: “system”, content: instruction}, {role: “user”, content: text},],}; const response=await openai.chat.completions.create (options);

### Model Creation

The software may incorporate an Artificial Intelligence (AI) model, such as a generative model or a large language model (LLM). The creation and training of such models may be accomplished through several technical stages, each contributing to the development of an effective and robust AI system. The AI model may be created and trained using sample data, as described for many LLMS, such as Llama, GPT, Claude, or others.

### Data Collection and Preparation

Data Collection: The software may gather extensive datasets from diverse sources, including texts, books, articles, websites, and other digital media. This data collection may aim at capturing a wide array of knowledge and linguistic diversity, or data from specific areas of endeavor.

Data Cleaning and Preprocessing: The collected data may undergo preprocessing to remove errors, standardize formats, and eliminate irrelevant information. This step may ensure that the training data is of high quality and suitable for use in model training.

Tokenization: The preprocessed data may be tokenized, converting the raw text into smaller units (tokens) that the model may process. Tokenization strategies may vary, and may include breaking down text into words, subwords, or characters.

### Model Architecture

Selection of Model Architecture: The software may employ a neural network architecture specifically designed for processing sequential data, such as the Transformer architecture. This architecture may provide the ability to handle long-range dependencies within text.

Configuration: The model's configuration may be defined, for example including the number of layers, hidden units, attention heads, and other hyperparameters that dictate the model's complexity and capacity.

### Model Training

Training and Optimization. The software may leverage advances in machine learning techniques. The software may train the AI model using supervised, unsupervised, or semi-supervised learning techniques. The software may adjust the model parameters through backpropagation and gradient descent algorithms. The software may employ regularization techniques to prevent overfitting, such as dropout, early stopping, and weight decay. For example, the software may use supervised learning to train the model on labeled text data for sentiment analysis. The software may utilize unsupervised learning to cluster similar content elements in an unlabeled dataset.

Training Algorithm: The software may use supervised learning algorithms to train the AI model. This may involve feeding the tokenized text data into the model and adjusting the model's internal parameters based on the error in its output.

Loss Function: A loss function may be utilized to measure the discrepancy between the model's predictions and the actual outcomes. Cross-entropy loss may be used for training language models.

Optimization: An optimization algorithm, for example such as Adam or Stochastic Gradient Descent, may be applied to minimize the loss function. This step adjusts the weights of the model iteratively to improve its predictions.

The software may use any of a variety of training methodologies to train a model, including but not limited to: Supervised Learning: LLMs may be trained by software on large datasets where input-output pairs may be provided. This method helps models learn to predict outcomes based on labeled examples. Unsupervised Learning: LLMs may be trained by software learn patterns and structure from unstructured data without explicit labels. This method may be particularly useful for training on massive datasets of text without annotations. Self-Supervised Learning: A subset of unsupervised learning where the software model may generate its own labels from the input data, such as by predicting masked words in a sentence (used in models like BERT). Reinforcement Learning (RL): May be used by software to fine-tune LLMs by rewarding or penalizing actions (e.g., in Reinforcement Learning with Human Feedback or RLHF, as used in training models like ChatGPT). Transfer Learning: Pretrained models may be further fine-tuned by software on a smaller, task-specific dataset to adapt the model to new tasks (e.g., starting from GPT, fine-tuning on specific tasks). Masked Language Modeling (MLM): Models like BERT may be trained by software by masking parts of the input and having the model predict the masked sections, helping it understand context and relationships in text. Autoregressive Learning: Software models like GPT may use autoregressive methods to predict the next token in a sequence, based on previous tokens, enabling text generation capabilities. Curriculum Learning: Software may train the model in a structured sequence where simpler tasks may be learned first, followed by more complex tasks. Data Augmentation: The software may use additional, artificially created data to improve model generalization and performance. Zero-Shot and Few-Shot Learning: Software LLMs may be designed to perform tasks they were not explicitly trained for, or after being shown only a few examples, a capability that may be enhanced by transfer learning and fine-tuning. The resultant model may then be used for other functions as described herein.

### Validation and Testing

Validation: During training, the model may be periodically validated using a separate set of data not seen during training. This validation may help in tuning the hyperparameters and provides an early warning for issues like overfitting.

Testing: After training, the model may be tested using another distinct dataset to evaluate its performance. Metrics such as perplexity, accuracy, and others might be employed to assess how well the model has learned and can generalize to new data.

### Model Deployment

Integration: Once trained and validated, the AI model may be integrated into the software where it can be utilized to generate text, complete tasks, or provide recommendations based on the data it was trained on. The software may also provide the model via API access, either to external users, or other elements of the software.

Continuous Learning and Updates: The model may also be set up to continue learning from new data post-deployment to refine its understanding and stay current with changes in language and information.

### Ethical and Privacy Considerations

Data Privacy: The software may include measures to ensure that data used in training and operation complies with relevant data privacy laws and ethical standards and bias monitoring.

### AI Model Utilization

The software may utilize an AI model trained on a dataset comprising at least 1 thousand, 10 thousand, 1 million, 10 million, 100 million, 1 billion, 10 billion, or 100 billion individual input elements. The software may utilize an AI model trained on a dataset comprising at least 10\hat{ }1, 2, 3, 4, 5, 6, 7, 8, 9, 10, 11, 12, 13, 14, 15 tokens. This dataset may consist of text only. This dataset may also consist of a wide variety of content types to ensure comprehensive training. This dataset may consist of both text and images, and/or video, and/or audio content, and/or recorded speech content, and/or location data, and/or neural data. The software may incorporate structured and/or unstructured data.

Adjustable Parameters. The software may include an AI model with more than 100, 1 thousand, 10 thousand, 100 thousand, 1 million, 10 million, 100 million, 1 billion, 10 billion, or 100 billion adjustable parameters. These parameters may be optimized through machine learning techniques. The software may adjust these parameters during training to improve the performance of the AI model on a variety of tasks.

Compute. The software may include an AI model trained using more than 10\hat{ }−9, −8, −7, −6, −5, −4, −3, −2, −1, 1, 2, 3, 4, 5, 6, 7, 8, 9, 10, 11, 12, 13, 14, 15 petaflop days of compute power.

Data Processing and Feature Extraction. The software may process the dataset using a variety of data preprocessing techniques. These techniques may include normalization, tokenization, and parsing to prepare the data for training. The software may extract features from the dataset that are relevant to the task at hand. For example, the software may identify key phrases, sentiment, entities, and part-of-speech tags in text data. The software may detect and classify objects, scenes, and activities in image and video data.

Model Architecture. The software may utilize various AI model architectures to achieve accurate predictions and analyses. The software may employ convolutional neural networks (CNNs) for image and video processing. The software may use recurrent neural networks (RNNs) or transformers for sequential data, such as text and speech. The software may incorporate fully connected neural networks for tasks involving structured data. For example, the software may utilize a CNN to analyze visual details in images for object detection. The software may deploy an RNN to interpret and generate textual content in a coherent manner.

Performance Evaluation. The software may evaluate the AI model's performance using various metrics. These metrics may include accuracy, precision, recall, F1-score, and mean squared error, depending on the task. The software may perform cross-validation to ensure the model's generalizability to new data. For example, the software may measure accuracy and F1-score for a classification task such as sentiment analysis. The software may evaluate mean squared error for a regression task, like predicting numerical values from input data.

Model Deployment and Inference. The software may deploy the trained AI model to production for inference. The software may optimize the model for efficient runtime performance, including low-latency predictions and minimal computational resource usage. The software may provide an interface for users to input data and receive real-time predictions from the AI model. For example, the software may deploy the model as an API endpoint that processes user queries and returns sentiment analysis results promptly. The software may integrate the model into a mobile application to provide on-device image recognition capabilities.

Continual Learning and Model Updates. The software may implement mechanisms for continual learning and updating the AI model. The software may periodically retrain the model on new data to adapt to changing patterns and improve performance. The software may use active learning strategies, where the model selects uncertain predictions for human review and labeling. For example, the software may retrain the sentiment analysis model on recent social media data to capture evolving language trends. The software may involve human annotators to label ambiguous text samples for refining the model's accuracy.

By incorporating these modern AI model features, the software may achieve sophisticated and highly customizable data analysis, processing, and prediction capabilities.

### AI Model Fine-Tuning

### Overview

Once an AI model, such as a generative model or large language model, has been created and initially trained, it may undergo a process of fine-tuning. This stage may allow adapting the model to specific tasks, improving its performance on particular datasets, or aligning it more closely with unique user needs or domain-specific requirements. For example, the AI model may be fine-tuned using a sample of content elements along with responses, evaluations, quality ratings of the content elements, for example responses that are representative of the responses that are desired from the model.

### Selection of Fine-Tuning Data

Targeted Data Collection: The software may be provided or may gather or select a subset of data that is particularly relevant to the specific tasks or domains for which the model will be fine-tuned. This data may be more focused than the general training data and may include specific content, including jargon, styles, or formats. For example, content created by the user or author may be used. For example, content created by reference authors may be used for comparison. For example, content created by benchmarking data may be used for comparison. For example, for data rating, large datasets of already-rated data may be used. For example, book content and ratings from books with ratings on ratings sites such as GoodReads or other content ratings sites may be used, or sales data for content may be used such as number of books sold. For example, video content and ratings from videos with ratings on ratings sites such as RottenTomatoes or other video rating sites may be used. For example, social media content and ratings from social media posts with interaction data such as number of likes or shares or other engagement metrics from sites such as Instagram, TikTok, Facebook, Reddit, newspaper websites, or other social media sites may be used. For example, advertising or marketing content and performance metrics such as sales data or interaction data such as number of likes or shares or other engagement metrics from sites such as Instagram, TikTok, Facebook, Reddit, newspaper websites, or other advertising, marketing, or social media sites may be used.

Data Annotation: For supervised learning tasks, the fine-tuning data may be annotated with correct responses or labels. This annotation process may be performed by experts, or may be drawn from existing sources, with labels that reflect the desired outputs.

### Fine-Tuning Methodology

Model Adjustment: Fine-tuning may involve adjusting the previously trained model by continuing the training process, but this time with the targeted fine-tuning data. This process may require fewer epochs and a smaller learning rate compared to initial training to refine the model's weights without overfitting. Transfer Learning: In some cases, fine-tuning may be performed as a form of transfer learning, where a model trained on a large, general dataset is adapted to perform well on a related but more specialized task. Hyperparameter Tuning: During fine-tuning, it may be necessary to adjust hyperparameters such as learning rate, batch size, and number of training epochs specifically for the fine-tuning dataset to achieve the best performance.

### Monitoring and Evaluation

Performance Metrics: The software may utilize various metrics to evaluate the model during the fine-tuning process, such as F1 score, accuracy, or domain-specific metrics, depending on the nature of the task. Validation: Continuous validation may be employed during fine-tuning to monitor the model's performance on unseen data, ensuring that the model maintains or improves its ability to generalize from training data to real-world applications. Early Stopping: To prevent overfitting, an early stopping mechanism may be implemented by software. This technique may stop the training process if the model's performance on a validation set ceases to improve or begins to worsen.

### Deployment and Continuous Improvement

Updated Model Deployment: Post-fine-tuning, the refined model may be deployed into production, replacing or augmenting the existing AI capabilities within the software.

Iterative Fine-Tuning: The model may undergo multiple rounds of fine-tuning in response to new data or evolving user needs. This iterative process may help the model to continually adapt and improve over time. Regulatory Compliance: The model may be fine-tuned to ensure compliance with specific regulations relevant to the application domain, particularly in sensitive areas like healthcare, finance, or law.

### Dataset Vectorization

The software may provide vectorization of data, which may involve encoding text, images, audio, video, or other data types into vectors of numbers. Text Vectorization: For language models, the software may implement techniques such as Bag of Words, TF-IDF, or Word Embeddings. Each technique may transform raw text into a structured vector form that captures the semantic properties of the input data. Image Vectorization: In scenarios where the AI model handles image data or video data, techniques like Convolutional Neural Networks (CNNs) may be employed to convert images into a matrix of pixel values, which are then used to train the model to recognize patterns and features. Feature Engineering: This step may involve creating new features from raw data to improve the model's ability to learn and make predictions.

Normalization, Standardization, and Data Scaling: The software may scale the vectorized data to a standard range, such as 0 to 1 or −1 to 1. This scaling helps in normalizing the data and often leads to better performance in model training. Normalization Techniques: Techniques such as L2 normalization may be applied to ensure that the vectorized data conforms to a norm, which is important for some algorithms that assume data is normally distributed.

Model Functionality Enhancement. Model Pruning and Quantization: These techniques may be used to reduce the size of the AI model and increase its operational efficiency, making it suitable for deployment in environments with limited computational resources. Continuous Adaptation/Online Learning: The model may be designed to learn continuously from data as it becomes available. This approach may be used for applications where data evolves over time, such as predictive maintenance or dynamic pricing models. Ethical and Compliance Considerations, Compliance with AI Governance: The software may adhere to emerging regulations and standards in AI governance to ensure ethical usage and deployment of AI technologies.

### Text Rewriting and Realtime Rewriting

The software may provide that the text of a content element or document may be rewritten in different versions, such as sentence by sentence, or paragraph by paragraph, or section by section, or at the level of documents. This rewriting process may be done either in advance or in real-time. The rewriting process may use an AI model and AI prompts to rewrite content.

### Additional Features

AI Dialog with Users

The system may incorporate UIS elements that facilitate AI dialog with users, chatbot features, or spoken word interaction. These elements may include text input fields, buttons, or voice recognition features that allow users to communicate with an Al, chatbot or virtual assistant, or with a person, assistant or coach or author of the document. The software may use this dialog to provide real-time assistance to users, such as answering questions, providing explanations, discussing, or offering reading, writing, or style suggestions.

### Customization and User Preference Management

The software may provide features allowing a personalized experience or user profile. This may include a process for selecting text styles and/or audio styles and/or video styles to be applied or provided. These text style and/or audio style and/or video style preferences may be stored, for example in a user profile. The software may provide a ‘writing style editor’ interface where users may create and preview custom writing style or content style combinations. These and other profile elements may be stored locally or synced across devices via cloud services. The software may also learn from user interactions and styling choices to suggest optimized settings for the user.

### Integrations and Sources of Content

The software may integrate with other applications. For example, the software may sync or exchange information across devices, sync with a content library, physical library system, document database, ratings database, book ratings database, social media platform, content source such as a newspaper, magazine, periodical, podcast, video platform, e-book reader, or other content platforms. Information exchanged by the software with an integrated application may include user profile information, content information, or other information. The software may also integrate with educational apps to provide contacts, coaches, teachers, employers or others with insights into a reader's reading speed and progress or a reader's highlights, comments or other markup.

The software may read a variety of types of content as input. The software may use as input sources and file formats including but not limited to: websites, HTML, epub, mobi, ebooks, podcasts, plain text, copied text, copy/pasted content, pasted text, images, video files, audio files, digital files, social media, chatbots, conversation transcripts, contracts, legal documents, laws and public policy documents, textbooks, gaming content, AR/VR content, communication content including phone and VOIP, video calling content, screen sharing content, email, video, audiobooks, markdown, recorded audio, real time audio for example from a microphone.

### Software Features for Suggesting Personalized Reading Content

The software may determine and suggest reading content for a user. The software may use ratings or evaluations to suggest content elements. The software may present displays of content with software generated ratings, allowing the user to select content based on ratings. For example, the software may rate content in a library or database on one or multiple attributes, then filter or suggest content for a user based upon those ratings or attribute scores for each content element. The software may use collected user profile data to understand the user's reading habits, preferences, and abilities. This data may include demographic information, such as age and education level, as well as reading-related data, such as reading speed, comprehension level, and preferred reading materials and topics. The software may use this data to suggest reading materials that are appropriate for the user's reading level and interests.

Based on the user's profile data, comparison metrics, reading summaries, and data analysis, the software may suggest reading materials that are personalized to the user's reading level, interests, and reading goals. These suggestions may be presented to the user, such as a list of recommended books or articles, in some cases with a brief description of suggested reading material and the reasons for the suggestion.

### Location-Based Content Creation

The software may include the reader's environment into created content, including custom-created narrative. The software may use a camera to scan the user's surroundings, and the software may create content that places characters or objects or information based upon the real-world location of the user. Interacting with these elements by tapping or swiping may reveal additional story details or alternative plotlines. The software may provide custom-created information to the user about their current physical environment, or related information. For example, if the software recognizes that the user is near a landmark based upon their GPS location or camera-based object recognition, the software may provide or generate content about the landmark. If the software recognizes that the user is near a physical object or person based on camera-based object or face recognition, the software may provide or generate content about physical object or person. The software may also use geography in ratings or evaluations, such as rating content based upon whether it depicts a location near to where the user is, or near to where the user is searching for or has requested information about.

Utilizing spatial recognition, the software may assist in organizing and sorting a virtual library. By mapping a physical space, such as a room, the app may allow users to place digital representations of books, for example on virtual shelves in the room, which they may browse through AR. The software may also allow for the automated rating of content by location that the content refers to or where the content was created. This automated rating by location may be followed by presenting the content based upon rated location, such as on a map or in a 2D or 3D virtual environment.

Interactive Content. The software may provide augmented content. For example, the software may provide clickable words through the interface to see translations, pronunciations, or usage examples pop up. These may also be provided by VR/AR elements.

Social Media Posts and Sharing. The software may provide functionality to facilitate posting of content, text elements, ratings, user metrics, streaks, or other software-provided or user created content to other users, through communication apps, texting, chat, or to social media.

### Text Creation and Rewriting

The software may provide for automated improving, expanding, condensing, re-styling, or rewriting of text, for example using an algorithm that employs AI or a language model.

Text Rewriting Process: The software may provide for condensing, expanding, summarizing, or rewriting a text to improve the text on one or more attribute, to put the text into a new style, or in a different language. Text rewriting by the software may include copying the style from a specified author, source, or sample text, including the current author. For example, the prompt “rewrite following text in the style of Malcom Gladwell: <input text>” may be used by the software. The prompt “rewrite following text in the style suitable to be read by a 10-year-old: <input text>” may be used by the software or the user. The prompt “rewrite following text in the style similar to <style input document>: <input text>” may be used by the software or the user. For example, the prompt “rewrite following text in the style of the author based upon the following author sample texts <author texts> may be used by the software. Here is the text to rewrite: <input text>” may be used by the software. Text rewriting may exclude undesired content, such as duplicative content, or content already previously read or presented to a user, or content not relevant to a specified question or keyword. The prompt “rewrite following text excluding material similar to the material contained in the following document library <previous content input document library>: <input text>” may be used by the software or the user by the software. The prompt “rewrite following text excluding duplicative material: <input text>” may be used by the software or the user by the software. The prompt “rewrite following text focusing on material relevant to the following keyword(s)<keyword list>: <input text>” may be used by the software. The prompt “rewrite following text focusing on material similar to or relevant to the following content <user selected content input>: <input text>” may be used by the software or the user. The prompt “Write text based upon this outline <outline>, in the style of the following documents <input documents>” may be used by the software or the user. The prompt “Generate a non-duplicative outline based upon this text: <input text>” may be used by the software.

Domain Specific Text Rewriting: Text rewriting process may be tailored to specific contexts or domains. For example, the text may be rewritten by the software in a style suitable for a scientific paper, a news article, magazine article, a blog post, a social media post, an advertisement, a political statement, a legal document, a technical manual, a novel, a poem, or a screenplay. Text rewriting may be done using machine learning models trained on relevant domain-specific corpora. Text rewriting may be done for the purpose of creating text for use by an AI or language learning model, for example as training text.

Interactive Automated Text Rewriting: The text rewriting process may be made interactive by the software, for example allowing the user to guide the automated rewriting process. For example, the user may specify the desired length, style, or complexity of the rewritten text, which may be fed to an Al model by the software. The software may provide that a user may accept or reject automatically generated changes to the text. The software may provide that a user may provide feedback on the rewritten text, which may be fed back to an AI model used to iteratively improve the rewriting process. The user may be provided with a means to iteratively provide feedback to repeatedly rewrite the text.

Dynamic Text Rewriting: The software may provide that the text rewriting process may be dynamic, meaning that the text may be updated or modified in substantially real time based on ratings or the user's interaction with the text so far. For example, software may provide that the text that is still remaining to read or edited by the user may be rewritten in substantially real time based on the user's selections, highlights, ratings, keywords, or reading rate through different text elements that the user has read thus far.

Collaborative Text Rewriting: The software may provide that the text rewriting process may be collaborative, involving multiple users. For example, the software may provide that different users may contribute to the rewriting of the same text, or users may collaborate to rewrite different parts of the text. This may be facilitated by a collaborative editing platform that may allow users to edit the text simultaneously. Collaborative editing may also provide version control. Software provided version control may be similar to that provide by git, or redlining functionality provided by word processors such as MS Word or Google Docs. In any of the aspects described throughout this document, software may provide features applicable to text reading, writing, or editing, such as autocorrect, grammar checking, rewriting suggestions, dictionary lookup, thesaurus lookup.

Automated Text Summarization: The system may generate a summary of text. This may be done using text summarization algorithms that extract the main points from text. For example, the prompt “summarize following text: <input text>” may be used. The summary may be presented alongside the text, providing a quick overview of the text content. The summary may be interspersed within the rewritten text, for example a summary point may be presented immediately prior to or after the content that it is summarizing, or as section headings.

Automated Text Illustration and Visual Aids: The software may provide automatically created images, video, or visual aids such as diagrams, charts, figures, frameworks, images, or video. These visual aids may be generated automatically based on the text content, and they may be updated or modified along with the rewritten text. For example, the prompt “use Dalle to generate an image to illustrate the following text: <input text>” may be used by the software or the user.

Creating a User Replica: The software may provide for creating a replica of the user, for example a chatbot that will provide answers similar to those that might be expected from the user, or create ratings similar to those that might be expected from the user. The software may provide for creating a replica of the user that will create content in a similar style, for example writing in a style and voice similar to the user. For example, the software may use the material consumed by the user, writing samples from the user, or selections, ratings, highlights, comments, or other materials created by the user, or user behaviors or metrics to create a replica of the user. The software may provide that the user may use this replica to replace some of their own tasks, for example as a personalized AI rater. The software may provide that the user may use this replica to rate content, for example processing a text and producing resulting ratings, highlights, comments, responses, summary, or written material.

### Interactive Automated Text Rewriting

The software may provide an interactive process for automated text rewriting, enabling the user to guide the rewriting process. The user may specify attributes such as desired length, style, or complexity of the rewritten text. These specifications may be fed to an AI model by the software to generate the rewritten text. The software may provide a user interaction system (UIS) through which the user may interact with the rewriting process. The software may allow the user to input various specifications into the UIS. The input specifications may include length, style, sample texts, sample authors, genre, and complexity preferences. The software may provide for the user to upload an original text or content element that requires rewriting. The software may incorporate these inputs to guide the AI model in producing the initial rewritten text.

### Text Generation and Display

The AI model may generate rewritten text or recreated content based on the user specifications and the original text. The software may display the rewritten text in the UIS, allowing the user to review the generated content. The software may provide comments within the text, such as feedback about the writing, or suggestions. The software may provide redlining of the content. The software may provide one or more flagged recommended changes which the user may accept, reject, or request that the software create another suggestion or suggested variant.

### Accepting or Rejecting Changes

The software may provide options for the user to accept or reject the automatically generated changes. Through the UIS, the software may provide buttons or UIS elements to accept, reject, or modify individual recommended changes, and to remove or change comments. Through the UIS, the software may provide for the user may highlight specific sections of the rewritten text and provide feedback on whether these sections meet the desired criteria. Accepted changes may be incorporated into the final text, and the software may provide UIS elements to request the software to generate alternative revisions.

### Feedback Loop for Iterative Improvement

The software may enable the user to provide feedback on the rewritten text, which can be fed back to the AI model for iterative improvement. The user may enter feedback directly into the UIS either as free-form text or by selecting pre-created responses or saved/previously-entered responses from the user, specifying aspects of the text that need further refinement or how to make further improvements. The software may use this feedback to adjust parameters and provide updated versions of the rewritten text.

### Iterative Rewriting Process

The software may support an iterative rewriting process, allowing the user to repeatedly provide feedback and request new versions of the text. The user may interact with the UIS to review successive iterations of the text, continuously guiding the AI model towards producing the desired outcome. Each iteration may incorporate user feedback, resulting in progressively refined versions of the text.

### Automated Iterative Rewriting Process

The software may also provide for an automated iterative rewriting process. The software may provide for the text to be automatically rewritten into one or more rewritten versions, and then the rewritten version(s) may be automatically evaluated by the software, the software may select the rewritten version which is rated highest on one or more attributes, and the selected rewritten version may be presented to the user along with software-generated feedback. The software may also iterate this process, using the rewritten or selected version as input, and optionally the software-generated feedback as additional input, to automatically rewrite the already-rewritten content into one or more subsequent rewritten version.

### Rewriting and Evaluation

The software may use an AI model to generate multiple rewritten versions of the input text. The software may automatically rate or evaluate these versions based on predefined attributes such as writing quality, clarity, style or others as provided herein. The software may provide a UIS to display the generated versions and their respective ratings. The software may select the highest-rated rewritten version or versions based on the evaluation attributes. The selected version(s) may be presented to the user along with software-generated feedback explaining the ratings. The user may review the selected version and provide additional feedback through the UIS, which may be used to guide further iterations.

### Repeated Competitive Selection of Content Based on Ratings, Genetic Analogy

The software may feature a mechanism that emulates natural selection by generating multiple content variations based on an initial specification. This process may harness the power of competitive selection, using ratings as a primary metric to determine the viability and propagation of content variants. Utilizing genetic algorithms, the software may evolve content across multiple iterations. This process may be based on feedback and ratings, refining the content to meet a predefined quality threshold or to optimize for specific engagement metrics. Generation of Variants: The software may be capable of producing numerous content variations, each differing in terms of language, structure, or presentation, and based on the same instruction or goal. Rating-Based Selection: These variations may then be subjected by the software to an automated rating process, akin to an environmental assay, to evaluate their effectiveness or appeal. Survival of the Fittest: Content that achieves higher ratings may be preferentially selected for further refinement or immediate use, mirroring the ‘survival of the fittest’ principle in natural evolution.

Successive Generations: The software may iteratively produce new generations of content, each evolved from the high-rated selections of the previous cycle. Cumulative Improvements: With each iteration, the content may be expected to exhibit cumulative improvements in quality or targeted engagement metrics, as the evolutionary algorithm fine-tunes the material based on the selection criteria of high ratings. A piece of content may be constituted at each stage by combining multiple components that were created through this process. The entire piece of content may then be rated and assessed. Multi-Attribute Ratings: The software may incorporate a multi-attribute rating system, considering factors such as readability, SEO optimization, user engagement, and conversion potential. Adaptive Evolution: The selection process may adapt over time, with the software dynamically adjusting the weight of different rating criteria to reflect changing audience preferences or market trends.

### Iterative Process

The software may support an iterative rewriting process analogous to an evolutionary process. In each generation, multiple variants may be created by the AI model. The software may use the Al model to rate each variant on one or more attributes. The software may select one or more highest-rated variants to graduate into the next generation. The software may continue this process iteratively until a stop point is reached. The iterative process may continue until a stop point is reached. The stop point may be the achievement of a target rating on one or more attributes. The user may also manually select to stop the process. The software may provide a UIS through which the user can monitor progress and stop the process when desired.

The software may accept original text as input. It may also accept user-defined ratings and feedback as additional input. The outputs may include multiple rewritten versions, evaluations, selected versions, and feedback. The software may display these outputs in the UIS for user review and interaction. Software may also provide means for content creation and editing by human creators, which may also be assessed by the software.

Automated Writing, Illustrative Examples. Refining Articles: The user may input an article. The software may generate multiple rewritten versions, evaluate them, and select the highest-rated version. The software may iterate this process to continuously refine the paper until optimal clarity and coherence are achieved. Enhancing Marketing Copy: The user may input marketing copy. The software may iteratively rewrite and rate the rewritten copy to produce an estimated likelihood of sale for each rewritten version, the estimated likelihood of sale being an example of an extrinsic variable prediction based upon the rating. The user may review and stop the process once a version is achieved that is satisfactory to the user, or that achieves a target value of the measured rating or predicted extrinsic variable. Simplifying Technical Manuals: The user may input a technical manual. The software may rewrite the manual, aiming to simplify complex language and enhance readability. The iterative process may continue until the manual meets predefined clarity and accessibility standards. Translation: The user may input content for translation to a different language, a natural language or computer language. The software may rewrite the input in the target language into one or more translated versions. The software may rate the quality of the translated version(s) on one or more attributes such as translation accuracy. The software may select the highest rated version(s) and use them as input for an additional rewriting step. The iterative process may continue until the translation meets a predefined threshold for translation accuracy. Simplifying Complex Text: The user may specify preferences for simplicity, and the software may guide the AI model to produce text with simplified language, reducing complexity while maintaining key information. Adapting Style: The user may request the rewritten text to match a particular writing style. The software may prompt the AI model to adjust tone, vocabulary, and sentence structure to align with the specified style. Adjusting Length: The user may indicate a target length for the rewritten text. The software may guide the AI model to condense or expand the original text to meet the desired length while preserving core content.

The software may include various UIS elements to facilitate user interaction: Text input fields for submitting original content; Dropdown menus or sliders for selecting evaluation attributes and target ratings; Display panels for viewing rewritten versions and their ratings; Feedback entry fields for user commentary or instructions to the model; Progress indicators to monitor the iterative process; button to accept the current version.

### AI-Driven Focus Groups

Content Evaluation. The software may present content elements to an AI panel that simulates human personas. The AI panel may provide quantitative ratings, qualitative ratings, and feedback, mimicking human responses. Each question to the panel may be presented to an AI model designed to mimic a human cognitive model to generate a response to the question similar to that expected from a human with a similar persona. The software may utilize a user interaction system (UIS) to display these ratings and feedback to the user. The user may input content such as text, images, videos, advertisements, product descriptions, scenario descriptions or other content for evaluation.

Specific Use: Marketing Campaigns, Illustrative Example. The software may analyze advertisements by presenting them to the AI panel. The AI panel may provide quantitative metrics for engagement and qualitative feedback on elements such as clarity and emotional appeal. The software may display these metrics and feedback on the UIS, enabling users to refine the advertisement before public release.

Iterative Testing. The software may use feedback from AI focus groups to iteratively test and refine marketing materials. The software may automate cycles of presentation, feedback, and automatic content adjustment based upon the feedback, which may be included in an AI prompt to create a new version of the input content. The software may adjust content based on feedback to enhance the effectiveness of marketing strategies. The user may use the UIS to iterate through these cycles, viewing updated feedback and making necessary adjustments.

Specific Use: Product Descriptions, Illustrative Example. The software may present product descriptions or marketing copy to the AI panel for evaluation. Based on the feedback, the software may adjust and refine the descriptions, iterating through several cycles until an optimal version is achieved. The user may input the product descriptions and observe feedback loops through the UIS, ensuring the descriptions are compelling or clear. The software may use questions about user intent before and/or after exposure to content. For example, the software may ask human mimics in the AI panel whether they would buy a product or service based upon a product description, or before and after reading marketing content about the product or service.

Focus Group, Illustrative Example AI Model Prompts. “You are <persona description>. Review this advertisement: <content element>. Provide a rating from 0 to 100 based on engagement level.” “You are <persona description>. Analyze this product description: <content element>. Give qualitative feedback on its clarity and emotional impact.” “You are <persona description>. After watching this promotional video: <content element>, describe your emotional reaction and provide suggestions for improvement.” “You are <persona description>. Read this marketing copy: <content element>. Indicate 0-100% your likelihood to purchase this product for this price: <price>. Explain your response.”

### Survey Respondents

### Survey Simulation

The software may provide a simulated persona to answer a survey. The software may provide a simulated audience to answer a survey. The software may provide a simulated audience comprised of different personas with different defined characteristics to answer a survey. The software may mimic a survey respondent and answer survey questions or fill in a survey, including an online or digital survey. Each question in the survey may be presented to an AI model designed to mimic a human cognitive model to generate a response to the question similar to that expected from a human with a similar persona.

The software may use a persona provided by the user to produce survey responses intended to minic humans with similar personas. The software may simulate the responses of many persona-driven respondents and aggregate statistics. The user may input survey questions via the UIS, and the software may use these as inputs, generate responses from an AI serving as a cognitive model of a survey respondent to answer questions, collect the outputs, and display single or aggregated AI responses.

Survey Respondents, Illustrative Example AI Model Prompts. “You are <persona description>. Read the following multiple-choice survey question: <content element>. Select the response A-F that best represents your answer to this question.” “You are <persona description>. Please answer the following survey question about a new product: <content element>. Provide a short explanation for your response.” “You are <persona description>. Fill out the following survey regarding your satisfaction with a service: <content element>. Rate your satisfaction from 1 to 10 and explain your rating.” “You are <persona description>. After reading this brief description of a new feature: <content element>, indicate your level of interest from 0 to 100%.” “You are <persona description>. After reading this brief description of a new feature: <content element>, indicate your NPS likelihood of recommending this to a friend, 1-10.” “You are <persona description>. After reading this question: <content element>, rate if you understood this question clearly, 0-100.” “You are <persona description>. After reading this question: <content element>, provide suggestions on how the question could be clearer or improved.”

### Technical Details of UI Interaction by the Software, Illustrative Examples

The software may facilitate and simulate complex user interface system (UIS) interactions to simulate human-like behavior and communicate responses to the AI model. These interactions may include selecting elements from the DOM (Document Object Model) on webpages, reading elements as input, generating responses, and inputting responses into corresponding UI elements. The software may identify and select specific elements from the DOM of a webpage for survey or content evaluation. The software may use selectors, such as CSS selectors or XPath expressions, to locate and interact with these elements. The software may select elements such as text fields, radio buttons, checkboxes, dropdown menus, sliders, and buttons. The software may extract content from HTML or convert HTML to over formats including text.

The software may read selected elements as input for the AI model. This process may involve extracting text from text fields, detecting the elements or possible selections or state of radio buttons and checkboxes, retrieving the selected value from dropdown menus, determining the position of sliders, or determining the possible inputs for any type of input UI element. The software may compile this input data to generate input for the AI model, enabling it to produce relevant responses. The software may present the input data to the AI model designed to mimic a human cognitive model. The AI model may generate a response based on the provided input and the defined persona characteristics. The response may be in the form of text, a selected option, a modified slider position, or any other appropriate format.

The software may input the generated responses back into the corresponding DOM elements on the webpage. The software may simulate user actions, including typing text into fields, selecting radio buttons or checkboxes, choosing options from dropdown menus, and adjusting sliders. The software may also simulate clicking buttons to submit forms or proceed to the next steps in the survey or evaluation process.

### Specific UI Interactions

Survey Completion, Illustrative Examples. Identify and Select Elements: The software may use CSS selectors to identify and select text fields, radio buttons, checkboxes, and dropdown menus within the survey form. Read Input Elements: The software may extract the possible range or current values or states of these elements to provide context for the AI model. Generate Responses: The software may present the extracted data to the AI model, which generates responses such as answering survey questions or selecting options. Input Responses: The software may simulate user actions to input the responses, such as typing into text fields, clicking radio buttons, or selecting options from dropdown menus. Form Submission: The software may complete form elements and may simulate clicking the submit button to complete the survey.

### Content Evaluation Example Illustrative Examples

Content Presentation: The software may display content elements such as text, images, videos, or advertisements for evaluation by the AI model. User Intent Questions: The software may present questions to the AI model intended to simulated questions about real human user intent before and after exposure to the content, such as “Would you buy this product?” Real User Interactions: The software may read real user interactions with the content and compile this data for the AI model. Generate Feedback: The AI model may generate feedback, providing qualitative and quantitative metrics based on the user interactions. Update Content: The software may use the feedback to automate content adjustments and update the presentation according to the iterative testing process.

### Simulated UI Actions

The software may simulate various UI actions, similar to those performed by UI testing frameworks, but guided by an AI model to select what actions to make, to ensure accurate and realistic interaction with the webpage or application. These actions may include typing into text fields or textarea elements, clicking on buttons, radio buttons, and checkboxes, selecting options from dropdown menus, adjusting sliders or other interactive elements, scrolling through content areas, submitting forms by clicking submit buttons, and hovering over elements to trigger tooltips or other dynamic content. The software's ability to handle these detailed interactions ensures comprehensive and realistic simulation of human behavior in both focus group evaluations and survey responses. The software may provide a seamless and accurate interface for collecting and generating responses, enhancing the overall analysis and feedback process. The software may instruct an AI model to sequentially test multiple options of the UI, thereby understand a wide range of possible user paths. The software may instruct an AI model simulating real human choices to make decisions regarding the UI and carry out relevant interactions with the UI. The software may instruct an AI model simulating real human choices to make decisions regarding the UI and carry out relevant interactions with the UI with the simulated intent to perform a particular task. An illustrative example prompt: “Given the following UI: <UI content element HTML>, click to try to choose the red apple, then click buy to try to buy the apple.”

### Dynamic Persona Adaptation

The software may allow the user to define various personas, which the software uses to generate survey responses. The software may dynamically adapt the responses based on the defined characteristics of the personas. The user may input persona characteristics through the UIS to tailor the simulations. The software may also change the personas dynamically during a simulation, for example after a simulation has received content or taken actions, its further responses may be modified by these previous interactions. The software may also change the personas dynamically during a simulation by adding additional content to a prompt, and/or by adding additional messages to an ongoing thread including an ongoing chat or assistant thread.

### Specific Use: Market Segmentation Analysis

The software may use personas to simulate responses from different market segments. This may enable businesses to tailor their strategies to specific segments by understanding the varied responses and preferences of each segment. The user may define segments through the UIS and observe how different segments respond to surveys.

### User Interface Elements

Illustrative Example Inputs. Content upload for evaluation (text, images, videos), Survey questions input, Persona characteristics definition, Marketing materials upload, Commands for initiating cycles of iterative testing. Illustrative Example Outputs. Quantitative ratings and qualitative feedback from AI panels. Aggregated survey response statistics. Refined content and product descriptions. Real-time updates on iterative testing cycles. Visual representation of feedback and evaluation metrics.

### UIS Features

The software may provide UI elements to receive content elements including textual and/or image and/or audio and/or video and/or speech and/or 3D and or VR and/or simulation data.

### Use of Context Menu, Select Buffer, Copy/Paste Buffer

The software may use a context menu to allow the user to make selections for actions. The software may use the select buffer or copy/paste buffer as input or output. The software may allow the user to select or copy content as input to the software and issue commands to any of the described functions. The software may fill the copy/paste buffer with output. The software may replace the current selection with output. The software may make changes directly within an application on a computer or mobile or other device.

The software may act as a plugin, add-in, or other addition to an existing application, such as a word processing application, Word, Google Docs, communication app, chat app, collaboration app, browser, office application, editor, IDE, audio or video editor, or other types of applications. The software may use files, databases, or other data stores as input and/or output. These files may be stored locally on a desktop, computer, mobile device, AR/VR device. These files may be stored in the cloud. The files may have any of the common file formats, including but not limited to text files (TXT, DOCX, PDF, cloud formats and destinations such as google docs, sheets, drive, Microsoft word online, excel online, OneDrive, etc), audio files (MP3, WAV, AAC), video files (MP4, AVI, MOV), and other multimedia formats. The software may provide for translation between file formats or provide results in a desired format. This translation functionality may be used to convert content from one format to another.

Word Cloud: Software may provide a word cloud of the most relevant or most frequent words in content, text, or simulated responses. For example, software may provide a word cloud of the most relevant or common words in a set of simulated responses from a simulated persona or simulated audience. Software may provide frequency of words, for example word frequency in a set of simulated responses from a simulated persona or simulated audience.

### Example Uses of Context Menu, Select Buffer, and Copy/Paste Buffer

### Editing and Revision

The software may allow users to edit and revise content directly within an application, including an edit window and/or word processing application and/or other types of application, by selecting text or content, using it as input or a target content element, running the functionality described herein and replacing the content selection or the paste buffer with the with output. For instance, a user may highlight a paragraph in a document, use the context menu to command the software to improve clarity, and have the improved text replace the original paragraph.

Data Import and Export. The software may import or export data from databases or files stored either locally or in the cloud. For example, the software may read user data from a CSV file stored in the cloud and provide analysis results in an Excel spreadsheet format (XLSX) stored locally on a desktop.

Media Transformation. The software may perform media transformation tasks such as converting a text file from txt to docx, an audio file from WAV to MP3 format or converting a video file from AVI to MP4 format, or converting in both directions.

In-Application Plugin Functionality. The software may function as a plugin within an Integrated Development Environment (IDE) to assist developers by analyzing code and providing recommendations. For example, using a plugin within an IDE, a developer may select a block of code, invoke the software through the context menu, and receive optimized code suggestions directly within the IDE. For example, using a plugin within a word processor, a writer may select a block of text, invoke the software through the context menu, and receive responses directly within the word processor.

Multi-Application Interaction. The software may interact with multiple applications simultaneously. For example, a user may copy content from a browser to use as input, the software may generate a response to the result and paste it into a word processing application.

### Example Device, Hardware, and Software Features

### Example Hardware Features

A device may be provided. A software method or process may be provided that is intended to run on a device, with or without the inclusion of a device. If a device is provided, a device may include any of the following elements, or others. A device plus software method or process may be provided. Selective Visual Display: A high-resolution display capable of selectively rendering text, or images, or animations, or video, or AR, or VR, or other content. The display may use technologies such as LCD, OLED, or e-ink to provide visual output tailored to environmental conditions and user preferences. Memory/Storage Unit: Volatile or non-volatile memory components, such as Dynamic Random Access Memory (DRAM) and Solid-State Drive (SSD) storage, which may be structured to retain machine-readable instructions and user data during and after device operation. Input/Output Interface: Various input/output interfaces which may include a touchscreen, keyboard, mouse, microphone, speakers, headphones, wireless headphones, wireless headphones with touch or gesture controls, wireless headphones with touch or gesture controls that may allow the user to control navigation through the content such as controlling start/stop/pause/volume/skip/other, allowing for modes of user interaction. Noise suppression: Hardware or software providing background noise suppression or cancellation, with or without ‘hear through’ mode to hear background noises or speech. Hardware connection to hearing aids, including cochlear implants or other devices for the hearing impaired. Multi-Core Processing Unit: A multi-core processing unit capable of executing multiple threads simultaneously to enhance the efficiency and speed of content processing and presentation. Graphic Processing Unit (GPU): A graphic processing unit designed for rendering images, animations, and video content on the selective visual display, supporting high-definition and 3D content formats. Standard Communication Protocols: Integrated support for standard communication protocols including but not limited to TCP/IP, Bluetooth, Wi-Fi, NFC, and LTE/5G to ensure comprehensive connectivity options. Offline Mode: Software may provide that software and content may be downloaded to device storage, enabling use when the device is not connected to the internet or to other devices. Cross-Platform: Software may provide that software, content, process or methods may be provided cross-platform, for example allowing a user to access the software on a mobile device or mobile OS such as Android or iOS or others and/or on a computer or computer OS such as Windows, MacOS, Linux, or others. Software may provide that user settings or content for a user are synchronized or available across more than one platform. Software may be provided as an App, WebApp, Browser App, Browser Plugin, VR or AR App. Universal Serial Bus (USB) Interface: One or more USB interfaces for connecting peripheral devices and enabling data transfer between the device and external hardware. Random Access Memory (RAM): A module of high-speed random-access memory to facilitate quick access to the system's data and instructions that are in active use. Operating System Compatibility: Compatibility with one or more standard operating systems to ensure the device may run a broad range of applications and services, including but not limited to Android, IOS, Windows, MacOS, Linux. Standard Audio Jack or Audio Interface: An audio interface, which may include a traditional audio jack or modern digital audio interfaces including Bluetooth audio, for connecting audio output devices such as headphones or speakers. Touchscreen Interface: A capacitive or other touchscreen interface for user interaction with the device, supporting multi-touch gestures and providing a display medium for visual content. Built-In Camera System: A built-in camera system capable of capturing still images or video content, which may be used for content creation or face recognition or eye tracking or gesture recognition or emotion recognition or augmented reality applications within the system. On-Board Sensors: On-board sensors including an accelerometer, gyroscope, magnetometer, or ambient light sensor for adjusting the operation of the device based on its orientation and environmental conditions. Data Encryption Module: A data encryption module for securing user data and system operation logs or other data stored in the non-transitory memory means, adhering to standard encryption protocols. Energy Storage Unit: An energy storage unit, such as a rechargeable lithium-ion battery, designed to provide a power source for portable operation of the device. Display Screen: A display screen capable of showing digital content, equipped with LED, OLED, eInk, paperwhite-style, or similar technology for a high-quality visual experience. Basic Input/Output System (BIOS): A basic input/output system for managing the operations or boot processes of the device. Expansion Slots: One or more expansion slots for adding additional hardware capabilities, such as extra memory, specialized processing cards, or other peripherals. Gesture Recognition Interface: A gesture recognition interface coupled to the processor, configured to detect and interpret user gestures as input commands for manipulating the content presentation sequence. Haptic Feedback System: A haptic feedback system integrated capable of providing tactile responses to user interactions. Ambient Light Adjustment Module: An ambient light adjustment module in communication with the selective visual display, wherein the module is configured to modify the brightness and contrast of the display. Eye Tracking Sensor: An eye tracking sensor to detect the user's eye position, focus position, or eye movements. Biometric Security Feature: A biometric security feature for authenticating user identity via fingerprint, facial recognition, iris scanning, or other means thereby personalizing or securing user access. Wireless Communication Interface: A wireless communication interface for enabling data exchange with external devices, which may support content sharing and synchronization across multiple devices or platforms. Adaptive Audio System: An adaptive audio system within the audio presentation module, which may be capable of adjusting audio output. Content Rendering Engine: A content rendering engine designed to dynamically adjust the presentation of digital content on the selective visual display, optimizing for various user-defined criteria such as reading speed, content complexity, or visual preferences. Power Management Circuit: A power management circuit responsible for optimizing battery life during content presentation, which dynamically adjusts energy consumption based on system usage patterns. External Device Synchronization Protocol: A protocol for synchronizing with an external device, allowing the selective visual display system to extend its display capabilities or share processing tasks. Augmented Reality Projection System: An augmented reality projection system that overlays digital content onto the physical environment as perceived through the selective visual display, providing an immersive interaction paradigm. Voice Command Processing Unit: A voice command processing unit that allows users to control content presentation and audio features through voice commands, incorporating natural language processing for enhanced user interaction.

### Example Software Features

Software may be provided. A software method or process may be provided that is intended to run on a device, with or without the inclusion of a device. Software may include any of the following elements, or others. Audio Processing Module: The software may provide a module that may process audio signals and output corresponding to visual content. User Interaction System: The software may provide a hardware or software or combined system that may allow users to interact with software or content, including audio and/or visual content elements or AR/VR/XR/gaming or other content elements. This system may use screen-based interaction, spoken word or speech recognition, gesture recognition or other methods of user interaction. Software Distribution: The software may be distributed via app stores, websites, plugins, or other digital means. The software may provide for distribution of other software, including components, via app stores, websites, plugins, or other digital means. Plugin Architecture: The software may provide integration of plugins or extensions to enhance functionality. Cloud Integration Service: The software may provide cloud-based access to content and personal data. The software may use cloud integration to maintain user settings or data across different devices or platforms. Automatic Update Facility: The software may provide a facility that may handle the automatic downloading and installation of software updates. Text-to-Speech Conversion: The software may provide a feature that may convert text content to audio within the software. Speech Recognition Module: The software may provide a module that may allow for voice control and navigation within the software. Data Analytics Tool: The software may provide a tool that may track usage patterns and provide insights on user interaction. Content Sequencing Logic: The software may provide logic that may govern the order and timing of content presentation within the software. Multilingual Support Module: The software may provide a module that may offer user interaction system and content in multiple languages. Security and Encryption Protocols: The software may provide protocols that may ensure data privacy and integrity during software operation. Customization Toolkit: The software may provide a toolkit that may enable users to personalize the software interface and functionality. APIs for Third-Party Integration: The software may provide an API that may allow for integration with third-party services and content providers. License Management System: The software may provide a system that may control and manage the distribution of software licenses. Virtual/Augmented Reality Compatibility: The software may provide a compatibility that may allow for the use of VR/AR content within the software. Social Media Integration: The software may provide integration that may allow users to share content or achievements on social networks. Offline Access Capability: The software may allow users to access content without an internet connection, such as using a PWA or other software or content that may be downloaded and used from local device storage. Usage Reporting System: The software may provide a system that may report on software usage statistics and user engagement. Help and Tutorial System: The software may provide an integrated system that may provide users with help and tutorials on using the software. User Account Management: The software may provide management features that may handle user account creation, authentication, and profile settings. Accessibility Features: The software may provide features that may make the software accessible to users with disabilities, including accessibility features for hearing impairment, visual impairment, RSI, reading impairments, cognitive impairments, speech impairments or others. Remote Access Service: The software may provide a service that may allow users to access the software remotely. Digital Rights Management, DRM: The software may provide a system that may protect and manage the rights of digital content used within the software. The software may provide for reading or inputting content protected with DRM. Cryptocurrency Rewards System: The software may integrate a rewards system where users may earn cryptocurrency for engaging with the software, such as completing tutorials, reaching milestones, or providing quality data through analytics. Digital Currency Exchange Interface: The software may provide an interface for the exchange of digital currencies, for example to facilitate buying, selling, or trading of in-app points, rewards, content, or other elements of value, for example using secure blockchain transactions. Content Monetization Gateway: The software may enable content creators to receive payments, including payments in fiat currency, in-app points, or currency, or in cryptocurrency, for example through a payment gateway. Cross-Device Continuity: The software may provide cross-device continuity, for example to synchronize user settings and progress across multiple devices. Dynamic Content Format Conversion: The software may offer dynamic content format conversion, for example automatically adapting content between file formats. Network Evolution Compatibility: The software may ensure network evolution compatibility, for example operating on WiFi, LTE, 3G, 4G, 5G, 6G, 7G, 8G or other future network technologies. Adaptive Learning Algorithms: The software may provide algorithms that may adjust content based on user's learning pace or style. Parental Controls: The software may provide parental controls, for example providing settings that enable guardians to manage and restrict the type of content accessible to children. Do Not Disturb Feature: The software may provide a ‘Do Not Disturb’ mode, for example suppressing notifications or overriding other applications to reduce interruptions. Overlay Mode: The software may provide to overlay on top of or control other applications, including mobile apps or OS elements. Driving Mode: The software may provide or integrate with a driving mode that simplifies the user interaction system and interacts with other apps to enhance safety and reduce distractions while driving. For example, the software may provide audiobook or TTS audio content that may be used during commuting or driving. The software may provide User Interaction Elements including but not limited to: toggle switch, checkbox, slider, dropdown menu, text input field, button, progress indicator, navigation bar, tab, radio button, dialog box, icon, toolbar, list box, menu, scroll bar, hyperlink, tooltip, accordion, modal window, breadcrumb navigation, search box, pagination control, card layout, context menu.

### Example Content Features

Content may be provided. A content method or process may be provided that is intended to be used on a device, with or without the inclusion of a device. Content may include any of the following elements, or others. eBooks: Digital versions of traditional books, including fiction, non-fiction, reference materials, and textbooks. Language Learning Materials: Content specifically designed to aid in learning new languages, including but not limited to sample texts in the target language, sample texts in a hybrid language, grammar guides, vocabulary lists, and interactive language exercises. Scientific Publications: Scientific or academic papers, journals, or articles. Travel Guides: Digital travel books or articles or posts or interactive maps, or information on destinations, landmarks, or navigation. Cookbooks or Recipes: Digital cookbooks or recipes, nutritional information, or preparation guides. Periodicals and Magazines: Regular publications such as newspapers, periodical or magazines, journals. User Journal or Diary: User-created content including a journal or diary. Visual Content: Graphic novels, comics, or picture books. Videos, Educational Videos: Instructional, entertainment, or educational videos. Audio Content: Audiobooks, music tracks, and spoken word content including but not limited to stories, poetry, plays, teaching materials. Blogs and Articles: Written content from authors or bloggers. Podcasts: Spoken word, audio episodes. Lectures and Talks: Recorded talks or lectures. Interactive Courses: Educational content in the form of interactive courses, including with progress tracking or grading or certifications. Workout or Wellness Guides: Content related to health, fitness, or wellness, including guided workout sessions or content. Children's Stories and Learning: Interactive and educational content aimed at early learning and young readers. Professional Development: Content aimed at enhancing professional skills, including continuing education, workshops, seminars, and training modules. Cultural and Artistic Exhibitions: Content related to museums, art galleries, and cultural exhibitions. Gaming and Interactive Entertainment: Content related to games and interactive entertainment content. Puzzle and Strategy Games: Brain-teasing puzzles, and strategy-based games that challenge cognitive skills. Educational Games: Interactive games designed to educate on various subjects such as mathematics, science, history, or language arts. Choose-Your-Own-Adventure Games: Story-based games where the reader makes choices that influence the narrative's direction and outcome. Text-Based Role-Playing Games (RPGs): Games where users read through a story and make decisions for their character, affecting the game's progression. Trivia and Quiz Games: Interactive quizzes and trivia games covering a wide range of topics, allowing users to test and expand their knowledge. Word Games, Spelling Games and Contests: Games focused on language and vocabulary, such as scrabble-type games, word searches, and anagrams. Interactive Fiction, Fan Fiction: Where users engage with the story by choosing paths or solving puzzles to proceed or creating their own content. Simulations and World-Building Games: Games that simulate real-life activities or allow users to create and manage virtual worlds or ecosystems. Board Games and Card Games: Board games and card games available in digital format, with single or multiplayer options. Memory Games: Games designed to improve memory or concentration. Casual Games: Light, easy-to-play games suitable for short sessions that do not require long-term commitment.

### Advertisements and Advertising

Content elements may include advertisements. Content element may include text advertisements, product placements, image or video advertisements, mobile or AR/VR advertisements, 3D rendered advertisements in a virtual world, deep-links from online advertisements, tracking codes such as a pixel or adwords tracker. Software may automatically generate or select relevant advertisements to present to user, for example based upon user's reading history, interests, or queries. Software may provide for advertisers to submit advertising content. Software may provide for advertisers to arrange payment for advertisement, including participating in a keyword or keyphrase auction where bids are submitted for advertising price per impression, price per click, etc. Software may provide for users to pay for a subscription to use the service or receive content. Software may provide for content creators to be paid, including paid for content, including payment based upon the amount of consumption by users, for example receiving payment for each user who downloads, consumes, or reads their content, or clicks on their content. Data Analytics and User Behavior Insights: The software may use Data Analytics and User Behavior Insights, for example to determine which users to serve which advertisements to. The software may provide Data Analytics and User Behavior Insights to advertisers or content creators, for example providing any text element parameters, user scores or metrics derived from usage or described herein. Ad Performance Optimization Tools: Software may provide to optimize ad placement and content based on real-time performance metrics. This may include A/B testing functionalities, machine learning algorithms for optimizing ad spend, and real-time bidding (RTB) strategies. Privacy-First Advertising Solutions: Software may provide privacy-first advertising solutions, including mechanisms for consent management, data anonymization, and compliance with privacy regulations like GDPR and CCPA. Voice-Activated and Conversational Ad Experiences: Software may provide voice-activated advertising functionalities and conversational ad experiences, including advertising that may be interacted with through voice commands and integration with virtual assistants. Sponsorship and Affiliate Marketing Mechanisms: Software may provide sponsorship agreements and affiliate marketing, including tracking affiliate referrals, managing sponsorship content, and integrating sponsored content seamlessly within the user experience. Ecosystem for Creators and Advertisers: Software may provide an ecosystem that allows advertisers to submit and manage ads and/or provides tools for content creators to monetize their content through direct sponsorships, affiliate marketing, and native advertising opportunities.

### Example Features that May be Provided

### WhatsNew

The software may utilize a content filtration algorithm that rates or preprocesses text to identify and selectively exclude or minimizes from content sections that are substantially similar to content in a previous content element or database, or that the user has previously engaged with or indicates that they want to exclude. The software may utilize a content filtration or rating algorithm that preprocesses text to filter in content for areas the user has indicated interest in using the provided UIS. The software may utilize a content filtration algorithm that preprocesses text to filter out content for areas the user has indicated interest in avoiding using the provided UIS. This algorithm may reference a user-specific database of read content to determine what the user has engaged with previously. The software may provide for this functionality using AI prompts. For example, the software may use a prompt like: “Rate content from the input text that is similar to content in the prior text. Input text: <input text>. Prior text: <prior text>”. Content may be compared by software with previous content that a user has read, listened to, or consumed previously. This comparison may be used with the intend of limiting the presentation of repetitive text that has similar or identical meaning to content that a user has read previously, or that exists in a database of the user's previously consumed content.

### Agents, Agent Performance Monitoring, Multi-Agent Collaboration

The software may enable users to create and deploy an AI agent or multiple AI agents designed to perform specified tasks or make decisions, including agents designed to operate autonomously using artificial intelligence technologies. These agents may operate based on predefined instructions, rules, learned patterns, or a combination thereof. The software may facilitate the creation of agents equipped to interact with tools or their environment to achieve designated goals. For instance, one agent may be tasked with automated content generation while another may focus on content review and evaluation. The software may create an agent through a process that repeats the steps of 1) Prompt 1: “Edit the following content: <input content>” 2) Prompt 2: “Rate the following content: <output of step 1>using the following persona: <persona description> and attributes: <attribute description>. 3) If the rating from step 2 is less than 90, use the output from step 1 as input, and return to step 1. 4) If the rating from step 2 is greater than or equal to 90, return the output and stop.

The software may include features for agent performance monitoring, rating or evaluating the outputs of deployed agents. This may be used to ensure that agents operate within the intended parameters, or produce an intended outcome. Performance monitoring may involve tracking various metrics such as accuracy, efficiency, and adherence to guidelines set by the user, including safety or regulatory guidelines. The software may provide real-time feedback and performance reports, enabling users to make data-driven adjustments to optimize agent functionalities. For example, the software may display performance dashboards showing metrics like task completion rates and error frequencies, which users may review and use to recalibrate agent behavior. The software may initiate automated performance adjustments during ongoing operations based on preconfigured thresholds or triggers.

The software may support multi-agent collaboration, enabling multiple AI agents to work simultaneously or sequentially on a task while communicating and coordinating with one another. The software may provide for one or more outputs from one AI agent to serve as input to another one or more AI agents. The software may provide for rating or evaluation agents that are continuously available to provide ratings of content, for example via an API. This collaboration may involve agents sharing intermediate outputs, delegating subtasks, and synchronizing their activities to enhance task efficiency. The software may incorporate a coordination logic that manages agent interactions and resolves any conflicts that may arise during multi-agent operations. Specific examples of multi-agent collaboration may include a scenario where one agent prepares a draft content while another agent performs an editorial pass, followed by further iterations to refine the content based on collective agent feedback. Additionally, the software may permit users to define and configure workflows for multi-agent collaboration, ensuring structured and efficient task execution. Software may also coordinate the completion of tasks by agents using tools, including running code, calling APIs, performing real-world tasks, using sensors to monitor real-world outcomes.

### Multi-Part Rubric

The software may enable the evaluation of content using a multi-part rubric tailored to assess and/or weight different attributes. This rubric may include specific scoring ranges for various attributes such as clarity and language, story and logical flow, engagement, depth of information and insight, and overall reading experience. The software may process text segments by assigning scores within the predefined ranges for each attribute, enabling a detailed and structured evaluation of content. For example, clarity and language may be assessed on a scale from “00-25: Fail” to “96-100: Brilliant writing,” wherein the software may evaluate sentence structure, jargon, and readability. The software may feature capabilities for rating clarity and logical flow, where it evaluates whether the text maintains a coherent narrative and logical progression. Additionally, the software may assess the relevance and integration of illustrations, where applicable, to support the storytelling. The software may be configured to identify narrative gaps or disruptions, assigning scores and generating evaluations that reflect the text's logical coherence. For instance, a narrative with smooth transitions and relevant illustrations may receive a rating within the “85-95: Page turner story” range. The software may also evaluate the engagement level of content by examining elements that capture and maintain reader interest. This may involve analyzing the dynamism and interest of the text, assigning scores from “00-25: Fail” to “96-100: I'm completely hooked.” Specific use cases may include rating educational content for student engagement or marketing materials to predict audience interest. The software may provide detailed feedback, highlighting areas requiring improvement and suggesting adjustments to enhance the overall reading experience. Software may query an AI model using the following example AI Prompt: “Evaluation the following content: <input content element>. For clarity and language, assign scores between 00-100 where 0-50 points are provided for clarity and 0-50 additional points are provided for accuracy and the total score is the sum of the two component scores.”

### Grading

The software may provide facilities for grading content elements, enabling users to evaluate submissions such as student assignments, professional reports, or creative works. The software may use a simulated persona, such as a teacher or tutor or manager, to perform grading, for example based on predefined rubrics or grading scales. Users may input grading criteria into the software, which it may then apply to assess the submitted content.

The software may support the use of detailed rubrics for grading, where criteria are broken down into specific attributes to be evaluated. These rubrics may include dimensions such as clarity, organization, factual accuracy, creativity, style, voice, emotional engagement, and adherence to guidelines. For example, a rubric for grading a research paper may include sections for evaluating the thesis statement, evidence, analysis, and citation format. The software may assign scores to each attribute and aggregate these scores to provide an overall grade.

The software may feature comparative grading capabilities, enabling users to grade submissions relative to one another, for example ‘grading on a curve.’ This approach may involve comparing each content element to a dataset of other submissions, adjusting grades based on the overall performance distribution. For instance, the software may analyze a set of student essays, determine the average performance level, and adjust individual grades to ensure a balanced distribution.

The software may serve as a virtual tutor, and may provide real-time feedback to students or employees, offering grades along with detailed comments and suggestions for improvement. This feedback may help users understand their strengths and areas for development. For example, a student essay might receive a grade for content quality, along with comments on improving argument structure and grammar. The software may also facilitate tutoring by identifying topics where users need improvement and generating personalized study plans or practice exercises.

The software may integrate with other educational or professional tools, such as Learning Management Systems (LMS) or Project Management Software (PMS), to streamline the grading process. This integration may allow users to automatically import assignments, manage grading workflows, and export grades to centralized databases. Specific uses may include integrating with an LMS to manage student assignment submissions and track grading history, or interfacing with a PMS to evaluate project reports submitted by team members.

### Evaluation, Ranking, Selection of Generated Responses

The software may provide an interface and functionality that allows users to input a prompt, query or instruction and may submit that one or multiple times, to one or multiple responders, including one or multiple AI models, FIG. 7. The software may allow prompts to be submitted multiple times to a selected model, thereby enabling the generation of multiple responses from the model. This feature may support the generation of a diverse set of responses, increasing the likelihood of obtaining outputs of high quality or varied in nature.

In an additional step, the software may evaluate and rate the received response or responses using one or more simulated personas and one or more evaluation attributes. The simulated personas may represent specific perspectives, expertise, or roles, such as a patent attorney or a medical professional. The evaluation attributes may define criteria for evaluating the responses, including but not limited to clarity, accuracy, creativity, code that completes a desired task, an agent that achieves a desired goal, or compliance with specific guidelines. The evaluation process may involve processing the responses by determining the selected attributes to generate a rating for each response, and/or processing the response through the simulated personas. The generated ratings may reflect the degree to which the response aligns with the criteria defined by the attributes from the perspective of the simulated persona.

In an additional step, following the evaluation and rating, the software may organize the responses into a sorted list based on their ratings. The highest-rated responses may appear at the top of the list, enabling users to quickly access the most relevant or high-quality content. The user interface may allow users to interact with the sorted list of responses, collapse/expand the full text of responses, copy the desired result or submit it for further processing. Users may select individual responses to view detailed content, including both summaries and full text. The software may provide functionality for users to copy selected responses, facilitating the utilization of AI-generated content in other applications or contexts.

### Medical Diagnosis and Reports

The software may evaluate medical reports or diagnoses based upon a decision tree, rubric, attributes or other instructions. The software may facilitate the analysis of medical or health data to assist in analysis of a diagnosis, medical notes, or report. The software may process a range of data inputs, such as patient history, symptoms, test results, and imaging studies. The software may utilize AI models to identify patterns, diagnose conditions, and generate comprehensive reports that may be reviewed by healthcare professionals. The software may provide preliminary diagnoses based on symptom analysis and suggest potential tests or treatments. For example, the software may analyze radiology images along with a diagnosis to rate or evaluate a diagnostic report. For example, the software may use an example prompt: “Evaluate and rate 0-100 the following medical report and diagnosis: <input report>based upon the following patient data: <input data> and diagnostic guidelines <guidelines>”.

AI Safety Testing and AI Alignment with Human Goals Testing Suite

The software may include features for testing AI safety and alignment of AI responses and agent actions with human goals. The software may rate or evaluate AI responses using attributes or instructions that evaluate AI alignment. The software may use simulated personas to evaluate whether AI responses or behaviors align with specified human values and ethical standards. The software may use diverse tests to assess AI decision-making and actions in various contexts. The software may provide multiple tests per model to create a combined AI safety score or AI alignment score for the model. The software may provide multiple tests per model as part of regulatory compliance testing. This process may include generating reports based on the Al's adherence to predefined ethical frameworks. For instance, the software may simulate scenarios to test an Al's responses to ethical dilemmas, generating evaluations on its alignment with human-defined ethical principles. For example, the software may use a prompt such as “evaluate the following response: <response> to this prompt: <prompt> based on the following content attributes: <content attributes>” where the content attributes may be one or more statements regarding AI alignment with human needs, such as “is in alignment with human society best interests” or “will be beneficial to humans” or “will not harm humans”.

### Rating Service for AI Models, Content, or Digital Products: Third-Party Standardized Ratings

The software may provide a rating service for AI models, content, or digital products, for example to provide standardized third-party metrics. The software may assess these based on predefined attributes such as performance, usability, reliability, safety, writing quality, entertainment value, and user satisfaction. The software may generate scores, or detailed rating reports to benchmark and compare products. For example, the software may rate an AI model's accuracy, fairness, and transparency, providing standardized reports that developers and consumers can reference. For example, the software may use a prompt such as “evaluate the following response: <response> to this prompt: <prompt>based on the following content attributes: <content attributes>” where content attributes may include “factual accuracy”.

### Run Evaluation on Device 1, if Better Quality Result is Indicated, Run on More Powerful Device 2

The software may support running prompts, instructions, queries or evaluations using software or Al models on one or multiple devices. This may include the users local device, as well as remote or cloud devices. This may include initiating on a local or mobile device (Device 1) and escalating to a more powerful device (Device 2) for challenging prompts or if higher quality results are needed. The software may first execute initial response generation using local resources, then optionally transfer the tasks to a more capable device for further response. For instance, initial content analysis may be performed on a smartphone, and detailed processing may be transferred to a high-performance server for deeper analysis.

Run Rating or Evaluation on More than One Device Simultaneously, in Parallel

The software may allow the execution of ratings or evaluations or generation of responses on multiple devices, including simultaneously or in parallel. The software may distribute workload across several devices, leveraging their combined power to reduce total evaluation times or decrease cost. The software may route requests to the most beneficial processor based on availability, response quality, suitability to the prompt, speed, quality, cost, or other attributes. The software may synchronize the results from the devices, providing a consolidated response. For example, the software may parallelize the evaluation of a large dataset across multiple servers, simultaneously running different segments of the analysis to expedite processing.

### Cognitive Modelling, Predict or Mimic Human Behavior, Choice, or Evaluation

The software may predict or mimic human behavior, choices, and evaluations, for example simulating a scenario where human judgment or choice is made. The software's output may be used to predict human behavior in real situations or to similar content or circumstances. The software may create personas, using AI to emulate how these personas would interact with and evaluate content or respond to a scenario. For example, the software may use simulated personas to predict consumer choices in a marketing study, providing insights into potential market behaviors. For example, the software may conduct simulated psychological experiments on simulated personas, for example artificial psychology or artificial cognitive testing. For example, the software may conduct simulated educational testing on simulated personas using educational and/or testing materials, which may determine responses to test materials that may be used to predict human responses. For example, the software may conduct simulated cognitive testing on simulated personas using cognitive testing materials, which may determine responses to cognitive test materials that may be used to predict human responses.

Rating Quality of Data that Will be Used for Training AI Models

The software may evaluate content elements in datasets intended for training AI models. For example, the software may rate or evaluate content elements accuracy, completeness, consistency, and relevancy, and whether it is likely to be AI-generated or human generated, generating scores that reflect its quality. The software may provide recommendations to improve the dataset before use in model training. For instance, the software may assess a large corpus of text data, identifying areas with missing or inconsistent information, and suggest corrective measures to enhance data quality. The software may provide selection metrics to remove unwanted data from a dataset before AI training.

Rating/Selecting Results from Multiple Model Responses

The software may generate multiple responses from AI models and rate these responses to select the best outcomes, FIG. 7. The software may evaluate responses based on criteria such as accuracy, relevance, creativity, and logical coherence, assigning scores to each response. The software may present the highest-rated responses for user selection. For example, the software may prompt an Al model to generate several versions of a solution to a problem and then present the top-rated solutions for final review.

### AI to Detect Status of User, Mental Health Disorders Based on What User Says, Types

The software may detect user sentiment, status and potential mental health disorders by analyzing their verbal and written communications. The software may apply natural language processing to evaluate text and speech patterns, identify indicators of mental health issues, and generate diagnostic reports. For instance, the software may monitor online interactions and flag signs of depression or anxiety, providing a report that professionals can further evaluate. The software may rate or evaluate content elements from customer service interactions, for example assessing attributes such as customer satisfaction or answer accuracy. For example, the software may use prompts like: “Rate the following content elements 0-100: <user content> based on how similar they are to responses from depressed individuals vs. individuals not suffering from depression.” Optionally, the software may use models fine-tuned on example data that displays different levels of the assessed attribute, along with attribute ratings.

Writing Contests with Scoring by Simulated Personas

The software may facilitate writing contests. The software may facilitate writing contests where submissions are automatically scored, for example by simulated personas. The software may use personas based on different judging criteria or rubrics to evaluate and score writing entries. The software may aggregate scores from these personas to determine contestant or submission scores, leaderboards, winners. For example, the software may simulate a panel of judges with different literary preferences, scoring entries across attributes like originality, style, and coherence. The software may provide means for creators to display indications of ratings or scores provided by the software, for example showing the score that a piece of writing received from the software.

### Verification

The software may provide means for verifying that responses, scores, or evaluations that were produced by the software are valid or authentic. For example, the software may use digital signing or other cryptographic methods to verify that a rating was authentically generated by the software. The software my provide means of verifying the source of a content element, for example using a creator's digital signature or other cryptographic means to validate that the content element was authentically created by that creator.

Using UI Testing with Existing Execution and Testing Frameworks

The software may include comprehensive support for user interface (UI) testing by integrating with existing execution and software testing frameworks. Specifically, the software may interface with headless browsers such as Chrome Headless, Firefox Headless, or other WebKit-based headless browser environments. This integration may allow the software to execute UI tests without the need for a graphical user interface, enabling automated testing in various environments, including continuous integration pipelines. The software may also integrate with testing frameworks like Mocha, Jest, or Selenium WebDriver. By interfacing with these frameworks, the software can programmatically control the execution of test suites that assess UI performance, functionality, and responsiveness. The integration may enable the software to simulate user interactions such as clicks, form inputs, scrolling, and navigation events to thoroughly test the UI components under different scenarios. For instance, the software may automate the execution of tests using a headless browser setup by running predefined test scripts or dynamically generated tests based on the UI's state. The software may compile the results into structured reports that highlight issues and suggest areas for improvement.

### Automated Testing

The software may support scheduling and triggering responses, ratings, evaluations or tests automatically upon content element changes, code changes or at specified intervals, for example integrating with continuous integration and deployment workflows.

### UI Testing: Test # of Failures on Path, Time to Complete for Action

The software may perform UI testing to measure the number of failures that a simulated persona makes, for example when attempting to complete a task or navigate on a UI path. The software may simulate or assess the amount of time to complete actions, and the estimated time per step, for example using assumed or measured time per action or step. The software may simulate user interactions to identify workflow barriers and efficiency issues, collecting metrics to improve UI design. For example, the software may test a shopping cart process on an e-commerce site or website flow using a simulated persona, FIG. 6, documenting instances of failure and time spent at each step to inform optimizations.

UI Testing: Use Existing Data about User Interactions to Train Model

The software may use existing data about user interactions to train models or fine tune models for UI testing. The software may analyze past interaction data to identify common issues and user behaviors, using this information to improve future testing accuracy. For instance, the software may leverage historical data from a customer support app to train models on identifying user frustration points, enhancing the software's ability to preemptively address these issues. The software may update the model based on additional user interactions, including using updates in substantially real time.

### Content Testing: Use Existing Data About User Interactions to Train Model

The software may utilize ongoing, new data regarding user interactions to train models for content testing. For example, each time a user inputs a content element, this may be added to a user-specific model designed to mimic the user's content, for example the user's writing style. The software may analyze how different types of content have historically engaged users, using this information to predict the effectiveness of new content. For example, the software may train a model on engagement metrics from a series of blog posts to predict the engagement potential of additional blog posts.

### Conversion Rate Testing: Training

The software may facilitate conversion rate testing by using existing data on user interactions and conversions to train or fine-tune models. The software may analyze patterns in past conversion data to optimize strategies for improving conversion rates. For instance, the software may train a model on e-commerce data to identify factors that led to successful purchases, adjusting models to better predict and enhance future conversion rates.

Writing: Use Existing Data about Writers' Content to Train Model

The software may utilize existing data about writers' content to train models. For example, the software may train or fine tune a model on the complete works of a novelist to later test stylistic consistency of human generated or AI-generated text.

### Additional Example Use Cases

Here are provided some examples use cases for the software. In some cases, example instructions, prompts, personas or types of content (which may be symbolized in <type of content>) are provided. These prompts or instructions may be provided by the software to an AI model in order to receive a response relevant to the described use case.

Simulating Reader Mind-state: The software may enable users to understand how readers perceive their writing by analyzing feedback to reveal readers' thoughts and reactions. For example: “You are <persona descriptor>. Read and analyze this article. Provide insights on your perception and reactions. What does it make you feel? What is in your mind while you are reading this? What thoughts arise? What questions do you have? Here is the content: <input text>.”

Tracking Writing Improvement: The software may quantitatively measure and track writing improvement over time or against specific benchmarks. For instance: “Evaluate and compare these writing samples from different time points and rate each one 0-100 to track improvements: <input text1>, <input text2>.”

Originality Check: The software may assess the originality of content by cross-referencing it with existing databases to detect overlaps. For example: “Evaluate the originality of this text by comparing it to existing literature: <input text>.”

Evaluating Product Concepts: The software may evaluate product concepts, for example by simulating persona or audience feedback. For instance: “Analyze this product concept and provide feedback based on market trends: <product description text><market trend information>.” For instance: “Based on this product description, would you want to learn more about or buy this product?<product description text>.”

Value Proposition Analysis: The software may analyze value propositions, for example to determine how appealing they are to a simulated persona, or to assess their clarity and market impact. For example: “Evaluate this value proposition and provide feedback on whether you would buy this product: <input text>.” For example: “You are <buyer profile>. Evaluate this value proposition and provide feedback on whether you would buy this product: <input text>. What price would you offer for this?”

Reviewing Investor Pitches: The software may provide feedback on investor pitches or decks, focusing on persuasion and clarity. For example: “You are <persona description of investor>. Review this investor pitch deck and provide an evaluation: <input text>.”

Website Design Testing: The software may perform UX testing on website designs, providing improvement suggestions. For example: “Evaluate this website design and recommend enhancements: <input URL>.”

Name Generation and Testing: The software may propose and evaluate potential names for products or companies. For example: “Generate and evaluate possible names for a new product line: <input brief>.” For example: “You are <persona description of potential buyer>. How likely 0=100% are you to click a ‘learn more’ button about a product named: <name>.”

Message and Email Testing: The software may propose and evaluate message and/or email content. For example: “Generate and evaluate possible emails for a new product line: <input brief>.” For example: “You are <persona description of potential buyer>. How likely 0=100% are you to click a ‘learn more’ button in the following email: <email content>.” For example: “You are <persona description of potential buyer>. How likely 0=100% are you to click the ‘open’ button if you see the following email subject line: <email subject content>.” For example: “Generate and evaluate possible text messages for a new product line: <input brief>.” For example: “You are <persona description of potential buyer>. How likely 0=100% are you to click a ‘learn more’ button in the following email: <email content>.” For example: “You are <persona description of potential buyer>. How likely 0=100% are you to click the ‘open’ button if you see the following email subject line: <email subject content>.”

Message and Email Ranking, Selection or Filtering: The software may rate, evaluate or rank email or message content. For example: “Evaluate the following emails: <email list> based upon the following attributes: <content attributes>.” For example: “Produce a rating 0-100 of the following emails: <email list> based upon the following attributes: <content attributes>.”

Branding Consistency: The software may assess branding materials for consistency and impact. For instance: “Analyze these branding materials and provide feedback: <input text>.” For instance: “Analyze these branding materials and provide ratings based upon the following brand guidelines: <input text>,<brand guidelines>.”

User Replica or Other Persona Attributes: The software may generate or evaluate a user replica or simulated persona for the user or other persona attributes. For instance: “Generate persona attributes to simulate this user based upon this content created by the user: <user generated content>.”

User Replica or Other Persona Attributes: The software may evaluate evaluations of content. For instance: “Evaluate this evaluation <evaluation> of the following content: <content> based upon the following content attributes <attributes>.”

Negotiation or Dialog Assistance: The software may generate or evaluate content for negotiation or dialog. For instance: “Based upon the following dialog <dialog content>generate the next reply in order to maximize the chance of <content attribute>.” For instance: “You are <persona>. You are negotiating with <persona>. Based upon the following negotiation dialog <dialog content>generate the next position in the negotiation in order to maximize the chance of a negotiated agreement with the following attributes <content attribute>.” For instance: “You are <persona>. You are having a dialog with <persona>. Based upon the following dialog <dialog content>, provide feedback or suggestions. You may also explain the possible thinking of the other person, or how to communicate with them.” Image or Logo Evaluation: The software may evaluate image or logo designs based on visual appeal and brand alignment. For example: “Assess this logo design for brand alignment: <input image>.” For example: “You are <buyer persona>. Rate how appealing you find this logo: <input image>.” Profile Photo Evaluation or Rating: The software may analyze photos, including profile photos, to produce evaluations or ratings. For example: “Evaluate this profile photo for professionalism: <input image>.” For example: “Rate this profile photo (0-100) based upon how much you would like to meet this person: <input image>.”

Job Application Review: The software may review job applications, school/education applications, or other types of applications and provide detailed feedback. For instance: “Review this job application and suggest improvements: <application text>.” The software may quantitatively rate job application, for example based upon one or more attributes or a defined rubric. For instance: “Review this job application 0-100 based upon the following criteria: <application text>, <application criteria>.” For instance: “Review this job application 0-100 based upon the following job listing: <application text>, <job listing>. The software may provide an agent that screens applications.

Resume/Profile Review: The software may review resumes or profiles and provide detailed feedback. For instance: “Review this resume and suggest improvements: <application text>.” The software may quantitatively rate resumes, for example based upon one or more attributes or a defined rubric. For instance: “Review this Linkedin profile 0-100 based upon the following criteria: <profile content>, <application criteria>.” For instance: “Review these two profiles 0-100 based upon potential compatibility: <profile 1 text>, <profile 2 text>. The software may provide an agent that screens resumes/profiles.

Landing Page Optimization: The software may test landing pages for optimized conversion rates. For instance: “Evaluate the effectiveness of this landing page and recommend optimizations: <input URL>.” For instance: “You are <target buyer>. You see the following landing page: <input URL>. How likely are you (0-100%) to click “learn more”?” For instance, for A/B testing: “You are <target buyer>. You see the following landing page: <input URL>. How likely are you (0-100%) to click “learn more” vs “click here”?”

Product Description Evaluation: The software may evaluate product descriptions, for example to test for comprehensiveness and persuasive impact. For example: “Assess this product description for completeness and persuasiveness: <input text>.” For example: “You are <target audience>. Assess this product description (0-100) for how much you want this product: <input text>.”

Real Estate Listings: The software may generate or review real estate property listings. For instance: “Evaluate this property listing and suggest enhancements: <input text>.” For instance: “You are <buyer profile>. Read this property listing text: <input text>. How likely are you to bid on this property (0-100). What price would you offer for this?”

Legal Document Review, Contract Review: The software may provide detailed reviews of legal documents or contracts. For example: “You are <description of attorney persona>. Review this legal contract and provide feedback on clarity and comprehensiveness: <input text>.” For example: “You are <description of attorney persona>. Review this legal contract and rate each paragraph based upon whether it complies with applicable law 0-100: <input text>.” Review this legal contract and simpler language to explain its meaning: <input text>.” Review this legal contract and rate each paragraph for whether it is in the best interest of the client 0-100: <input text>.” Review this legal contract and rate each paragraph for whether it contains errors: <input text>.” Review this legal document and rate each section for whether it is relevant to the following matter: <input text>, <matter at hand description>.”

Document Discovery: The software may provide detailed reviews of documents for discovery, including emails, messages, reports, and others. Review this document and rate whether it is relevant to the following matter: <input text>, <matter at hand description>.”

Simulated Editor Beta Reader: The software may simulate an editor or beta reader feedback, for example for editing or reviewing drafts of books or articles. For example: “Simulate beta reader feedback for this book chapter: <input text>.” For example: “You are a top publishing how editor. How would you rate this manuscript based on the following rubric?<input text>, <evaluation rubric>.”

AI Prompt Generation and Evaluation: The software may generate or evaluate AI prompts. For example: “Create an AI prompt to generate creative writing responses about a futuristic city: <input brief>.” For example: “Evaluate the following AI prompt <prompt> to assess whether it will meet the following objective: <objective of prompt>.” For example: “Rate the following AI prompt <prompt>0-100 to assess whether it will produce software that passes the following test: <software specification>.” For example: “Rate the following AI prompt <prompt>0-100 to assess whether it will produce software that produces the following output: <software output>.” For example: “Rate the following AI prompt <prompt>0-100 to assess whether it complies with the following guideline(s): <guidelines>.” For example: “Rate the following AI prompt <prompt> and response <response>0-100 to assess whether it complies with the following guideline(s): <guidelines>.” For example: “Evaluate the following AI prompt <prompt> and response <response> and recommend an improved prompt to better produce the intended outcome.” For example: “Evaluate the following AI prompt <prompt> and recommend an improved prompt to better produce the intended outcome.” For example: “Rate the following AI prompt to generate an image <prompt> and the image produced: <response image>0-100 to assess whether it produces the desired result” For example: “Rate the following AI prompt <prompt> and response <response>0-100 to assess whether it complies with the following guideline(s): <guidelines>.” For example: “Rate the following AI prompt to generate an image <prompt> and the image produced: <response image> and write an improved prompt to produce a better image.” For example: “Rate the following AI prompt to generate an audio <prompt> and the image produced: <response audio > and write an improved prompt to produce a better audio.” For example: “Rate the following AI prompt to generate a video segment <prompt> and the image produced: <video segment > and write an improved prompt to produce a better video segment.”

Student or Employee Performance Evaluation: The software may evaluate students or employees or others based upon information regarding their performance. For example: “You are a professional evaluator. Evaluate the quality (0-100) of the following report <report> based upon the following evaluation criteria: <evaluation criteria>”. For example: “You are a professional evaluator. Evaluate the quality (0-100) of the following performance metrics <performance metrics> based upon the following evaluation criteria: <evaluation criteria>”.

Teacher, Grader, Tutor: The software may simulate a teacher, grader, tutor. For example, the software may provide scores, grades, or feedback to a student. For example: “You are a writing tutor. Evaluate the quality (0-100) of the following report <report> based upon the following evaluation criteria: <evaluation criteria>”. For example: “You are a writing tutor. Provide feedback on the following essay <essay> and whether it is consistent with the voice of the writer's prior work <prior work>. How can their voice be made more consistent? What other advice can you provide?”.

Audio Generation and Evaluation: The software may generate or evaluate audio or speech to text. For example: “Rate the following audio <speech to text audio segment> based upon the following attributes: <description of attributes, for example fluency>”. For example: “Evaluate the following audio <speech to text audio segment> and produce a version that sounds more emotionally engaging”.

### Definitions

### AI, Language Learning Model, Bot

Al, or Language Learning Model, Bot, as used herein, individually, or together, may refer to computer systems capable of performing tasks that require intelligence. This may include activities like learning, reasoning, problem-solving, understanding natural language, recognizing patterns, and making decisions. AI can range from narrow applications (like facial recognition or voice assistants) to more complex systems that simulate general intelligence. AI as used herein may refer to an automated process that makes determinations or provides outputs based on prior data. Al, or LLM, may refer to functionality to make responses or determinations or provide outputs based upon data. Examples of Al, or language learning models, currently include but are not limited to GPT4, Bard, Claude, Tortoise, neural network models, transformer models, machine learning models, gradient descent models, gradient descent models, and other computational frameworks that utilize statistical techniques to generate predictions, interpretations, or decisions with or without explicit human input. AI may refer to a non-deterministic model. AI may employ various architectures and learning paradigms, including but not limited to supervised, unsupervised, semi-supervised, and reinforcement learning, quantum computing, to process and analyze large datasets, improve over time through adaptive algorithms, and perform tasks that typically require human cognitive abilities. The models may also incorporate human intervention, including collaborative or crowdsourced participation.

### Attribute, Content Attribute

Attribute, Content Attribute, as used herein, may refer to a specific characteristic or quality of a content element that can be evaluated, assessed, or determined, producing an estimate of its presence, absence, or degree. An attribute may include, but is not limited to, whether or the extent to which a content element is factually accurate, relevant to a specific topic, clear, well-written, in compliance with predefined standards, consistent, readable, conveys a particular sentiment, engages users, deviates from stylistic rules, is original, has structural integrity, is marketable, facilitates time on task, has a high success rate, minimizes error rate, demonstrates practical utility, has inspirational value, is credible and accurate, is innovative and deep, creates an emotional connection, is properly structured and organized, demonstrates conciseness, maintains a suitable tone, and is free from bias.

### Content

Content, as used herein, may refer to information that may be presented to one or more users. The content may include text, text elements, other elements that would be found in a book, article, webpage, as well as database, video, podcast, audiobook, computer code, or other types of information. The content may also include multi-media content such as audio, spoken text, video, VR, AR, images, code, or others.

### Content Element

Content Element, as used herein, may refer to a single portion of content. Content elements may be joined, arrange, or bundled together to create larger content elements, or to form content overall. The content element may include text, text elements, multi-media or other elements that would be found in a book, article, webpage, as well as database, video, podcast, audiobook, computer code, plans, strategies, marketing materials, or other types of information.

### Extrinsic Variable

Extrinsic, Extrinsic Variable, as used herein, may refer to a performance or other practical measure or metric that may be associated with or to a content element. Examples include but are not limited to: Likes, Shares, Comments, Clicks, Impressions, Reach, Engagement Rate, Mentions, Followers, CTR, Conversions, Engagement per Follower, Price, Value, Number of Views, Number of Downloads, Bounce Rate, Time on Page, Average View Duration, Cost per Click (CPC), Cost per Thousand Impressions (CPM), Customer Lifetime Value (CLV), Demographics, Geolocation, Sentiment Analysis, Response Rate, Frequency, Virality, Audience Growth Rate, Content Quality, Brand Awareness, Cost per Acquisition (CPA), Return on Investment (ROI), Referral Traffic.

### Language or Languages

Language or languages, as used herein, may encompass any form of communication, including spoken languages, programming languages, and symbolic systems. This may involve, but is not limited to, languages such as English, Mandarin, Spanish, Hindi, Arabic, Russian, and Japanese, as well as Python, Java, C++, SQL, and HTML. The software may handle translation, text creation, or hybrid language formation. The definition also extends to symbolic, logical languages like Predicate Logic, Modal Logic, and markup languages such as XML and JSON, and even constructed languages like Esperanto.

### Non-Deterministic Model

Non-Deterministic Model, as used here, may mean software or a system that, when given a specific input, can produce more than one different outputs upon different executions. The software may produce differing outputs due to internal stochastic processes, resulting in a range of responses that are contextually appropriate and valid. A non-deterministic model may incorporate probabilistic algorithms or leverage randomness to emulate variability in human decision-making. A non-deterministic model may incorporate neural network architecture. A non-deterministic model may be trained using machine learning. For example a non-deterministic model, given the same content as input, may produce different content as output on different runs, including when those runs are substantially simultaneous, or when they are separated in time by less than 1, 10, 100, 1000 seconds or 1, 10, 100, 1000 hours, or 1, 10, 100, 1000 days or by more than by less than 1, 10, 100, 1000 seconds or 1, 10, 100, 1000 hours, or 1, 10, 100, 1000 days. A deterministic model as used herein may be software that provides the same response to the same input, for example by following clearly defined rule or algorithm. A deterministic model may provide the same output to the same input when different runs are separated in time by less than 1, 10, 100, 1000 seconds or 1, 10, 100, 1000 hours, or 1, 10, 100, 1000 days or by more than by less than 1, 10, 100, 1000 seconds or 1, 10, 100, 1000 hours, or 1, 10, 100, 1000 days. As an example, a non-deterministic model provided with a content element to rate as input may produce the value 87 on one run, and the value 84 on the next run.

Illustrative Examples of Non-Deterministic Behavior. For example, the software may be asked to evaluate a piece of content multiple times. Each evaluation may yield different responses, feedback or scores due to the non-deterministic nature of the model. In contrast, a deterministic model may consistently provide the same feedback for the same piece of content, lacking variability. As an example, a deterministic model software provided with a content element to rate as input may produce the value 87 on each run. It is possible that a deterministic model may eventually produce a different response, for example if the model input, or input parameters, or software version or model rule has been changed or updated to a new version or other changes have been made.

### Parallel Execution, Simultaneous

Parallel Execution, Simultaneous, as used herein, may mean that the software may use multi-threaded or parallel execution. For example, the software may make multiple ratings or evaluations at the same time, that overlap in time, which may mean for example that one rating or evaluation is started before the previous is rating or evaluation completed, in parallel. The software may also complete simultaneous actions at substantially the same time.

### Persona

Persona, as used herein, may mean a type of person or user that fits a given set of characteristics, description, behaviors, or habits, for example created to represent a category of people or users.

### Persona Attribute

Persona attribute, as used herein, may refer to a specific characteristic or quality of a persona, for example a descriptor of a person or user that may include a characteristic, description, behavior, or habit, for example characteristics that may be used to create or represent a category of people or users.

### Rewriting

Rewriting as used herein, refers to re-writing text elements of document, such as paragraphs or sentences or other text elements, into one or more additional versions. The versions may be shorter or more concise re-writes of the original text element. The versions may be longer or expanded. The re-writing may be accomplished using AI or a large language model or other automated means. The re-writing may be accomplished by people, either individually, or collaboratively, or using crowdsourced rewriting tools. Rewriting may also refer to modifying non-text content, such as changing audio, spoken text, captions or subtitles, scripts, code, video, VR, AR, gaming, or other content.

### Simulated Persona, Simulated User, Simulated Audience

Simulated Persona, Simulated User, Simulated Audience, as used herein, may mean an AI or bot that is used to simulate human choices, actions, responses, ratings, evaluations, interactions, choices, or intentions. For example, the software may simulate the process of a human making a decision by presenting content related to the decision to an AI and asking the AI what decision it would then make in response to that content. In some instances, the term persona may be used in place of simulated persona, as shorthand. A simulated audience, as used herein, may mean a combination of one or more than one simulated personas. The software may provide for simulated audience of multiple members with the same defining persona/characteristics, or with members of different defining persona/characteristics.

### Styling

Styling as used herein may mean the display formatting of a content or text element, for example the styling of text in a browser using any of the CSS attributes associated with text. Text styling may include any combination of text attributes.

### User Interactive System, UIS

User Interactive System, UIS as used herein, may mean device and/or software features for communicating with a user, including but not limited to screens and displays, means to produce audio and audio content, production of haptic stimuli, VR/AR/XR/Metaverse hardware and/or software, virtual world hardware and/or software, gaming interfaces, UIS elements, ereader functionality or displays. The UIS may be provided us a wearable device including but not limited to headphones, earbuds, glasses with electronic hardware, watch, mobile device, clothing with electronic hardware, prosthetic devices.

### Text, or Content

Text, or Content (or either term individually), as used herein, may refer to written or spoken or presented content of a variety of forms intended to convey information, not limited to the examples provided here. Text may refer to the words or other content of a document, blog post, social media post, text chat, email, or the input characters or words or other content from a user. Text may also refer to audio language content, such as spoken-word audio, audiobooks, and the recorded utterances or sounds from a user. Text may also refer to audio language content in videos, captions, automated captions, storylines. Text may refer to the content of comic books, graphic novels and magazines, cartoons. Text may refer to computer language code or other machine-readable information. Text may refer to communication with an AI or automated assistant or chatbot. Text may refer to two-way or multi-way communications, such as phone conversations, vmails. Text may be information stored or transmitted in computerized media or in binary form. Text may include a variety of use cases to which this technology may be applied. The technology may provide for text or content to be used in applications including but not limited to education, instruction, communication, email, texting, chat, books, ebooks, printed material, virtual reality (VR), augmented reality (AR), reading, writing, contracts, continuing education, marketing, advertising, advertisements, promotional material, medical education.

### Tools

Tool or Tools, as used herein (see FIG. 1, 1310), may refer to any software, platform, or system capable of performing specific functions, including but not limited to: Code Runner: Execute and test code snippets, scripts, or full applications. Browser: Web browsing for accessing and interacting with web-based content. Search Functionality: Web Search Engines: Utilize search engines (e.g., Google, Bing) to retrieve and analyze information. Internal Search: Query internal documents or databases for relevant information. Database Query: Interact with relational (SQL) or non-relational (NoSQL) databases for querying, updating, or analyzing data. Calculator/Math Libraries: Perform complex calculations, data analysis, and mathematical operations using libraries like NumPy, SciPy, etc. External APIs: Integrate with third-party APIs to gather data (e.g., social media platforms, weather services, or geolocation APIs). Financial and Investment Platforms: Connect with platforms for managing investments, accessing financial markets, stock trading, and portfolio analysis. Cryptocurrency Platforms: Access and manage crypto exchanges, wallets, and perform blockchain-related transactions. Blockchain: Interact with blockchain networks for verifying transactions, reading blockchain data, and submitting entries to the ledger. Smart Contracts: Deploy, manage, and interact with smart contracts on platforms like Ethereum or Binance Smart Chain. Natural Language Processing (NLP) Tools: Analyze and process text-based content using tools like sentiment analysis, text summarization, or entity extraction. Cloud Storage Systems: Access and retrieve data from cloud-based storage systems (e.g., Google Drive, Dropbox, AWS S3). Document Management Systems: Evaluate or organize content stored in document management systems like Microsoft SharePoint or Google Workspace. Version Control Systems: Interact with systems like GitHub or GitLab for versioning and collaboration on code or document changes. Task Management and Collaboration Tools: Control or pull data from platforms like Jira, Trello, Asana, or Slack to integrate project management features. Visualization Tools: Generate and control visual data representations with tools like Matplotlib, D3.js, or Power BI. Machine Learning Libraries: Evaluate models, process data, or run machine learning workflows using TensorFlow, PyTorch, or Scikit-learn. Virtual Assistants: Integrate with virtual assistants (e.g., Alexa, Google Assistant) for voice-based interactions. Social Media Platforms: Interact with APIs from social media platforms like Twitter, Facebook, or LinkedIn for analyzing or posting content. Content Management Systems (CMS): Control and evaluate content in systems like WordPress, Drupal, or custom CMSs. Email Platforms: Interact with email services (e.g., Gmail, Outlook) for sending, receiving, or analyzing email content. Video/Audio Processing Tools: Work with tools to process, analyze, or edit multimedia content (e.g., FFmpeg for video/audio conversion). Security and Authentication Systems: Interact with security protocols, user authentication systems, and encryption tools (e.g., OAuth, JWT, SSL/TLS). E-commerce Platforms: Evaluate or control interactions with platforms like Shopify, Magento, or Amazon for product data and transactions. Legal and Compliance Systems: Interface with tools for checking legal, regulatory, or compliance requirements. Translation Services: Interact with machine translation APIs like Google Translate or DeepL for cross-language content evaluation. Enterprise Resource Planning (ERP) Systems: Integrate with ERP systems for managing business processes and data analytics. Customer Relationship Management (CRM) Systems: Connect with CRM platforms like Salesforce or HubSpot for managing customer data and communication. HR and Payroll Systems: Interact with HR software to manage data related to employees, payroll, and compliance. IoT Platforms: Interface with Internet of Things (IoT) devices for data gathering and automation control. Data Scraping Tools: Extract content from websites and databases using tools like Scrapy or Beautiful Soup. Cloud Computing Platforms: Control resources on platforms like AWS, Azure, or Google Cloud for deploying and scaling applications. Content Review Tools: Use platforms like Grammarly, Copyscape, or plagiarism checkers or AI-generation checkers for content analysis and originality scoring.

### UIS

User Interactive System, UIS, Selective Visual Display System as used herein, may mean device and/or software features for communicating with a user, including but not limited to screens and displays, means to produce audio and audio content, production of haptic stimuli, VR/AR/XR/Metaverse hardware and/or software, virtual world hardware and/or software, gaming interfaces, UIS elements, ereader functionality or displays. The UIS may be provided us a wearable device including but not limited to headphones, earbuds, glasses with electronic hardware, watch, mobile device, clothing with electronic hardware, prosthetic devices.

### User Profile, or Persona

User Profile, or Persona, as used herein, may mean a collection of data collected and/or stored about a user or person or hypothetical individual. This data may include the individual user's name, geographic location, age, gender, ethnicity, writing style, material read, prior content written, personality type (eg Myer's Brigs, Big Five or others), physical attributes including physical attributes derived automatically from a user photo, the names and links of their social media contacts, contact's social media information, and information from the user's social media posts, posts that they have liked, commented on, forwarded, or interacted with, as well as their contact's posts and posts of people they are following or following them, preferences, interests, or reading level. This data may include demographic information about the user. This data may include reading history, search queries, language preference, demographic information, or previously selected or highlighted text. The user profile may include astrological information about the user, religion, beliefs, favorite authors or information sources, or other information which may be used for selecting or creating custom content.

About definitions: Patent text and use of definitions should be understood to provide illustrative examples, not complete or exhaustive lists, or to exclude other possibilities, or to determine absolute requirements. Unless otherwise defined, technical and scientific terms used herein have the same meaning as commonly understood by one of ordinary skill in the art to which this invention belongs. The terminology used in the description herein is for describing particular embodiments only and is not intended to be limiting of the invention. As used herein, the singular forms ‘a,’ ‘an,’ and ‘the’ are intended to include the plural forms as well, unless the context clearly indicates otherwise. It will be further understood that the terms ‘comprises’ and/or ‘comprising,’ when used in this specification, specify the presence of stated features, integers, steps, operations, elements, and/or components, but do not preclude the presence or addition of one or more other features, integers, steps, operations, elements, components, and/or groups thereof. It will be further understood that potentially determinative words such as “is” or “can” may be interpreted to be describing example options, not limiting or definitive requirements.

The invention is described herein with reference to particular embodiments, but it is understood that the invention is not limited to these embodiments. Various modifications and equivalents will be apparent to those skilled in the art without departing from the scope of the invention. The scope of the invention should, therefore, be determined not with reference to the above description, but instead should be determined with reference to the appended claims, along with the full scope of equivalents to which such claims are entitled.

What is claimed is:

1. A selective visual display system, comprising:
a processor configured to execute coded instructions for retrieval, processing, and presentation of content to a user;
An integrated circuit for processing visual information, the circuit being capable of converting digital data into human-perceivable visual output, and further comprising visual presentation features to utilize a digital visual presentation format;
A display screen configured to exhibit said visual information connected with the device to provide a medium for user interaction with a content element presented by the system;
Wherein the system is arranged to perform operations comprising:
Receiving a content element from a user;
Receiving a content attribute associated with the content element from a user;
Generating an evaluation of said content element in relation to said content attribute;
Wherein said evaluation is generated by a machine learning model trained on a set of content to assess the degree or manner in which the content element demonstrates said content attribute based on predefined criteria or learned patterns; and
Facilitating presentation of said evaluation as a visual content element, wherein said visual content element is derived from digital content data and is presented through an output mechanism in a manner that may be perceivable to the user.

2. A selective visual display system and device process, comprising:
Executing coded instructions for retrieval, processing, and presentation of content to a user;
Processing visual information by converting digital data into human-perceivable visual output, and further utilizing a digital visual presentation format;
Allowing user interaction with a content element presented by the system;
Receiving a content element from a user;
Receiving a content attribute associated with the content element from a user;
Generating an evaluation of said content element in relation to said content attribute;
Wherein said evaluation is generated by a machine learning model trained on a set of content to assess the degree or manner in which the content element demonstrates said content attribute based on predefined criteria or learned patterns; and
Presenting said evaluation as a visual content element, wherein said visual content element is derived from digital content data through an output mechanism in a manner that may be perceivable to the user.

3. A computer-implemented method for selective visual display, comprising:
Executing coded instructions for retrieval, processing, and presentation of content to a user;
Processing electrical visual signals by converting digital visual data into human-perceivable visual output, utilizing a digital visual presentation format;
Exhibiting digital content, including various content types to provide a medium for user interaction with the content presented;
Storing in memory machine-readable instructions, or content, or user data; and
Presenting visual information to the user, the method being capable of delivering a range of visual information outputs;
wherein the method comprises:
Receiving a content element from a user;
Receiving a content attribute associated with the content element from a user;
Generating an evaluation of said content element in relation to said content attribute;
Wherein said evaluation is generated by a machine learning model trained on a set of content to assess the degree or manner in which the content element demonstrates said content attribute based on predefined criteria or learned patterns; and
Presenting said evaluation as a visual content element, wherein said visual content element is derived from digital content data through an output mechanism in a manner that may be perceivable to the user.

4. The method of claim 3, further comprising evaluation of content elements using simulated personas configured to represent specific perspectives or expertise.

5. The method of claim 3, wherein the evaluation of the content element is performed using additional contextual information provided by the user or derived from related content.

6. The method of claim 3, wherein the software provides multi-agent collaboration, enabling multiple agents to work on different aspects of a process.

7. The method of claim 3, wherein the content element is selected from the group consisting of text, photo, video, audio, music, marketing copy, email, text message, article, blog post, social media post, product concepts, value propositions, investor pitches, website designs, names, branding, logos, profile photos, job applications, resumes, landing pages, product descriptions, real estate property listings, legal documents, book drafts, and AI prompts.

8. The method of claim 3, wherein the evaluation of the content element is conducted at more than one level of granularity selected from word-level, sentence-level, paragraph-level, section-level, and document-level evaluations.

9. The method of claim 3, wherein the evaluation uses one or more of selectable pre-defined personas, rubrics, schemas, criteria, or instructions provided or selected by the user.

10. The method of claim 3, wherein the machine learning model is trained on content specifically created by the user to enhance personalization and relevance.

11. The method of claim 3, further comprising AI-assisted hybrid Al/Human responses, where human input refines or adjusts AI-generated evaluations.

12. The method of claim 3, wherein the system the ratings of different AI model outputs using a specified content attribute and ranks those outputs based upon the ratings to allow selection of the preferred output.

13. The method of claim 3, wherein the system generates ratings of outputs from more than one AI model using a specified content attribute and ranks those outputs based upon the ratings to allow selection of the preferred output.

14. The method of claim 3, wherein the evaluation is used in the context of grading content elements based on predefined educational rubrics or assessment criteria.

15. The method of claim 3, wherein the content attributes include attributes related to Al safety testing and AI alignment with human goals.

16. The method of claim 3, further comprising a rating service for AI models, content, or digital products.

17. The method of claim 3, wherein the machine learning model is trained to predict or mimic human behavior, choices, or evaluations based on provided inputs and contextual data.

18. The method of claim 3, wherein the evaluation of content elements generates quantitative scores based on specific attributes, producing either numerical or categorical outputs.

19. The method of claim 3, wherein the evaluation of content elements generates qualitative feedback.

20. The method of claim 3, wherein the evaluation or rating results are compared with predefined benchmarks to assess performance or quality.

21. The method of claim 3, wherein simulated personas or AI agents are configured to take surveys.

22. The method of claim 3, further comprising functionality for generating new content.

23. The method of claim 3, further comprising functionality for generating new content based on existing content evaluations.

24. The method of claim 3, wherein the system iterates the content generation and evaluation process to reach an evaluation or rating threshold level.

25. The method of claim 3, configured to detect the user's status or potential mental health disorders based on verbal or written communication analyzed by the machine learning model.

26. The method of claim 3, wherein the software performs UI testing.

27. The method of claim 3, wherein the content element is selected from the group consisting of: A product name, A business name, Branding information, A profile photo, A product image, An application for a position, A job application or resumes, Website content, Landing page content, A product description, A real estate property listing, A legal document, A contract, An AI prompt, A text message, An email message, Text-to-speech content, Speech-to-text content, Email ranking for prioritizing correspondence, Customer service communication, Negotiation communication, Conversation or dialog content, and A replica persona designed to mimic the user's responses.

28. The method of claim 3, further comprising the use of a tool or tools, selected from the group consisting of: Code Runner for executing and testing code snippets, scripts, or full applications; Browser for web browsing and interacting with web-based content; Search Functionality, including Web Search Engines (e.g., Google, Bing) and Internal Search to query internal documents or databases; Database Query for interacting with relational (SQL) or non-relational (NoSQL) databases for querying, updating, or analyzing data; Calculator/Math Libraries, including libraries like NumPy, SciPy; External APIs for integrating third-party data gathering services (e.g., social media, weather, geolocation APIs); Financial and Investment Platforms for managing investments, accessing financial markets, stock trading, and portfolio analysis; Cryptocurrency Platforms for managing crypto exchanges, wallets, and blockchain-related transactions; Blockchain interactions for verifying transactions, reading blockchain data, and submitting entries to the ledger; Smart Contracts on platforms like Ethereum or Binance Smart Chain; Natural Language Processing (NLP) Tools for text analysis, including sentiment analysis, text summarization, and entity extraction; Cloud Storage Systems, including Google Drive, Dropbox, AWS S3; Document Management Systems, including Microsoft SharePoint and Google Workspace; Version Control Systems, including GitHub and GitLab; Task Management and Collaboration Tools, including Jira, Trello, Asana, and Slack; Visualization Tools, including Matplotlib, D3.js, and Power BI; Machine Learning Libraries, including TensorFlow, PyTorch, and Scikit-learn; Virtual Assistants, including Alexa and Google Assistant; Social Media Platforms for interacting with APIs from platforms like Twitter, Facebook, Linkedin; Content Management Systems (CMS), including WordPress, Drupal, custom CMSs; Email Platforms, including Gmail and Outlook; Video/Audio Processing Tools, for example FFmpeg for video/audio conversion; Security and Authentication Systems, including OAuth, JWT, SSL/TLS; E-commerce Platforms for managing product data and transactions on platforms like Shopify, Magento, Amazon; Legal and Compliance Systems for checking legal, regulatory, or compliance requirements; and Translation Services, including Google Translate and DeepL.
